(19) United States
(12) Patent Application Publication
(10) Pub. No.: US 2018/0301048 A1
(43) Pub. Date: Oct. 18, 2018

(54) REMOTE LIVE TUTORING PLATFORM

(71) Applicant: Age of Learning, Inc., Glendale, CA (US)

(72) Inventors: Farshid ALMASSIZADEH, Los Angeles, CA (US); Bing CHEN, La Cañada Flintridge, CA (US)

(21) Appl. No.: 15/951,083

(22) Filed: Apr. 11, 2018

Related U.S. Application Data
(60) Provisional application No. 62/484,622, filed on Apr. 12, 2017.
(60) Provisional application No. 62/593,432, filed on Dec. 1, 2017.

(51) Int. Cl. G09B 5/14; H04L 29/06; G06F 17/30; G06Q 30/02; G06Q 20/10

(52) U.S. Cl. CPC G09B 5/14; H04L 65/4015; G06Q 20/102; G06Q 30/0282; G06F 17/30867

(57) ABSTRACT

Described are systems, media, and methods for conducting live, remote, online tutoring sessions via a bi-modal, online tutoring application including a database of tutor profiles, an interface for conducting a tutoring session between one or more tutors and one or more learners, a learner mode, and a tutor mode.

### CROSS-REFERENCE

This application claims priority to U.S. Provisional Application No. 62/484,622, filed Apr. 12, 2017, and U.S. Provisional Application No. 62/593,432, filed Dec. 1, 2017, both of which are incorporated herein by reference in their entireties.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

Electronic-learning (“e-learning”), or learning outside of a traditional classroom through the aid of electronic media, is increasingly prevalent. E-learning allows its users to remotely participate in learning activities, access mentors, such as tutors, across great distances, and access learning materials at the users' convenience.

### SUMMARY OF THE INVENTION

Existing online tutoring applications suffer from multiple technical deficiencies. By way of example, current technologies fail to facilitate an adequately functioning marketplace for tutoring services, wherein learners can rate, browse, and select tutors to fit their needs based on a library of tutor profiles. By way of further example, current technologies fail to bring together the features and functionalities necessary to allow learners and tutors to meaningfully connect in the online environment, where each is remote from the other, while minimizing computer resources and maximizing computer performance. By way of example, some existing online tutoring applications indiscriminately provide any feature and functionality to any user, regardless whether they are a learner or a tutor. However, too many features and functionalities afforded to all users may not only be distracting, but may also adversely affect the performance and capability of the computer to accommodate the numerous interactions and simultaneous input from both tutors and learners—especially as the number of learners increase. Yet, affording too few features and functionalities may have drawbacks as well. Tutors often face the challenge unique in the virtual world of maintaining or simulating a comforting, engaging, and natural environment to learners (especially those who are young) without the ability to provide the physical presence of the tutor, other classmates, or even a classroom—all items that normally exist in a brick and mortar classroom and that generally help create a natural and engaging environment. In some instances, not enough features and functionalities is detrimental to re-creating a comfortable, interactive e-learning environment for the learner, taking away the incentive and mechanisms for the learner to engage in an online activity. Hence, this lack of specific and appropriate features and functionalities may, in some cases, offer an incredible roadblock to learning in a virtual learning environment. Additionally, and importantly, existing applications fail to deliver learning content designed and adapted for co-browsing and remote, live tutoring environments. Hence, among other items, a superior online tutoring application that provides a balanced approach of specific features and functionalities to some users to adequately create or simulate a meaningful interactive e-learning environment while providing a technical advantage and improvement in computer functionality by limiting other features and functionalities based on the specific user is needed.

Advantages of the platforms, systems, media, and methods described herein include provision of features facilitating a marketplace wherein tutors share information about how to best help specific learners and wherein learners can browse and study many tutor profiles, rich in information, to identify a tutor that is a good match for their educational situation. Additional advantages include a live, remote, online tutoring environment including a combination of features such as streaming video, audio, and chat (optionally with real-time translation), interactive rewards and feedback, and others that allow learners to connect with tutors across the remote spaces of the world-wide-web. Also, advantages of the platforms, systems, media, and methods described herein include content tailored for and directed to delivery in live, remote tutoring environments, complete with a rich-media tutoring script. Moreover, the subject matter described herein includes a bi-modal application, which allows learners, tutors, and administrators to use the same app, but enjoy a user experience customized for their role in the educational process across devices and platforms. In addition, the subject matter described herein describes a remote tutoring application that can stand alone or that can be retrofitted, added on, or offered as an upgrade to any existing e-learning environments, websites, or services. Further advantages will be apparent to those of skill in the field from the following disclosure.

In one aspect, disclosed herein are computer-implemented systems comprising: a digital processing device comprising: at least one processor, an operating system configured to perform executable instructions, a memory, and a computer program including instructions executable by the digital processing device to create a bi-modal, online tutoring application for providing live, remote tutoring sessions, the application comprising: a database of tutor profiles, each profile comprising an average rating and availability of a tutor; an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding; a learner mode comprising: a booking module allowing a learner to purchase tutoring session credits, browse the tutor profiles, and book new tutoring sessions; a dashboard module providing access to booked sessions and learner progress; and a learner feedback module allowing a learner to rate tutors and completed tutoring sessions; a tutor mode comprising: a billing and payment module allowing a tutor to view booked tutoring sessions and payments for completed tutoring sessions; and a tutor feedback module allowing a tutor to, for a completed tutoring session, perform one or more of: assign homework, describe learner progress, provide tutor-to-tutor feedback, and rate curriculum; wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum. In some embodiments, the mode is determined by log-in credentials. In some embodiments, each tutor profile further comprises name, photo, number of tutoring sessions completed, biography, awards, education, and experience. In various embodiments, the tutoring session duration has a predetermined duration of about 20 minutes, about 30 minutes, about 40 minutes, or about 60 minutes. In various embodiments, the live audio/video presence is of the one or more tutors, the one or more learners, or both the one or more tutors and the one or more learners. In some embodiments, the text chat comprises automatic translation. In various embodiments, the co-browsing module shows the pointer position of the one or more tutors, the one or more learners or both the one or more tutors and the one or more learners. In a particular embodiment, in the learner mode, the booking module allows the learner to book up to three sessions. In some embodiments, the onscreen awards comprise an animated graphic. In some embodiments, the onscreen awards comprise an interactive game. In some embodiments, wherein the curriculum is organized into a hierarchy comprising one or more units, a unit comprising one or more lessons, a lesson comprising one or more slides, a slide comprising one or more videos. In some embodiments, the co-browsing module independently accesses the media for each tutor and learner and exchanges event data to sync the presentation among all tutors and learners. In some embodiments, in the tutor mode, the interface for conducting a tutoring session further comprises tools for a tutor to disable learner whiteboarding. In some embodiments, the tutoring script for the curriculum comprises educational rationales and teaching prompts. In further embodiments, the teaching prompts comprise a prompt to transfer navigational control to one or more of the learners or a prompt to transfer navigational control back from a learner. In further embodiments, the tutoring script for the curriculum comprises one or more images, one or more videos, one or more audio elements, or one or more interactive elements. In various embodiments, the interface for conducting a tutoring session, the learner mode and the tutor mode are implemented via a mobile app, a web app, or a standalone app. In some embodiments, the tutoring session is conducted between one tutor and one learner. In other embodiments, the tutoring session is conducted between one tutor and a plurality of learners. In further embodiments, the tutoring session is conducted between one tutor and at least 5, at least 10, or at least 20 learners. In some embodiments, the tutoring session is conducted by a plurality of tutors.

In another aspect, disclosed herein are non-transitory computer-readable storage media encoded with a computer program including instructions executable by a processor to create a bi-modal, online tutoring application for providing live, remote tutoring sessions, the application comprising: a database of tutor profiles, each profile comprising an average rating and availability of a tutor; an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding; a learner mode comprising: a booking module allowing a learner to purchase tutoring session credits, browse the tutor profiles, and book new tutoring sessions; a dashboard module providing access to booked sessions and learner progress; and a learner feedback module allowing a learner to rate tutors and completed tutoring sessions; a tutor mode comprising: a billing and payment module allowing a tutor to view booked tutoring sessions and payments for completed tutoring sessions; and a tutor feedback module allowing a tutor to, for a completed tutoring session, perform one or more of: assign homework, describe learner progress, provide tutor-to-tutor feedback, and rate curriculum; wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum. In some embodiments, the mode is determined by log-in credentials. In some embodiments, each tutor profile further comprises name, photo, number of tutoring sessions completed, biography, awards, education, and experience. In various embodiments, the tutoring session duration has a predetermined duration of about 20 minutes, about 30 minutes, about 40 minutes, or about 60 minutes. In various embodiments, the live audio/video presence is of the one or more tutors, the one or more learners, or both the one or more tutors and the one or more learners. In some embodiments, the text chat comprises automatic translation. In various embodiments, the co-browsing module shows the pointer position of the one or more tutors, the one or more learners or both the one or more tutors and the one or more learners. In a particular embodiment, in the learner mode, the booking module allows the learner to book up to three sessions. In some embodiments, the onscreen awards comprise an animated graphic. In some embodiments, the onscreen awards comprise an interactive game. In some embodiments, wherein the curriculum is organized into a hierarchy comprising one or more units, a unit comprising one or more lessons, a lesson comprising one or more slides, a slide comprising one or more videos. In some embodiments, the co-browsing module independently accesses the media for each tutor and learner and exchanges event data to sync the presentation among all tutors and learners. In some embodiments, in the tutor mode, the interface for conducting a tutoring session further comprises tools for a tutor to disable learner whiteboarding. In some embodiments, the tutoring script for the curriculum comprises educational rationales and teaching prompts. In further embodiments, the teaching prompts comprise a prompt to transfer navigational control to one or more of the learners or a prompt to transfer navigational control back from a learner. In further embodiments, the tutoring script for the curriculum comprises one or more images, one or more videos, one or more audio elements, or one or more interactive elements. In various embodiments, the interface for conducting a tutoring session, the learner mode and the tutor mode are implemented via a mobile app, a web app, or a standalone app. In some embodiments, the tutoring session is conducted between one tutor and one learner. In other embodiments, the tutoring session is conducted between one tutor and a plurality of learners. In further embodiments, the tutoring session is conducted between one tutor and at least 5, at least 10, or at least 20 learners. In some embodiments, the tutoring session is conducted by a plurality of tutors.

In yet another aspect, disclosed herein are computer-implemented methods of providing a marketplace for live, remote, online tutoring comprising: maintaining a database of tutor profiles, each profile comprising an average rating and availability of a tutor; presenting an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding; providing a learner mode comprising: a booking module allowing a learner to purchase tutoring session credits, browse the tutor profiles, and book new tutoring sessions; a dashboard module providing access to booked sessions and learner progress; and a learner feedback module allowing a learner to rate tutors and completed tutoring sessions; providing a tutor mode comprising: a billing and payment module allowing a tutor to view booked tutoring sessions and payments for completed tutoring sessions; and a tutor feedback module allowing a tutor to, for a completed tutoring session, perform one or more of: assign homework, describe learner progress, provide tutor-to-tutor feedback, and rate curriculum; wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum. In some embodiments, the mode is determined by log-in credentials. In some embodiments, each tutor profile further comprises name, photo, number of tutoring sessions completed, biography, awards, education, and experience. In various embodiments, the tutoring session duration has a predetermined duration of about 20 minutes, about 30 minutes, about 40 minutes, or about 60 minutes. In various embodiments, the live audio/video presence is of the one or more tutors, the one or more learners, or both the one or more tutors and the one or more learners. In some embodiments, the text chat comprises automatic translation. In various embodiments, the co-browsing module shows the pointer position of the one or more tutors, the one or more learners or both the one or more tutors and the one or more learners. In a particular embodiment, in the learner mode, the booking module allows the learner to book up to three sessions. In some embodiments, the onscreen awards comprise an animated graphic. In some embodiments, the onscreen awards comprise an interactive game. In some embodiments, wherein the curriculum is organized into a hierarchy comprising one or more units, a unit comprising one or more lessons, a lesson comprising one or more slides, a slide comprising one or more videos. In some embodiments, the co-browsing module independently accesses the media for each tutor and learner and exchanges event data to sync the presentation among all tutors and learners. In some embodiments, in the tutor mode, the interface for conducting a tutoring session further comprises tools for a tutor to disable learner whiteboarding. In some embodiments, the tutoring script for the curriculum comprises educational rationales and teaching prompts. In further embodiments, the teaching prompts comprise a prompt to transfer navigational control to one or more of the learners or a prompt to transfer navigational control back from a learner. In further embodiments, the tutoring script for the curriculum comprises one or more images, one or more videos, one or more audio elements, or one or more interactive elements. In various embodiments, the interface for conducting a tutoring session, the learner mode and the tutor mode are implemented via a mobile app, a web app, or a standalone app. In some embodiments, the tutoring session is conducted between one tutor and one learner. In other embodiments, the tutoring session is conducted between one tutor and a plurality of learners. In further embodiments, the tutoring session is conducted between one tutor and at least 5, at least 10, or at least 20 learners. In some embodiments, the tutoring session is conducted by a plurality of tutors.

In another aspect, disclosed herein are computer-implemented system comprising: a digital processing device comprising: at least one processor, an operating system configured to perform executable instructions, a memory, and a computer program including instructions executable by the digital processing device to create a bi-modal, online tutoring application for providing live, remote tutoring sessions, the application comprising (a) a shared mode wherein the application presents to one or more tutors and one or more learners a content screen with at least one learning activity to which only the one or more tutors may interact wherein the interaction is simultaneously broadcast to the one or more tutors and one or more learners; and (b) a quiz mode wherein the application presents: (i) to the one or more learners a content screen comprising the at least one learning activity, wherein each learner is given permission to interact with the at least one learning activity on the content screen, wherein each learner's interaction is not broadcast to any other learner in the remote tutoring session; and (ii) to the one or more tutors one or more content screens that simultaneously broadcasts in real time the content screen and interactions of the one or more learners, wherein the application provides the one or more tutors with an interface element to switch between the shared mode and the quiz mode. In some embodiments, the one or more learners comprises 2, 3, 4, 5, 6, 7, 8, 9, 10, 11, 12, 13, 14, 15, 16, or more learners. In other embodiments, the quiz mode presents to the one or more tutors all of the one or more learners' content screens and interactions in a single tutor content screen. In further embodiments, the quiz mode presents to the one or more tutors all of the one or more learners' content screens and interactions over a plurality of tutor content screens that the tutor may separately scroll through. In additional embodiments, the quiz mode broadcasts live audio and visual images of the one or more tutors and one or more learners. In even further embodiments, either the shared mode or quiz mode the application presents the one or more tutors the ability to award animated masks to one or more learners, wherein the animated mask is contextual to the tutoring session

In another aspect, disclosed herein are non-transitory computer-readable storage media encoded with a computer program including instructions executable by a processor to create a bi-modal, online tutoring application for providing live, remote tutoring sessions, the application comprising: (a) a shared mode wherein the application presents to one or more tutors and one or more learners a content screen with at least one learning activity to which only the one or more tutors may interact wherein the interaction is simultaneously broadcast to the one or more tutors and one or more learners; and (b) a quiz mode wherein the application presents: (i) to the one or more learners a content screen comprising the at least one learning activity, wherein each learner is given permission to interact with the at least one learning activity on the content screen, wherein each learner's interaction is not broadcast to any other learner in the remote tutoring session; and (ii) to the one or more tutors one or more content screens that simultaneously broadcasts in real time the content screen and interactions of the one or more learners, wherein the application provides the one or more tutors with an interface element to switch between the shared mode and the quiz mode. In some embodiments, the one or more learners comprises 2, 3, 4, 5, 6, 7, 8, 9, 10, 11, 12, 13, 14, 15, 16, or more learners. In other embodiments, the quiz mode presents to the one or more tutors all of the one or more learners' content screens and interactions in a single tutor content screen. In additional embodiments, the quiz mode presents to the one or more tutors all of the one or more learners' content screens and interactions over a plurality of tutor content screens that the tutor may separately scroll through. In even further embodiments, the quiz mode broadcasts live audio and visual images of the one or more tutors and one or more learners. In further embodiments, either the shared mode or quiz mode the application presents the one or more tutors the ability to award animated masks to one or more learners, wherein the animated mask is contextual to the tutoring session.

In yet another aspect, disclosed herein are computer-implemented methods of providing a bi-modal, online tutoring application for providing live, remote tutoring sessions, the method comprising: (a) providing a shared mode comprising the application presenting to one more tutors and one or more learners a content screen with at least one learning activity to which only the one or more tutors may interact and simultaneously broadcasting the interaction to the one or more tutors and one or more learners; (b) providing a quiz mode comprising: (i) the application that presents to one or more learners a content screen comprising the at least one learning activity, giving each learner permission to interact with the at least one learning activity on the content screen, and limiting the broadcast of each learner's interaction so the learners' interaction is not broadcast to any other learning in the remote tutoring session; and (ii) the application that presents to the one or more tutors one or more content screens that simultaneously broadcasts in real time the content screen and interactions of the one or more learners, and (c) providing the one or more tutors with an interface element to switch between the shared mode and the quiz mode. In some embodiments, the one or more learners comprises 2, 3, 4, 5, 6, 7, 8, 9, 10, 11, 12, 13, 14, 15, 16, or more learners. In other embodiments, the quiz mode presents to the one or more tutors all of the one or more learners' content screens and interactions in a single tutor content screen. In additional embodiments, the quiz mode presents to the one or more tutors all of the one or more learners' content screens and interactions over a plurality of tutor content screens that the tutor may separately scroll through. In further embodiments, the quiz mode broadcasts live audio and visual images of the one or more tutors and one or more learners. In even further embodiments, either the shared mode or quiz mode the application presents the one or more tutors the ability to award animated masks to one or more learners, wherein the animated mask is contextual to the tutoring session.

### BRIEF DESCRIPTION OF THE DRAWINGS

A better understanding of the features and advantages of the present subject matter will be obtained by reference to the following detailed description and the accompanying drawings of which:

FIG. 1 shows a non-limiting example of a graphic user interface; in this case, an interface for an individual to log in the remote tutoring session application;

FIG. 2 shows a non-limiting example of a graphic user interface; in this case, a booking module for the learner mode for a learner to book a new tutoring session;

FIG. 3 shows a non-limiting example of graphic user interface; in this case, a booking module for the learner mode for a learner to select a date to book a new tutoring session;

FIG. 4 shows a non-limiting example of graphic user interface; in this case, a booking module for the learner mode for a learner to select a time to book a new tutoring session;

FIG. 5 shows a non-limiting example of graphic user interface; in this case, a booking module for the learner mode to browse a tutor profile;

FIG. 6 shows a non-limiting example of graphic user interface; in this case, a booking module for the learner mode for a learner to purchase tutoring session credits;

FIG. 7 shows a non-limiting example of graphic user interface; in this case, a dashboard module for the learner mode for the learner to view already booked tutoring sessions;

FIG. 8 shows a non-limiting example of graphic user interface; in this case, a dashboard module for the learner mode for the learner to view a summary of the different tutoring sessions already booked;

FIG. 9 shows a non-limiting example of graphic user interface; in this case, a dashboard module for the learner mode for the learner to view a summary of the learner progress;

FIG. 10 shows a non-limiting example of graphic user interface; in this case, a learner feedback module for the learner mode;

FIG. 11 shows a non-limiting example of graphic user interface; in this case, an interface for a tutor to view a curriculum and its lesson plan for a remote tutoring session;

FIG. 12 shows a non-limiting example of graphic user interface; in this case, a remote tutoring session interface for a tutor feedback module for a tutor to assign homework to the learner;

FIG. 13 shows a non-limiting example of graphic user interface; in this case, a remote tutoring session interface for a tutor feedback module for a tutor to describe learner progress;

FIG. 14 shows a non-limiting example of graphic user interface; in this case, a remote tutoring session interface for a tutor feedback module for a tutor to provide tutor-to-tutor feedback;

FIG. 15 shows a non-limiting example of graphic user interface; in this case, a remote tutoring session interface for a tutor feedback module for a tutor to rate the curriculum;

FIG. 16 shows a non-limiting example of graphic user interface; in this case, an interface for conducting a tutoring session between one or more tutors and one or more learners through a shared co-browsing module from a learner's perspective;

FIG. 17 shows a non-limiting example of graphic user interface; in this case, an interface for conducting a tutoring session between one or more tutors and one or more learners through a shared co-browsing module from a tutor's perspective;

FIG. 18 shows a non-limiting example of graphic user interface; in this case, an interface for an online learning activity relating to matching different virtual figures;

FIG. 19 shows a non-limiting example of graphic user interface; in this case an interface for an online learning activity depicting a short animation;

FIG. 20 shows a non-limiting example of graphic user interface; in this case, an interface for online learning activities depicting a plurality of academic subjects for children;

FIG. 21 shows a non-limiting example of graphic user interface; in this case, an interface for online learning activities depicting a plurality of academic subjects through a classroom theme;

FIG. 22 shows a non-limiting example of graphic user interface; in this case, an interface for online learning activities depicting a variety of reading activities;

FIG. 23 shows a non-limiting example of graphic user interface; in this case, an interface for online learning activities depicted through a step-by-step path beach theme;

FIG. 24 shows a non-limiting example of graphic user interface; in this case, an interface for customizing the learning activities and organizing earned tickets, coupons, prizes, tokens, or awards;

FIG. 25 shows a non-limiting example of graphic user interface; in this case, an interface for a learner's parent or guardian to customize the learning activities;

FIG. 26 shows a non-limiting example of graphic user interface; in this case, an interface for managing the learner's account;

FIG. 27 shows a non-limiting example of graphic user interface; in this case for a learner to select a tutoring style for a live, remote tutoring session;

FIG. 28 shows a non-limiting example of graphic user interface; in this case a home screen for classroom (large group) tutoring sessions including a catalog of broadcast events and access to interface elements allowing a learner to enroll in future sessions and join currently streaming sessions;

FIG. 29 shows a non-limiting example of graphic user interface; in this case an interface for providing a classroom (large group) tutoring session including two tutor video presences;

FIG. 30 shows a non-limiting example of graphic user interface; in this case an interface for providing a classroom (large group) tutoring session including a single tutor video presence;

FIG. 31 shows a non-limiting example of graphic user interface; in this case an interface for providing a classroom (large group) tutoring session including a single tutor video presence;

FIG. 32 shows a non-limiting example of graphic user interface; in this case a first exemplary interface for providing a classroom (large group) tutoring session including a live quiz feature;

FIG. 33 shows a non-limiting example of graphic user interface; in this case a second exemplary interface for providing a classroom (large group) tutoring session including a live quiz feature;

FIG. 34 shows a non-limiting schematic diagram of a digital processing device; in this case, a device with one or more CPUs, a memory, a communication interface, and a display;

FIG. 35 shows a non-limiting schematic diagram of a web/mobile application provision system; in this case, a system providing browser-based and/or native mobile user interfaces;

FIG. 36 shows a non-limiting schematic diagram of a cloud-based web/mobile application provision system; in this case, a system comprising an elastically load balanced, auto-scaling web server and application server resources as well synchronously replicated databases;

FIG. 37 shows a non-limiting example of a graphic user interface; in this case, a remote tutoring session interface configured for a mobile device;

FIG. 38 shows a non-limiting example of a graphic user interface; in this case, a remote tutoring session interface configured for a tablet;

FIG. 39 shows a non-limiting example of an application software architecture; in this case a first exemplary architecture;

FIG. 40 shows a non-limiting example of an application software architecture; in this case second exemplary architecture;

FIG. 41 shows a non-limiting example of a graphic user interface; in this case, an interface for a tutor to view his or her schedule of remote tutoring sessions;

FIG. 42 shows a non-limiting example of a graphic user interface; in this case, an interface for a tutor to view the attendees in the remote tutoring session;

FIG. 43 shows a non-limiting example of a graphic user interface; in this case, an interface for a tutor to award animated masks to fit over one or more learner's images in the remote tutoring session;

FIG. 44 shows a non-limiting example of a graphic user interface; in this case, an interface for a tutor to award animated stickers to one or more learners in the remote tutoring session;

FIG. 45 shows a non-limiting example of a graphic user interface; in this case, an interface for a tutor to begin chatting with one or more learners in the remote tutoring session;

FIG. 46 shows a non-limiting example of a graphic user interface; in this case, an interface for a tutor to see an overview of all of the lesson plan slides for the remote tutoring session;

FIG. 47 shows a non-limiting example of a graphic user interface; in this case, an interface for a tutor to view the lesson plan for the remote tutoring session;

FIG. 48 shows a non-limiting example of a graphic user interface; in this case, a whiteboarding module to allow a tutor to whiteboard onto the graphic user interface or allow a learner to whiteboard onto the graphic user interface;

FIG. 49 shows a non-limiting example of a graphic user interface; in this case, an interface for a tutor to interact with four learners simultaneously in quiz mode;

FIG. 50 shows a non-limiting example of a graphic user interface; in this case, an interface for a tutor to fill out a student progress report;

FIG. 51 shows a non-limiting example of a graphic user interface; in this case, an interface for a tutor to fill out a student progress report;

FIG. 52 shows a non-limiting example of a graphic user interface; in this case, an onboard interface for when a learner first logs into the remote tutoring program;

FIG. 53 shows a non-limiting example of a graphic user interface; in this case, an interface for a learner to select a day and time for a remote tutoring session;

FIG. 54 shows a non-limiting example of a graphic user interface; in this case, an interface for a learner to select a day and time for a remote tutoring session;

FIG. 55 shows a non-limiting example of a graphic user interface; in this case, an interface for a learner to confirm the selected day and time for a remote tutoring session;

FIG. 56 shows a non-limiting example of a graphic user interface; in this case, an interface for a learner to confirm the selected day and time for a remote tutoring session;

FIG. 57 shows a non-limiting example of a graphic user interface; in this case, an interface for assisting a learner to confirm whether the microphone on a platform will function in the remote tutoring session;

FIG. 58 shows a non-limiting example of a graphic user interface; in this case, an interface for assisting a learner to confirm whether the speakers on a platform will function in the remote tutoring session;

FIG. 59 shows a non-limiting example of a graphic user interface; in this case, an interface for assisting a learner to confirm whether the camera on a platform will function in the remote tutoring session;

FIG. 60 shows a non-limiting example of a graphic user interface; in this case, an interface for assisting a learner to confirm whether the microphone, speakers, and camera will function in the remote tutoring session;

FIG. 61 shows a non-limiting example of a graphic user interface; in this case, an interface for providing parental consent;

FIG. 62 shows a non-limiting example of a graphic user interface; in this case, an interface for providing an overview of the remote tutoring program;

FIG. 63 shows a non-limiting example of a graphic user interface; in this case, an interface for assessing the literacy competency of the learner;

FIG. 64 shows a non-limiting example of a graphic user interface; in this case, an interface for a learner in a remote tutoring session;

FIG. 65 shows a non-limiting example of a graphic user interface; in this case, an interface for a learner in a remote tutoring session;

FIG. 66 shows a non-limiting example of a graphic user interface; in this case, an interface for a learner to provide feedback of the remote tutoring session;

FIG. 67 shows a non-limiting example of a graphic user interface; in this case, an interface for providing the progress report of the learner;

FIG. 68 shows a non-limiting example of a graphic user interface; in this case, an interface for the home page module of a learner;

FIG. 69 shows a non-limiting example of a graphic user interface; in this case, an interface for signing up for one or more remote tutoring sessions;

FIG. 70 shows a non-limiting example of a graphic user interface; in this case, an interface for signing up for one or more remote tutoring sessions;

FIG. 71 shows a non-limiting example of a graphic user interface; in this case, an interface for signing up for one or more remote tutoring sessions;

FIG. 72 shows a non-limiting example of a graphic user interface; in this case, an interface for signing up for one or more remote tutoring sessions;

FIG. 73 shows a non-limiting example of a graphic user interface; in this case, an interface for viewing upcoming remote tutoring sessions;

FIG. 74 shows a non-limiting example of a graphic user interface; in this case, an interface for viewing the details of an upcoming remote tutoring session;

FIG. 75 shows a non-limiting example of a graphic user interface; in this case, an interface for viewing the past remote tutoring sessions;

FIG. 76 shows a non-limiting example of a graphic user interface; in this case, an interface for viewing the details of past remote tutoring sessions;

FIG. 77 shows a non-limiting example of a graphic user interface; in this case, an interface for selecting one or more subscription plans for remote tutoring sessions;

FIG. 78 shows a non-limiting example of a graphic user interface; in this case, an interface for selecting one or more subscription plans for remote tutoring sessions;

FIG. 79 shows a non-limiting example of a graphic user interface; in this case, an interface for inserting a password to purchase a subscription plan for remote tutoring sessions; and

FIG. 80 shows a non-limiting example of a graphic user interface; in this case, an interface for requesting customer support.

FIG. 81 shows a non limiting example of a graphic user interface; in this case, an interface for a tutor to see which parents of learners have or have not provided consent.

FIG. 82 shows a non limiting example of a graphic user interface; in this case, an interface for a parent to re-schedule a tutoring session.

FIG. 83 shows a non limiting example of a graphic user interface; in this case, an interface for a parent with more than one child learner to select which child is registering for a tutoring session.

FIG. 84 shows a non limiting example of a graphic user interface; in this case, an interface for a parent to receive additional help.

FIG. 85 shows a non limiting example of a graphic user interface; in this case, an interface for a parent to provide consent.

FIG. 86 shows a non limiting example of a graphic user interface; in this case, an interface for displaying the general rules around tutoring sessions.

FIG. 87 shows a non limiting example of a graphic user interface; in this case, an interface for displaying the general rules around subscription purchasing, upgrading, and downgrading.

FIG. 88 shows a non limiting example of a graphic user interface; in this case, an interface for displaying the general rules around subscription cancellation.

### DETAILED DESCRIPTION OF THE INVENTION

Described herein, in certain embodiments, are computer-implemented systems comprising: a digital processing device comprising: at least one processor, an operating system configured to perform executable instructions, a memory, and a computer program including instructions executable by the digital processing device to create a bi-modal, online tutoring application for providing live, remote tutoring sessions, the application comprising: a database of tutor profiles, each profile comprising an average rating and availability of a tutor; an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding; a learner mode comprising: a booking module allowing a learner to purchase tutoring session credits, browse the tutor profiles, and book new tutoring sessions; a dashboard module providing access to booked sessions and learner progress; and a learner feedback module allowing a learner to rate tutors and completed tutoring sessions; a tutor mode comprising: a billing and payment module allowing a tutor to view booked tutoring sessions and payments for completed tutoring sessions; and a tutor feedback module allowing a tutor to, for a completed tutoring session, perform one or more of: assign homework, describe learner progress, provide tutor-to-tutor feedback, and rate curriculum; wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum.

Also described herein, in certain embodiments, are non-transitory computer-readable storage media encoded with a computer program including instructions executable by a processor to create a bi-modal, online tutoring application for providing live, remote tutoring sessions, the application comprising: a database of tutor profiles, each profile comprising an average rating and availability of a tutor; an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding; a learner mode comprising: a booking module allowing a learner to purchase tutoring session credits, browse the tutor profiles, and book new tutoring sessions; a dashboard module providing access to booked sessions and learner progress; and a learner feedback module allowing a learner to rate tutors and completed tutoring sessions; a tutor mode comprising: a billing and payment module allowing a tutor to view booked tutoring sessions and payments for completed tutoring sessions; and a tutor feedback module allowing a tutor to, for a completed tutoring session, perform one or more of: assign homework, describe learner progress, provide tutor-to-tutor feedback, and rate curriculum; wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum.

Also described herein, in certain embodiments, are computer-implemented methods of providing a marketplace for live, remote, online tutoring comprising: maintaining a database of tutor profiles, each profile comprising an average rating and availability of a tutor; presenting an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding; providing a learner mode comprising: a booking module allowing a learner to purchase tutoring session credits, browse the tutor profiles, and book new tutoring sessions; a dashboard module providing access to booked sessions and learner progress; and a learner feedback module allowing a learner to rate tutors and completed tutoring sessions; providing a tutor mode comprising: a billing and payment module allowing a tutor to view booked tutoring sessions and payments for completed tutoring sessions; and a tutor feedback module allowing a tutor to, for a completed tutoring session, perform one or more of: assign homework, describe learner progress, provide tutor-to-tutor feedback, and rate curriculum; wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, “learner” refers to a person who interacts with an educational system for the purpose of gaining knowledge, insight, or understanding of one or more target language or academic subject matter or by virtue of having been allowed, asked, or assigned to interact with an educational system.

As used herein, “tutor” refers to any person who interacts with an educational system for the purpose of providing knowledge, insight, or understanding of one or more target language or academic subject matter or by virtue of having been allowed, asked, or assigned to interact with an educational system.

As used herein, a “learner mode” refers to a mode available to an individual who logs into a remote tutoring session application as a learner and is automatically directed to a set of interfaces and tools including features configures for a learner.

As used herein, a “tutor mode” refers to a mode available to an individual who logs into a remote tutoring session application as a tutor and is automatically directed to a set of interfaces and tools including with features configured for a tutor.

As used herein, a “quiz mode” refers to a mode available to an individual who logs into a remote tutoring session application as a tutor and accesses a quiz mode module that allows the tutor to go from a shared content screen between a tutor and one or more learners to a content screen that allows simultaneously viewing the content screens of one or more learners in the remote tutoring session. Similarly, “quiz mode” for an individual who logs into a remote tutoring session as a learner refers to a mode that, upon direction from a tutor, transitions the learner's content screen from a shared experience among the tutor and one or more learners to an individual experience, allowing limited interactions with said individual's content screen but limiting the learner from being able to see or interact with the content screens of other learners in the remote tutoring session.

### Log-in

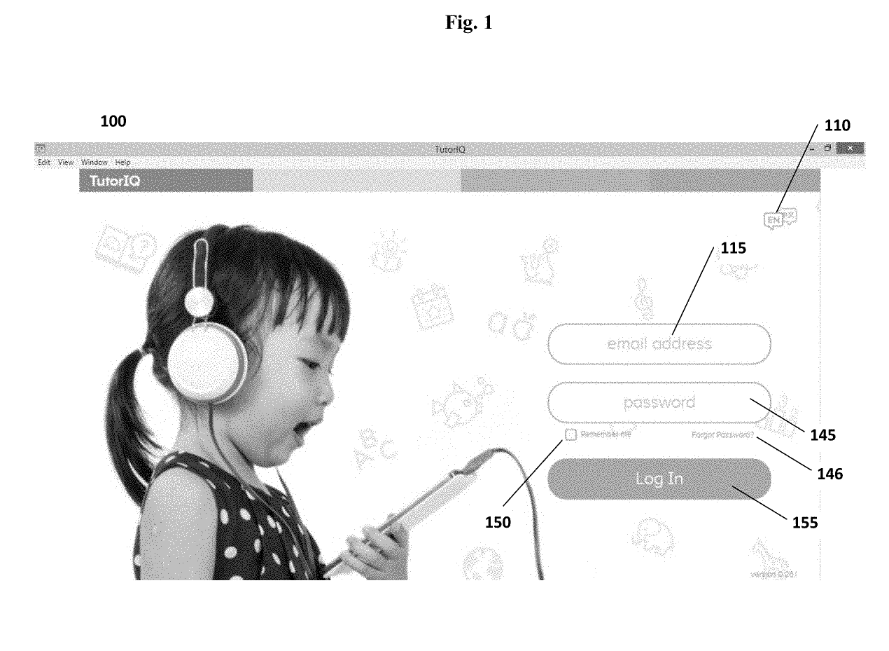

Referring to FIG. 1, in a particular embodiment, an interface for an individual to log in the remote tutoring session application is provided. In some embodiments, there is an interface 100 where the individual may provide an email address 115 and password 145, and press a “Log In” button 155 to access the application. The application optionally offers the user a “learner mode” or a “tutor mode” depending on the log-in information provided. The different modes optionally provide unique features and tools for the learner or tutor to be used during the remote tutoring session. In other embodiments, the application may also offer different modes and features for the learner's parents or guardians. In further embodiments, the application may portray an icon 150 to store the individual's log-in information for subsequent use. Moreover, other embodiments may also portray a button 110 to toggle the language portrayed on the interface 100 between English and Chinese. Those of skill in the art will recognize that the interface 100 can be displayed in any language including, by way of non-limiting examples, Chinese, Spanish, English, Hind, Arabic, Portuguese, Bengali, Russian, Japanese, French, German, Italian, or Korean.

### Learner Mode

In some embodiments, the platforms, systems, media, and methods described herein include a learner mode, or use of the same. In some embodiments, the learner mode is determined by log-in credentials. In further embodiments, the log-in credentials comprises an email address and password. In some embodiments, these features and tools include a booking module that allows a learner to purchase tutoring session credits, browse the tutor profiles, or book new tutoring sessions. In further embodiments, these features and tools include a dashboard module providing access to booked sessions and learner progress. In even further embodiments, these features and tools include a learner feedback module allowing a learner to rate tutors and completed tutoring sessions. In some embodiments, these features and tools are unique to a learner during a co-browsing activity.

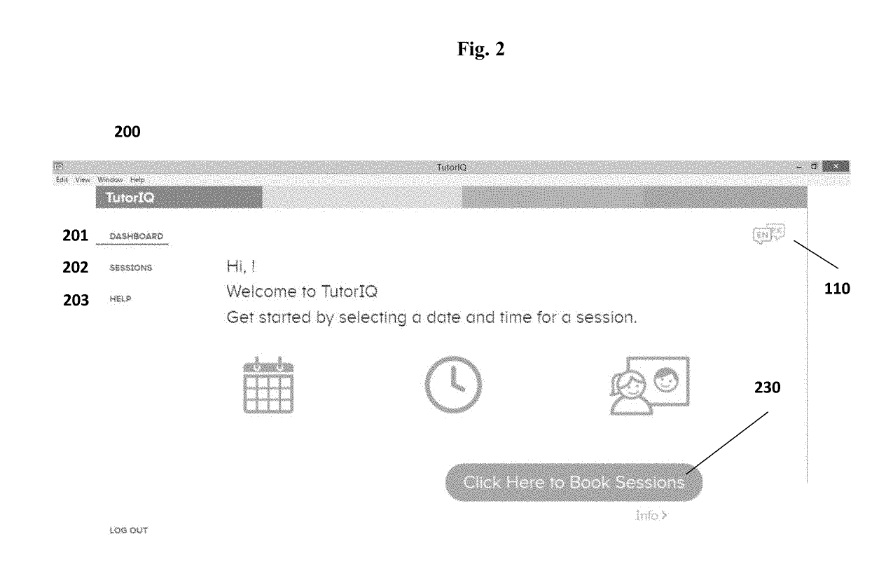

Referring to FIG. 2, in a particular embodiment, a booking module 200 for the learner mode is provided. In this embodiment, the learner has an option to book a new tutoring session 230. Further, in this embodiment, a menu is displayed which provides a learner the ability to access the dashboard 201, view tutoring sessions 202, or access the help page 203. In other embodiments, the booking module 200 is offered in the tutor mode for a tutor to book a new tutoring session. In further embodiments, the booking module offers the ability for one or more tutors to instantly start a remote tutoring with one or more learners.

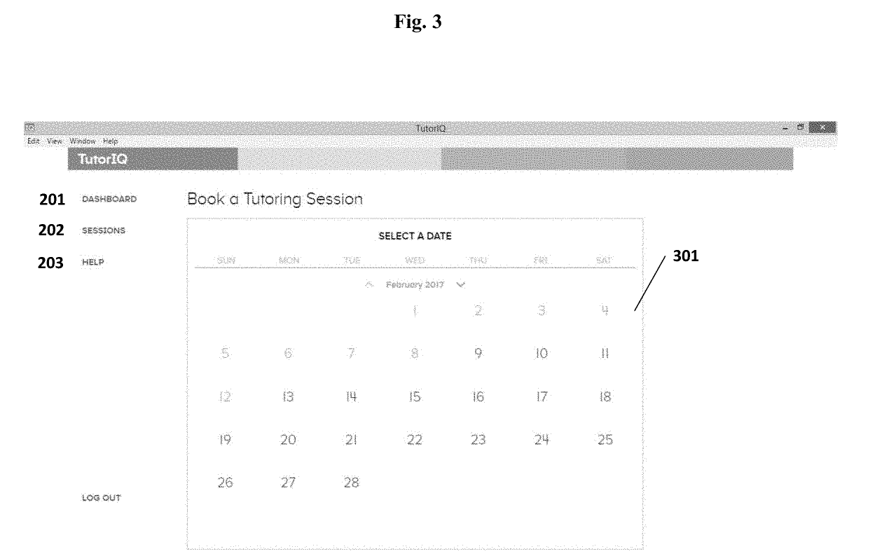

Referring to FIG. 3, in a particular embodiment, a booking module for the learner mode is provided. In this particular embodiment, a calendar 301 for the learner to select a date to book a new tutoring session is provided. FIG. 3 further displays a menu to access the dashboard 201, view tutoring sessions 202, or access the help page 203. In some embodiments, the booking module allows the learner to book up to three sessions. In some embodiments, the booking module is offered in the tutor mode for a tutor to select the dates the tutor is available for a remote tutoring session is also available.

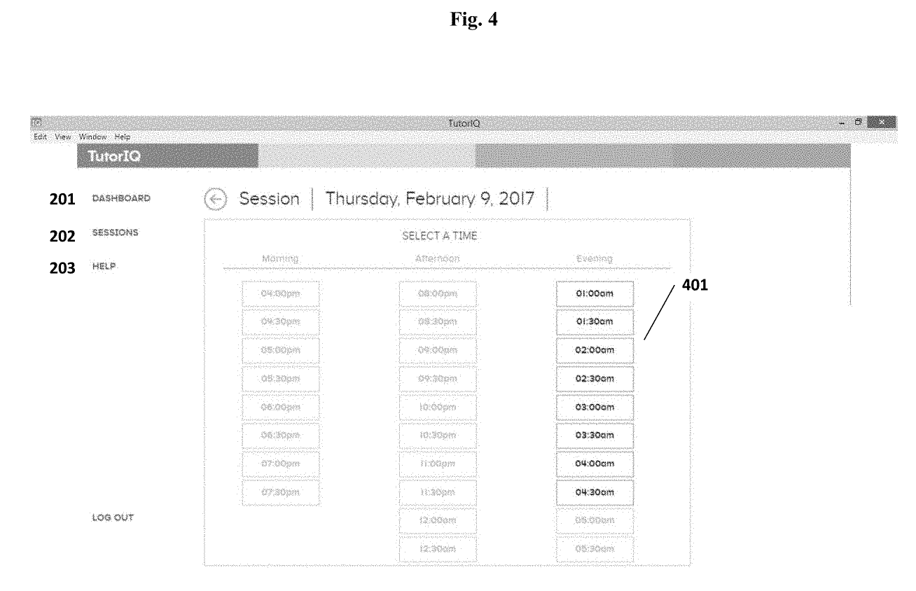

Referring to FIG. 4, in a particular embodiment, a booking module for the learner mode is provided. In this particular embodiment, a calendar 404 for the learner to select a time to book a new tutoring session once the learner selected a date in an embodiment of a booking module like the one portrayed in FIG. 3 is provided. In further embodiments, the booking module offers tutoring sessions for a predetermined duration of about 20 minutes, about 30 minutes, about 40 minutes, or about 60 minutes. In some embodiments, the booking module is offered in the tutor mode for a tutor to select the times the tutor is available for a remote tutoring session is also available.

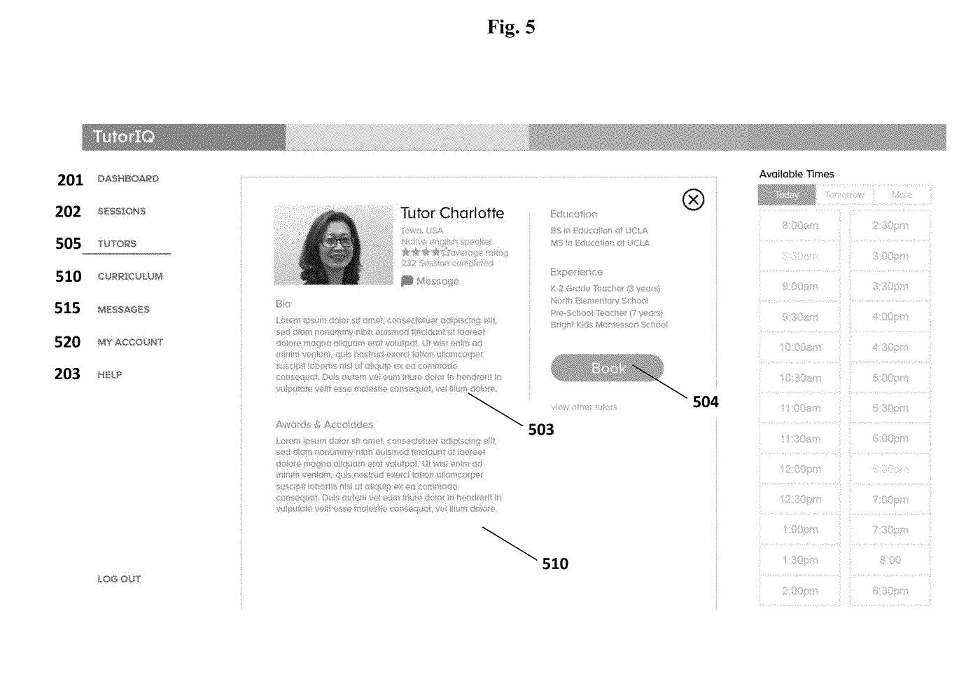

Referring to FIG. 5, in a particular embodiment, a booking module for the learner mode is provided. In this particular embodiment, the learner is allowed to browse a tutor profile. In this embodiment, the module portrays the tutor's profile 503, which may include the tutor's educational background, previous experience, awards, and accolades 510. Further, other embodiments may portray the times and dates the tutor is available for a remote tutoring session 505 and the option for a learner to book a tutoring session with the instant tutor 504. The booking module may optionally display a menu to access the dashboard 201, view tutoring sessions 202, view profiles of the tutors 305, access the curriculum 310, view messages from other learners or tutors 315, view the subscription details of the learner 320, or access the help page 203. In some embodiments, the tutor profile further comprises the tutor's name, photo, number of tutoring sessions completed, and rating. In some embodiments, the tutor profile is accessible by the tutor and the learner's guardians or parents. In some embodiments, a booking module maintains a database of tutor profiles, each profile comprising an average rating and availability of a tutor. In further embodiments, the availability of a tutor may be broken into sections of mornings, afternoons, evenings, minutes, hours, days, weekdays, weekends, weeks, holidays, months, or seasons.

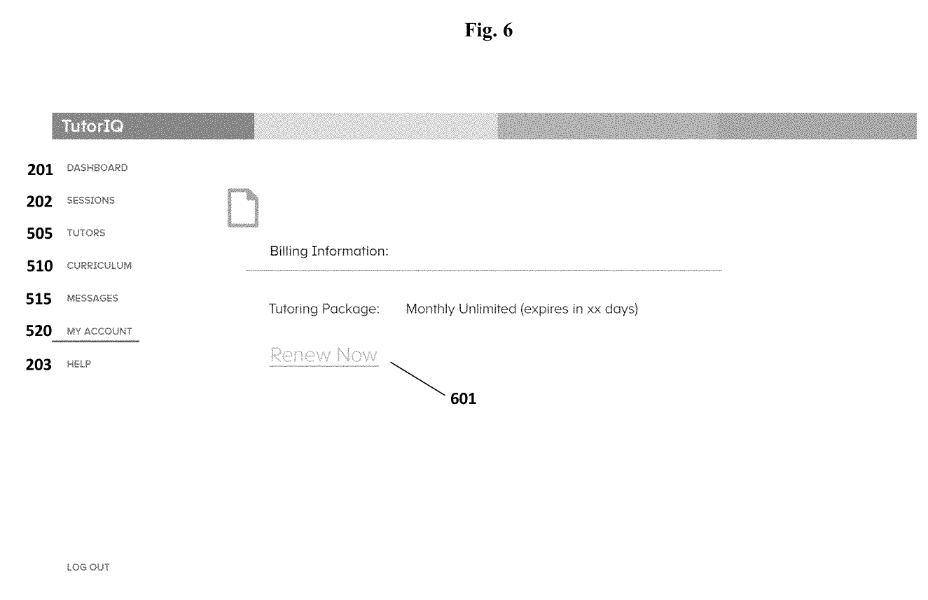

Referring to FIG. 6, in a particular embodiment, a booking module for the learner mode is provided. In this embodiment, the booking module depicts an option for the learner to purchase tutoring session credits 601. In some embodiments, a booking module for a tutor mode is provided, wherein the module acts as a billing and payment module that allows the tutor to view booked tutoring sessions and payments for completed tutoring sessions.

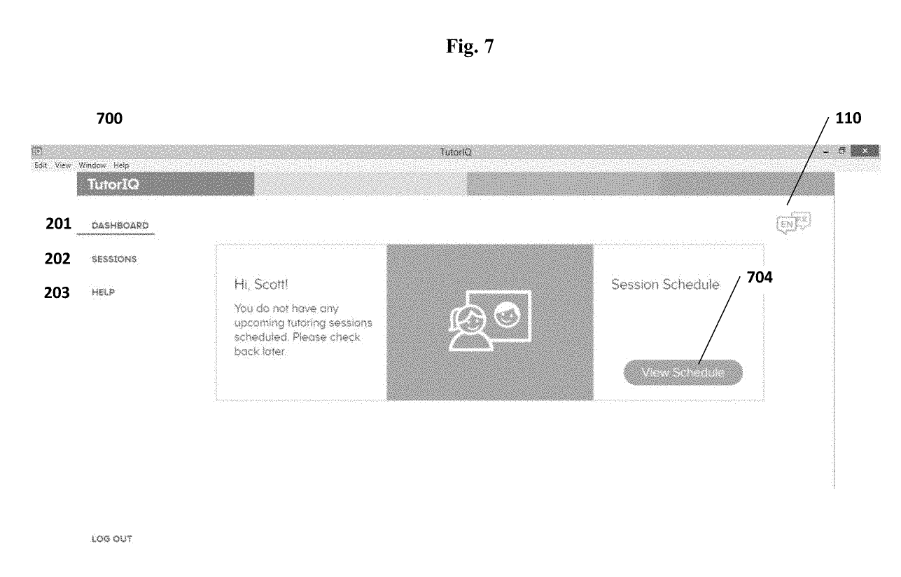

Referring to FIG. 7, in a particular embodiment, a dashboard module 700 for the learner mode is provided. In this embodiment, the dashboard module displays a menu to view the already booked tutoring session 704. In some embodiments, the dashboard module may portray the learner progress of the remote tutoring sessions. In some embodiments, the option to access the dashboard 700 is available to a tutor in the tutor mode.

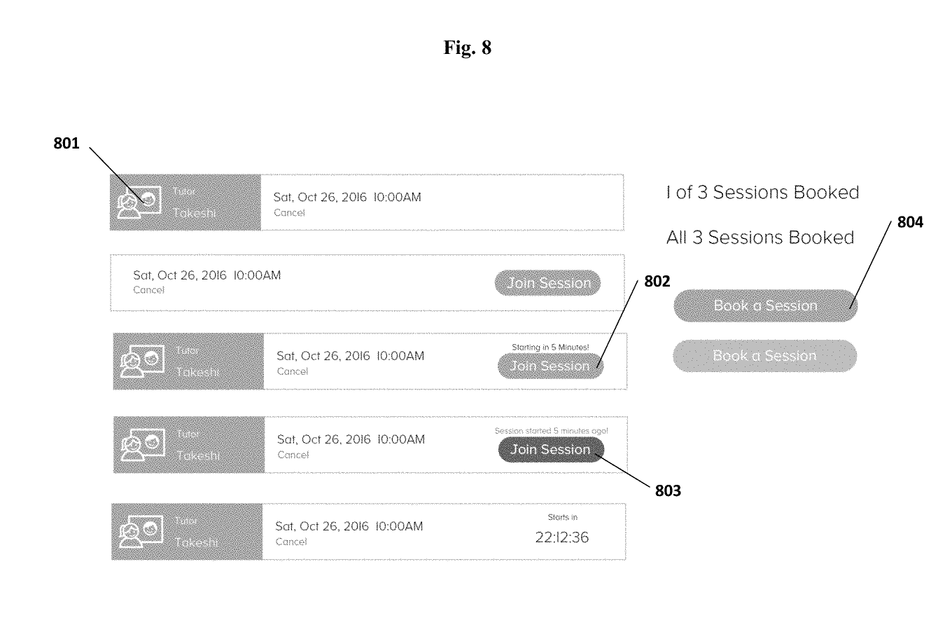

Referring to FIG. 8, in a particular embodiment, a dashboard module for the learner mode is provided. In this particular embodiment, the learner is allowed to view a summary of the different remote tutoring sessions already booked 801. In this embodiment, the dashboard module depicts buttons for the learner to join a session that is about to start in five minutes 802. Further, in this embodiment, the dashboard module further indicates if the learner is late in joining a session that has already started 803. The instant embodiment also provides the option for the learner to book other session 804. In some embodiments, the options to view a summary of the different remote sessions already booked or join a session that is about to start or has already started are available to a tutor in the tutor mode.

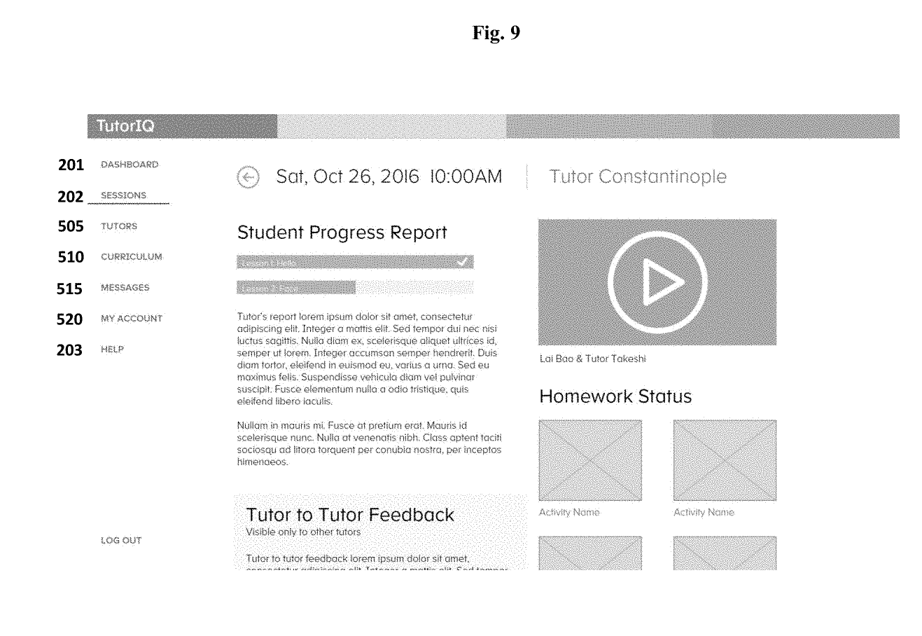

Referring to FIG. 9, in a particular embodiment, a dashboard module for the learner mode is provided. In some embodiments, the learner is allowed to view a summary of the learner progress, which may include the status of any assigned homework or completed tutoring sessions. In some embodiments, the option to view the summary of the learner progress is available to a tutor in the tutor mode.

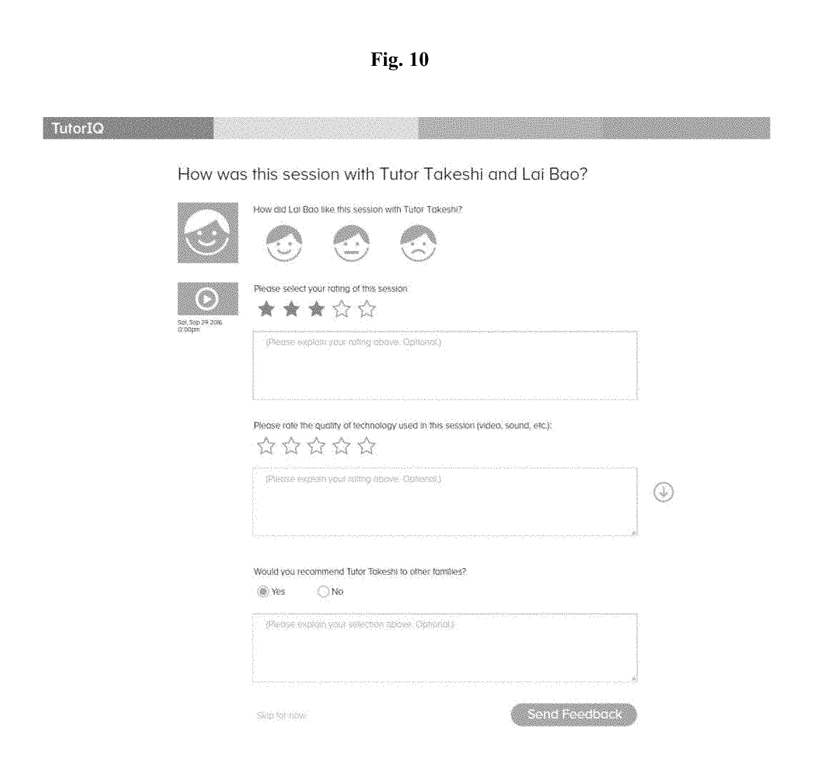

Referring to FIG. 10, in a particular embodiment, a learner feedback module for the learner mode is provided. In some embodiments, the learner is allowed to rating the tutors and completed tutoring sessions by evaluating the session, providing substantive feedback of the tutor services, or noting whether the learner would recommend the tutor to other learners. In some embodiments, the learner feedback of a particular tutor is stored to be used in a marketplace of remote tutors for other learners to access and use in selecting tutors. In further embodiments, the average rating of a tutor is stored to be used in a marketplace of remote tutors for other learners to access and use in selecting tutors.

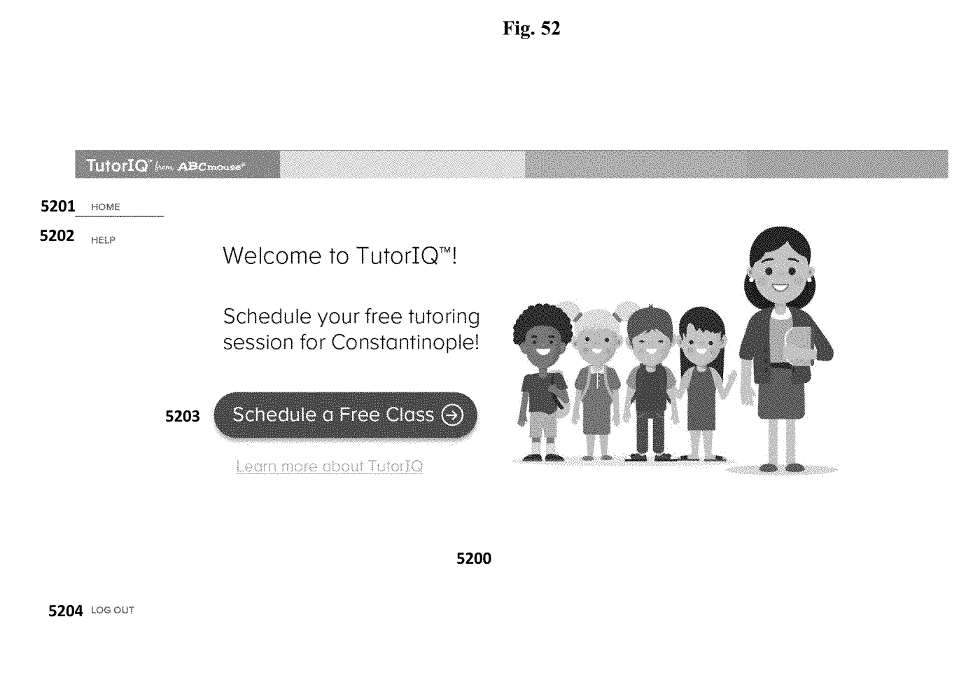

Referring to FIG. 52, in a particular embodiment, a graphic user interface depicting an onboarding screen 5200 for a learner is provided. In some embodiments, the onboarding screen 5200 displays a menu to access the home page 5201, help page 5202, and log out of the remote tutoring program 5204. In the present embodiment, the onboarding screen portrays a one-click button to allow the learner to easily schedule a class 5203.

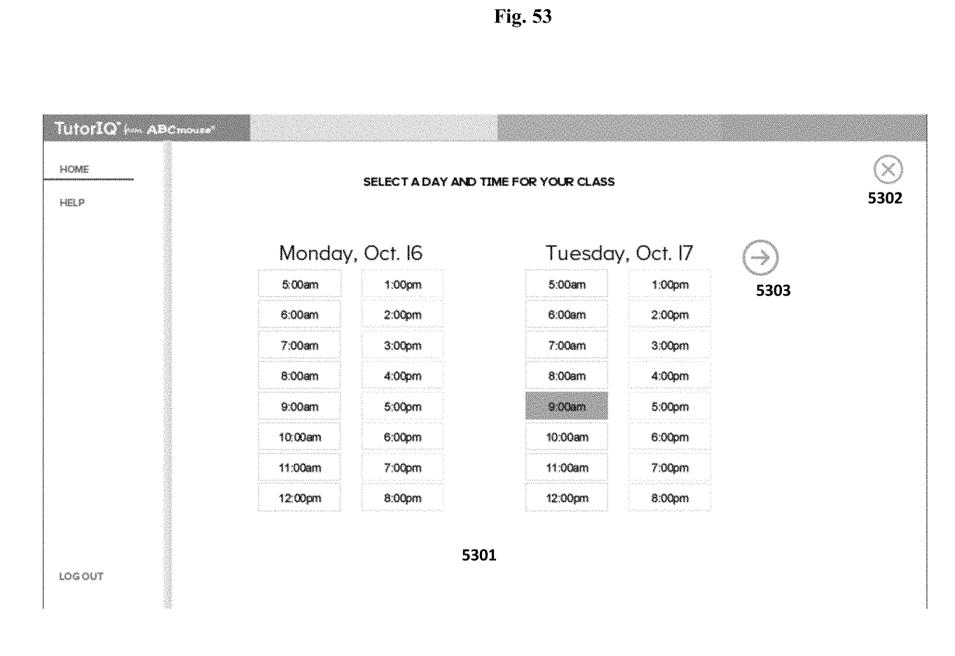

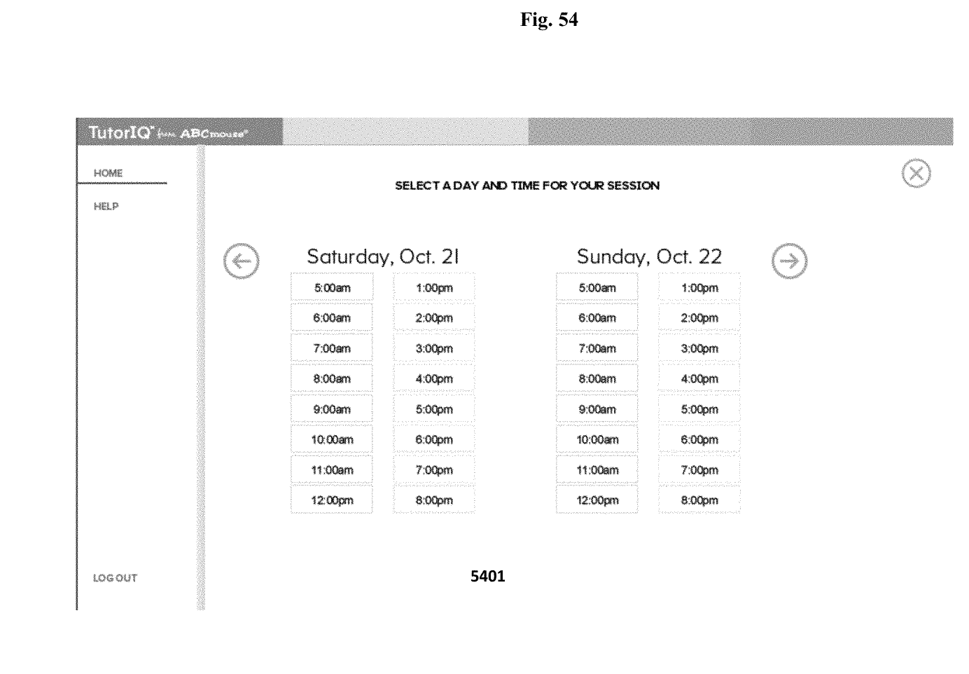

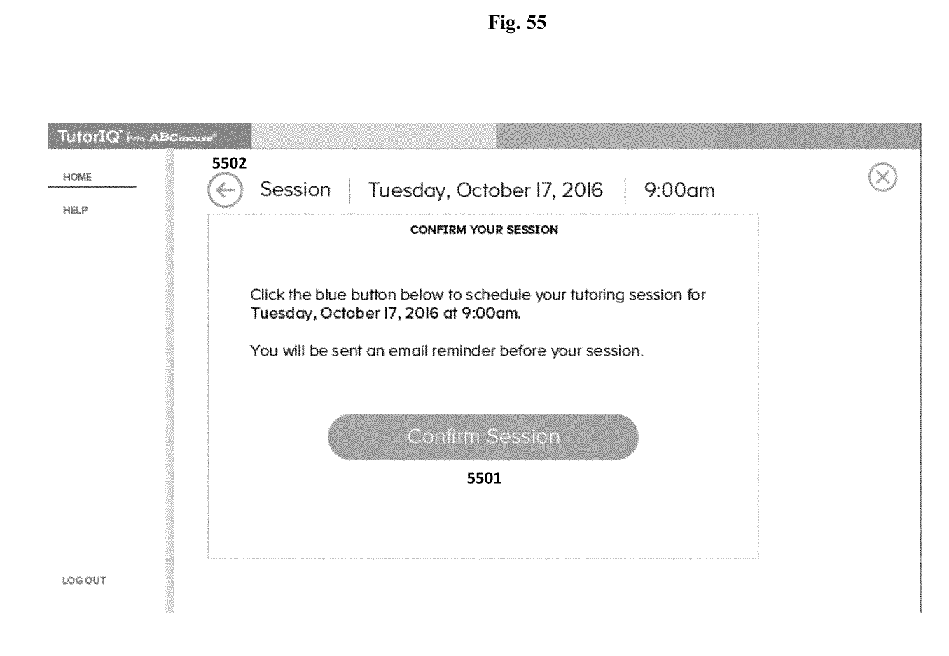

Referring to FIGS. 53-56, in particular embodiments, graphic user interfaces for a learner or someone assisting the learner to schedule future remote tutoring sessions are provided. Referring to FIG. 53, in a particular embodiment, an interface for selecting a day and time for a class 5301 is provided. The learner may close out of this page 5302 or scroll to a different page 5303 to view additional day and time options. Referring to FIG. 54, in a particular embodiment, an interface for selecting a day and time for a remote tutoring session 5401 is provided. Referring to FIG. 55, in a particular embodiment, a graphic user interface for a learner to confirm a selected session 5501 is provided.

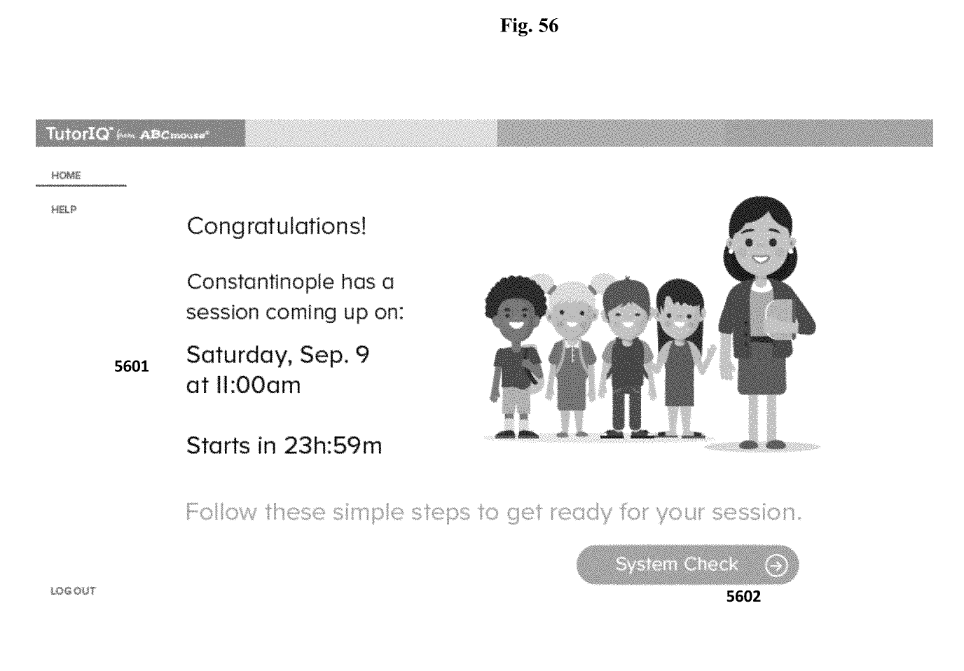

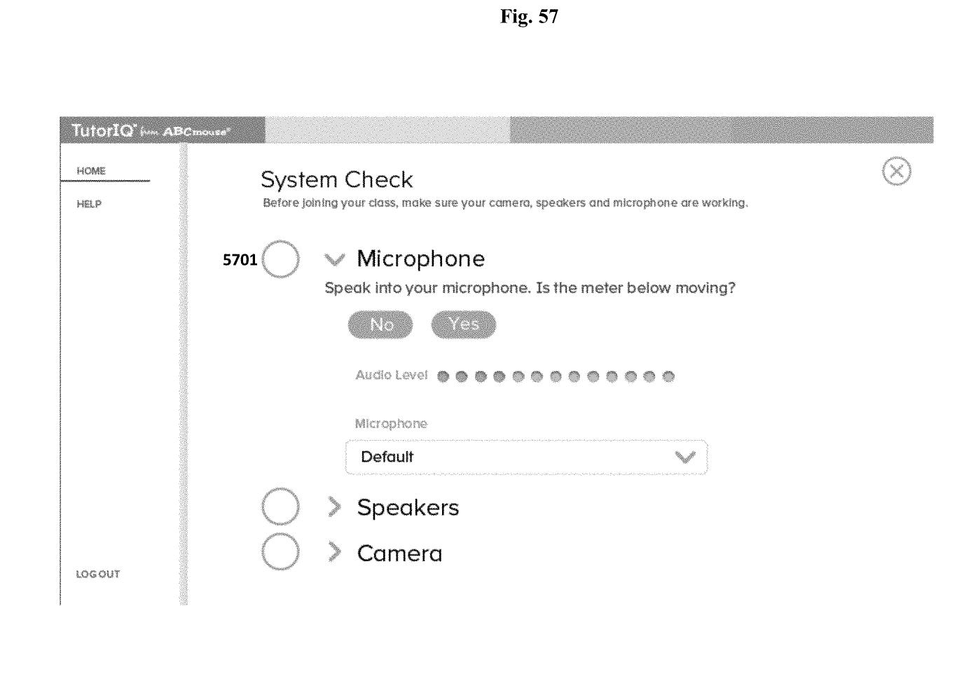

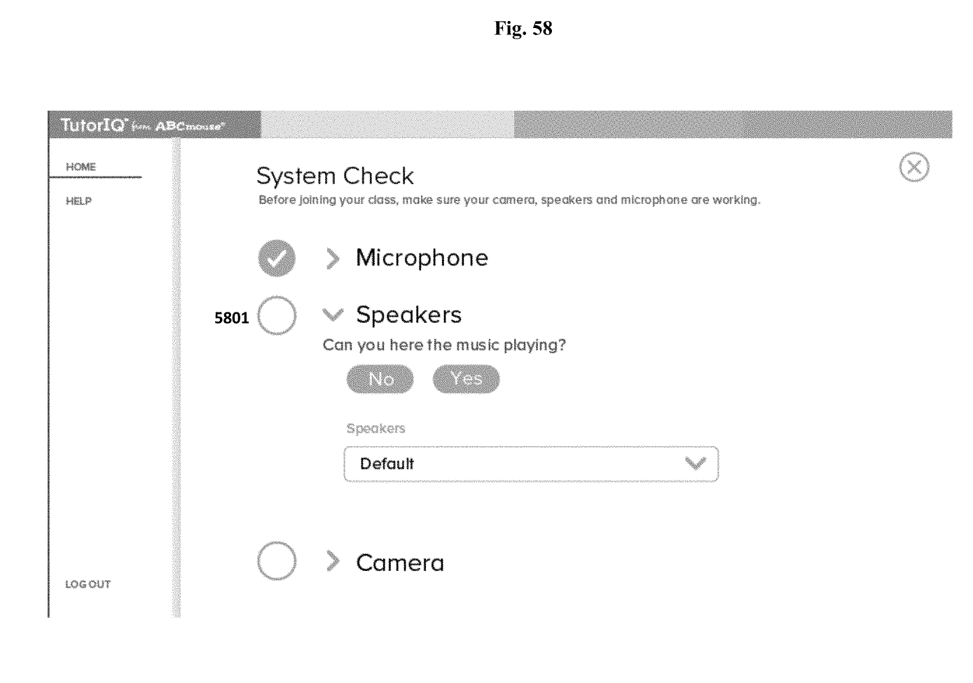

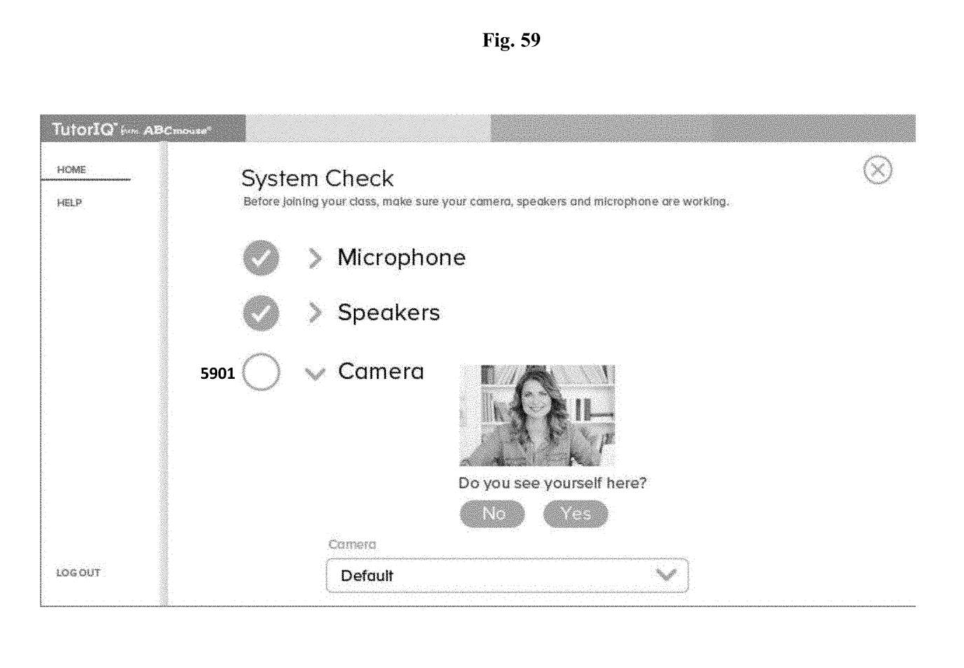

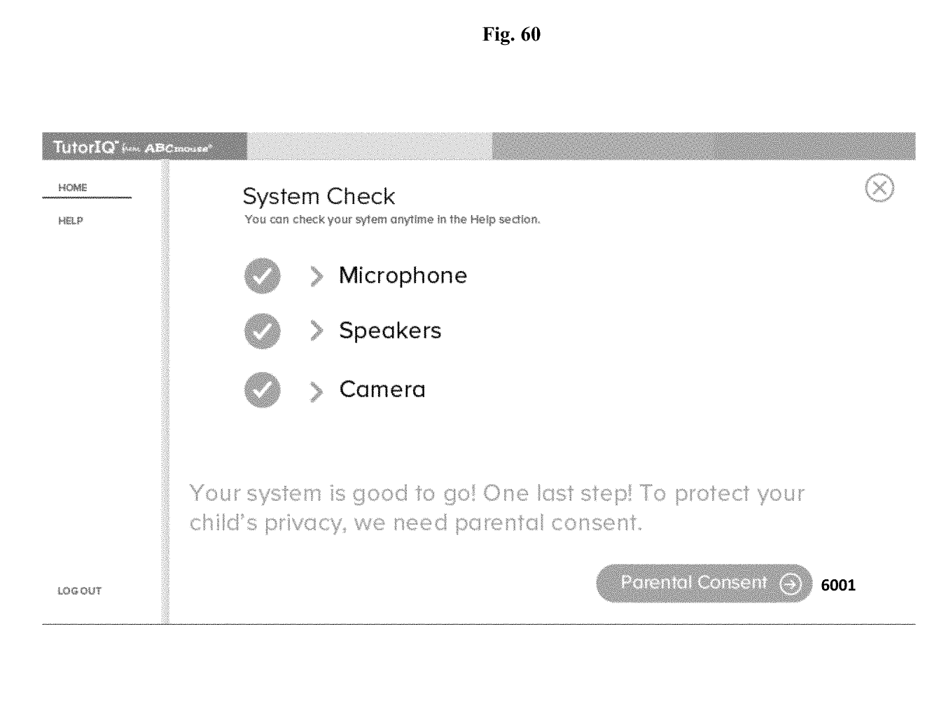

Referring to FIGS. 56-60, graphic user interfaces for a learner to conduct a system check on the system to execute the remote tutoring program are provided. Referring to FIG. 56, in a particular embodiment, the starting page for a learner to begin the system check 5602 is provided. In some embodiments, the page depicts the learner's next remote tutoring session and a countdown for when the session will begin 5601. Referring to FIG. 57, in a particular embodiment, an interface for the learner to test the functionality of the microphone 5701, e.g., confirming that the microphone is able to adequately pick up audio spoken into the microphone, is provided. Referring to FIG. 58, in a particular embodiment, an interface for the learner to test the functionality of the speakers 5801, e.g., that the learner can hear sounds and music, is provided. Referring to FIG. 59, in a particular embodiment, an interface for the learner to test the functionality of the camera 5901, e.g., that the learner can view himself or herself, is provided. Referring to FIG. 60, in a particular embodiment, an interface confirming that the system's microphone, speakers, and camera are properly functioning is provided. In some embodiments, the learner or the parent of the learner is allowed to give parent consent 6001 for a learner to participate in the remote tutoring sessions.

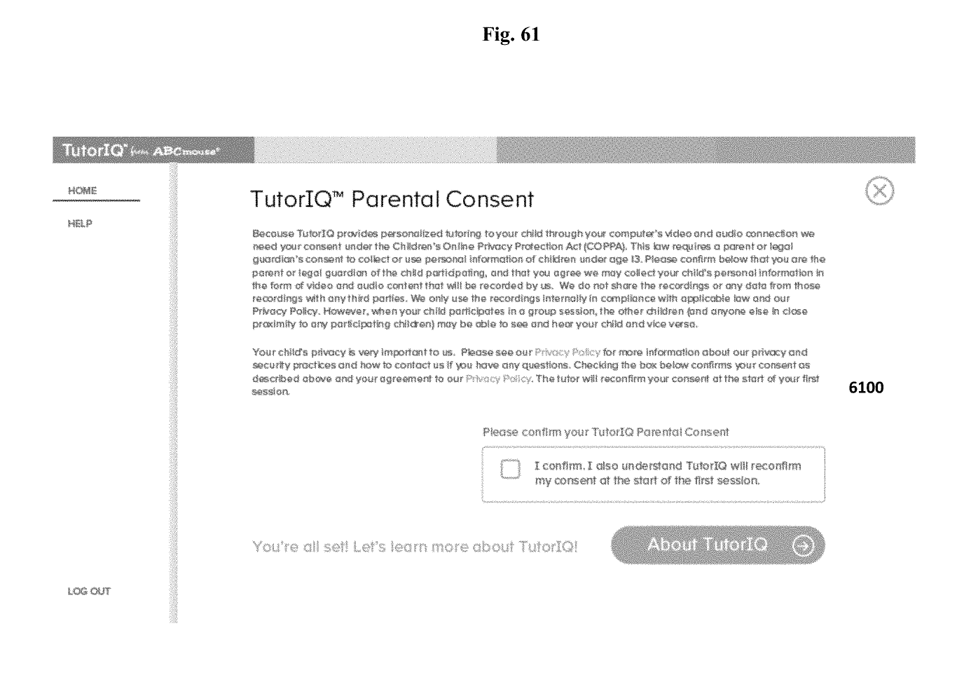

Referring to FIG. 61, in a particular embodiment, an interface depicting a parent consent form for a learner to participate in a remote tutoring session 6100 is provided.

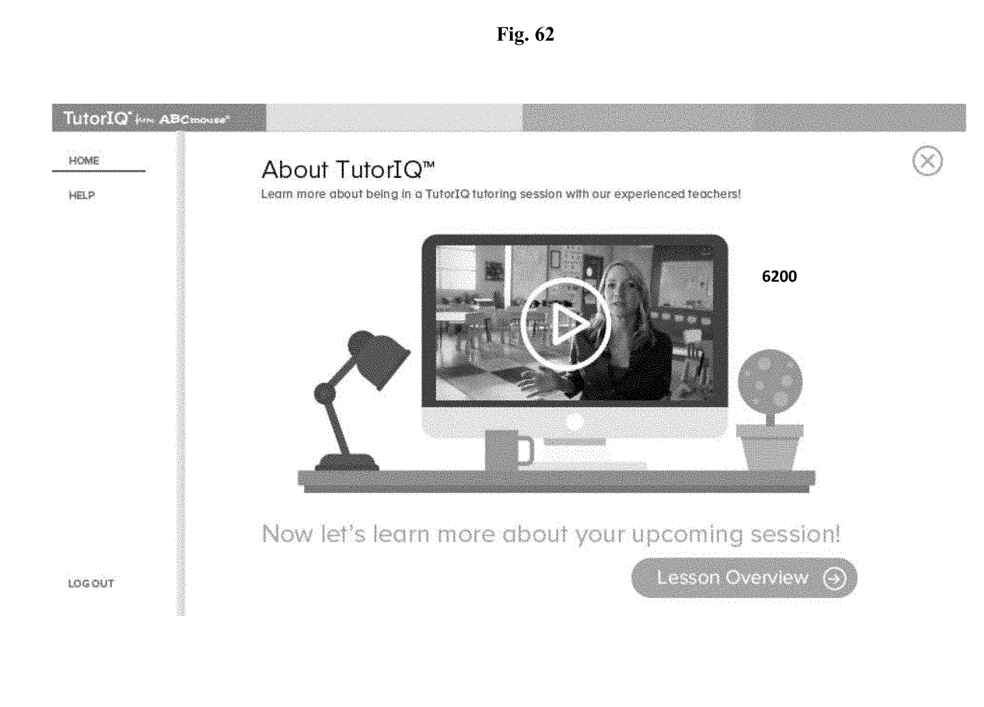

Referring to FIG. 62, in a particular embodiment, an interface depicting an overview of the remote tutoring program 6200 is provided.

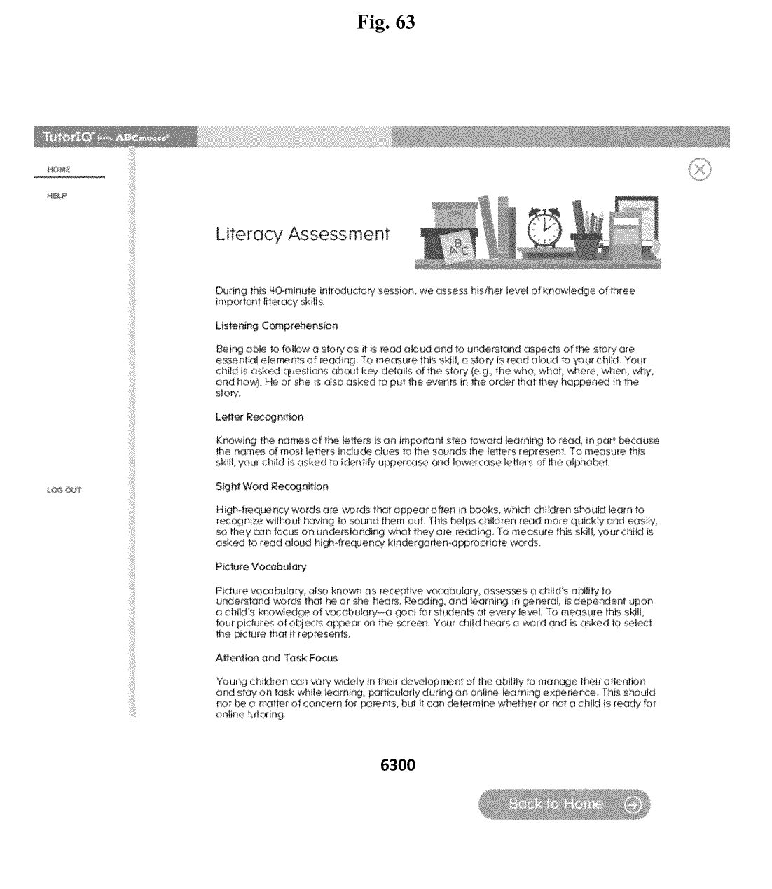

Referring to FIG. 63, in a particular embodiment, an interface for assessing the literacy competency of the learner 6300 is provided.

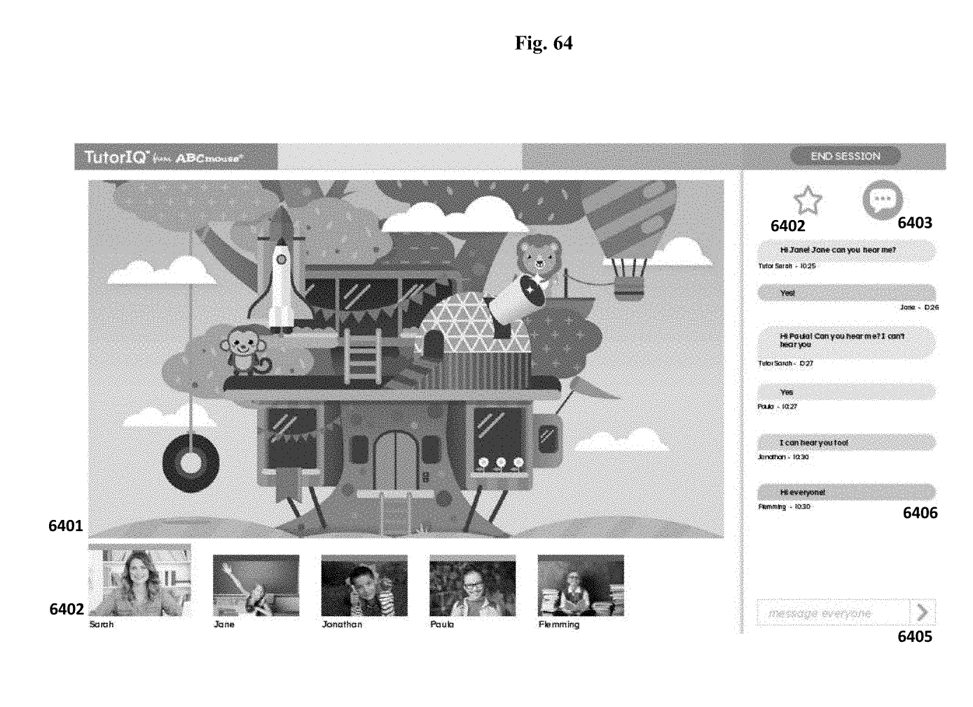

Referring to FIG. 64, in a particular embodiment, an interface for a learner in a remote tutoring session is provided. The learner interface provides, in some embodiments, a chat module 6403, which allows a learner to type in text in a chat box 6405 and communicate back and forth with one or more learners or tutors via chat 6406. In some embodiments, the chats are color coded to allow easy tracking of which learner or tutor provided the chat. The learner interface further provides, in additional embodiments, the learner is able to view a video screenshot of himself or herself along with a video screenshot of his or her tutor 6402 near the bottom of the interface below the main screen 6401 where one or more learning activities may be depicted.

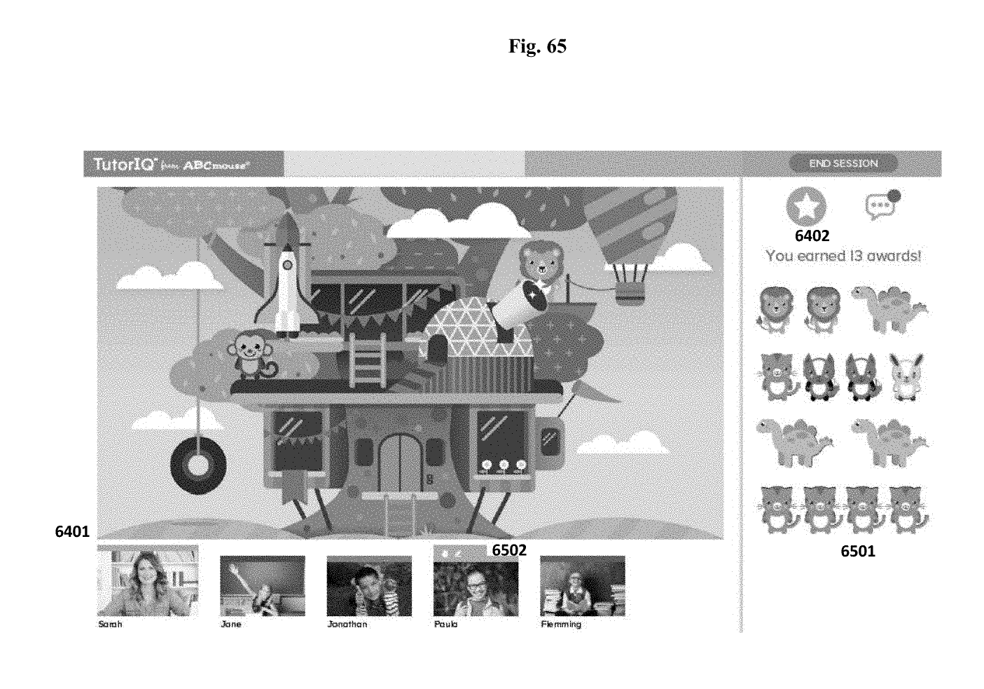

Referring to FIG. 65, in a particular embodiment, an interface for a learner in a remote tutoring session is provided. The learner interface provides, in some embodiments, a module 6402 for a learner to view the different stickers and awards the learner received from the tutor or after completion of different learning activities 6501. In some embodiments, the different stickers and awards are interactive. In some embodiments, the learner is able to select the video image or still image of the learner's icon to reveal a menu 6502 that provides additional features. In further embodiments, these features may include the ability to notify the tutor that the learner has a question. In other embodiments, these features may also include the ability to utilize whiteboarding features onto the main screen 6401. In further embodiments, the learner is only able to utilize the features in the menu 6502 after the tutor grants permission.

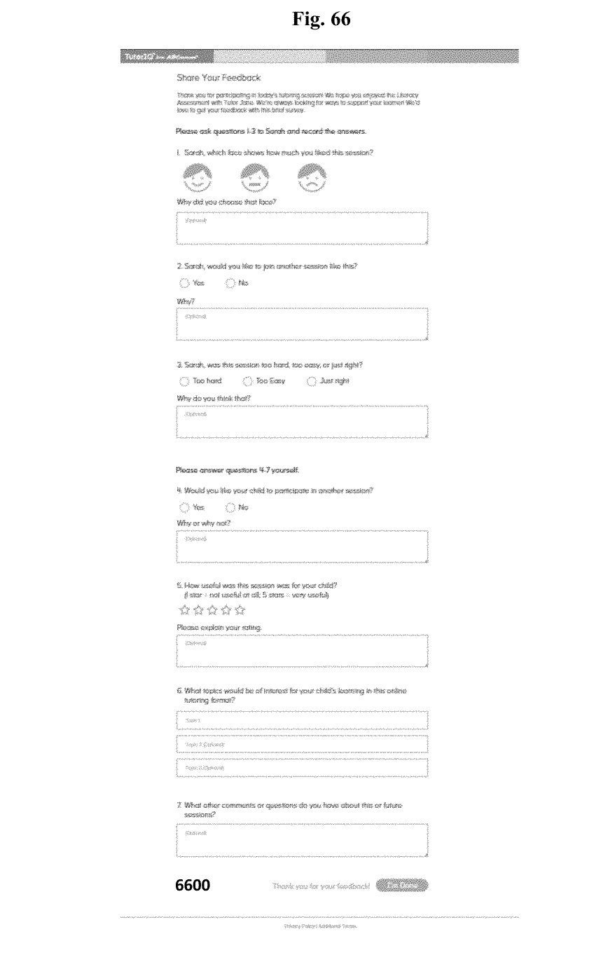

Referring to FIG. 66, in a particular embodiment, an interface for the tutor to provide feedback on one or more learners 6600 is provided.

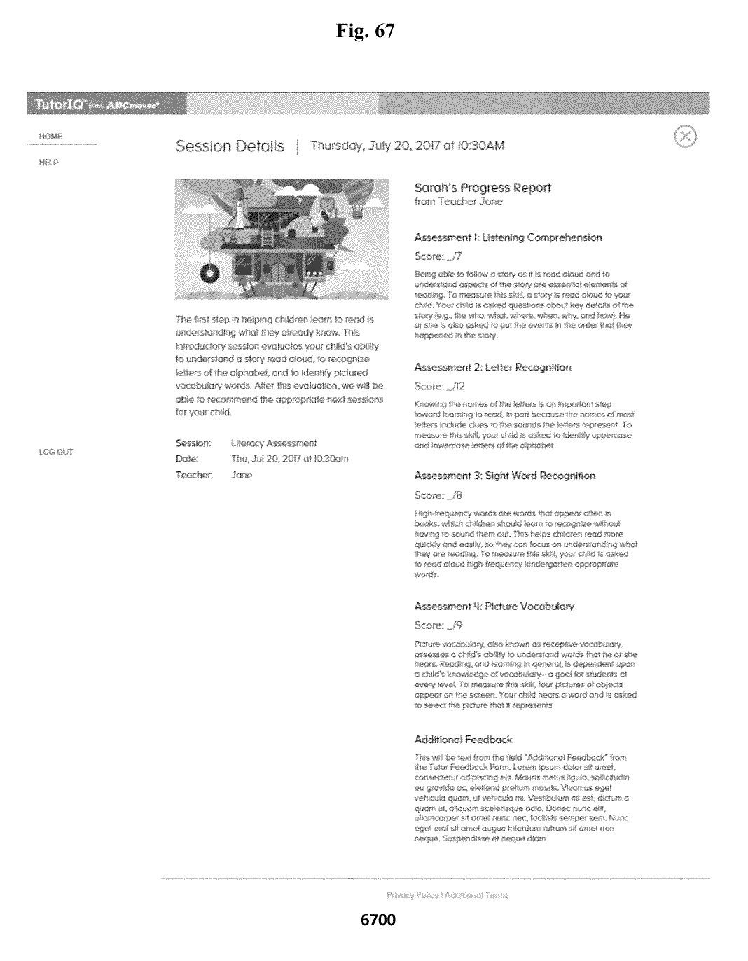

Referring to FIG. 67, in a particular embodiment, an interface for a tutor to provide a progress report on one or more learners 6700 is provided.

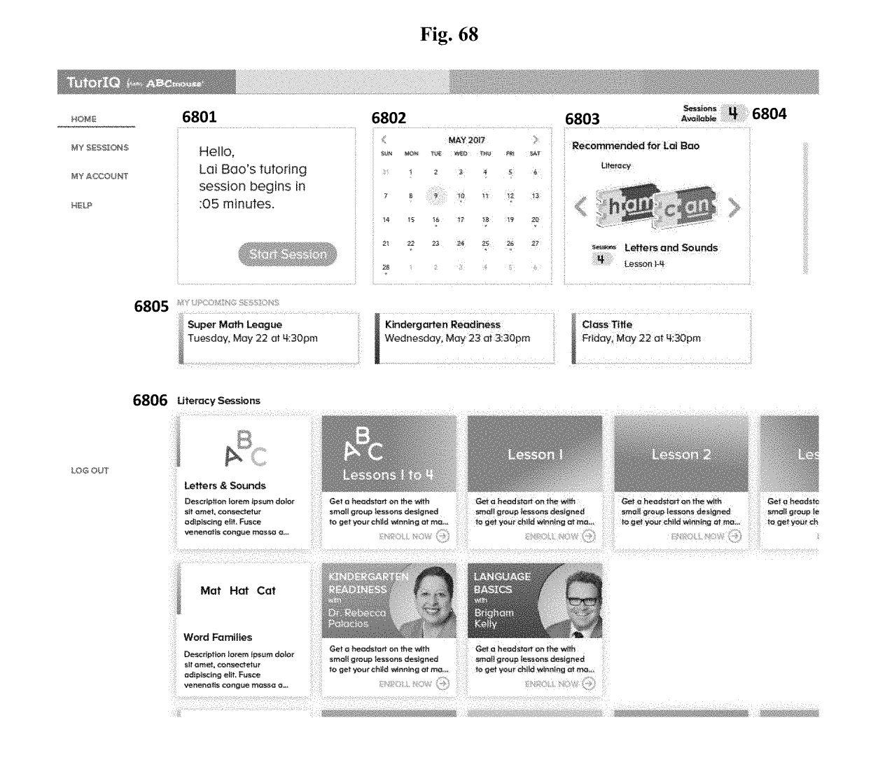

Referring to FIG. 68, in a particular embodiment, the home page for a learner is provided. In some embodiments, the home page reminds the learner when the next remote tutoring session will begin 6801. In other embodiments, the home page provides a calendar 6802 with indications of dates when the learner has scheduled one or more remote tutoring sessions. In further embodiments, the home page provides recommendations to the learner on which remote tutoring sessions lessons the learner should take 6803 and also depicts how many sessions the learner has available 6804. In even further embodiments, the home page describes in further detailed the next upcoming sessions 6805, e.g., the name, date, and start time of these sessions. In other embodiments, the home page provides an overview of various remote tutoring sessions in a variety of subjects suitable for a learner. Many subjects are suitable and include, by way of non-limiting examples, math, reading, science, social studies, art, music, language arts, foreign language, and combinations thereof. Similarly, many levels of learning are suitable and include, by way of non-limiting examples, a pre-K, level, a Kindergarten level, a first grade level, a second grade level, a third grade level, a fourth grade level, a fifth grade level, a sixth grade level, a seventh grade level, an eighth grade level, a ninth grade level, a tenth grade level, an eleventh grade level, a twelfth grade level, and the like, including intermediate levels between. In other embodiments, a co-browsing activity is not linked to a school grade level, but instead is a proficiency level, a fluency level, a competency level, a mastery level, or a combination thereof.

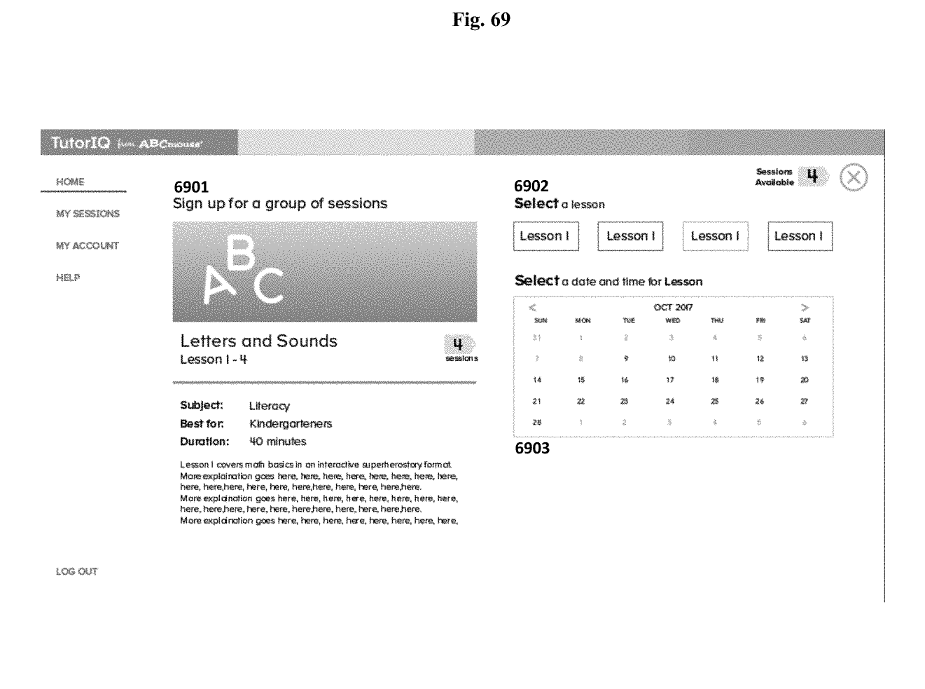

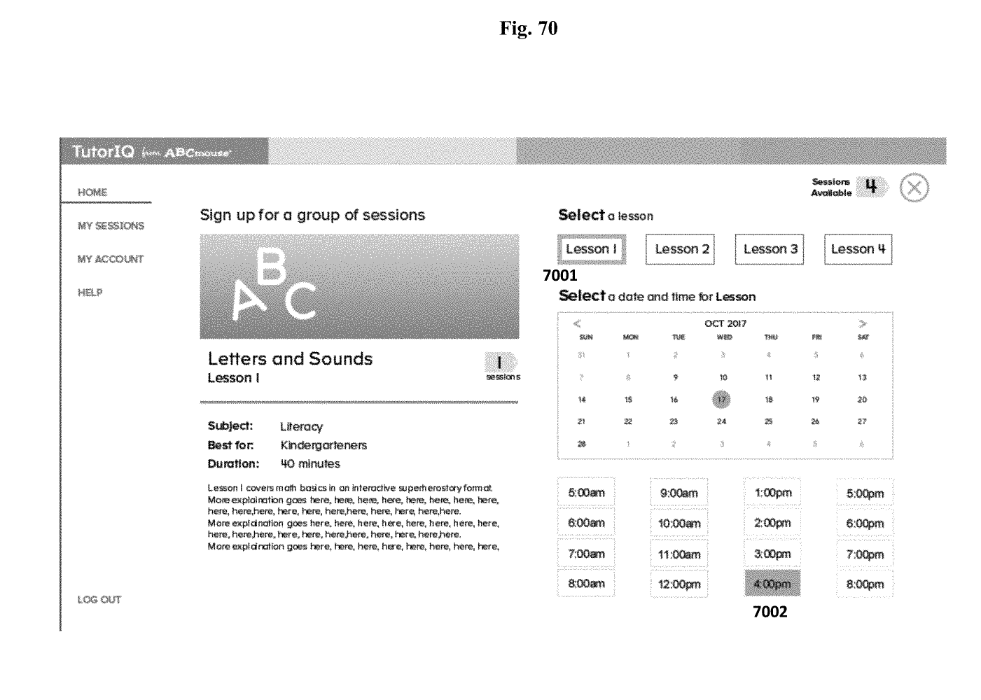

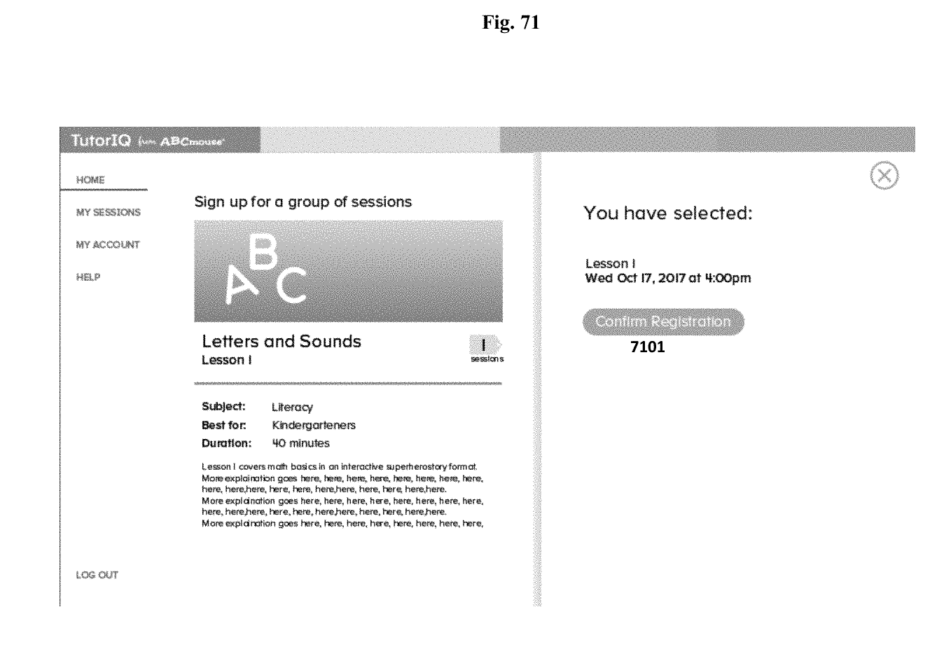

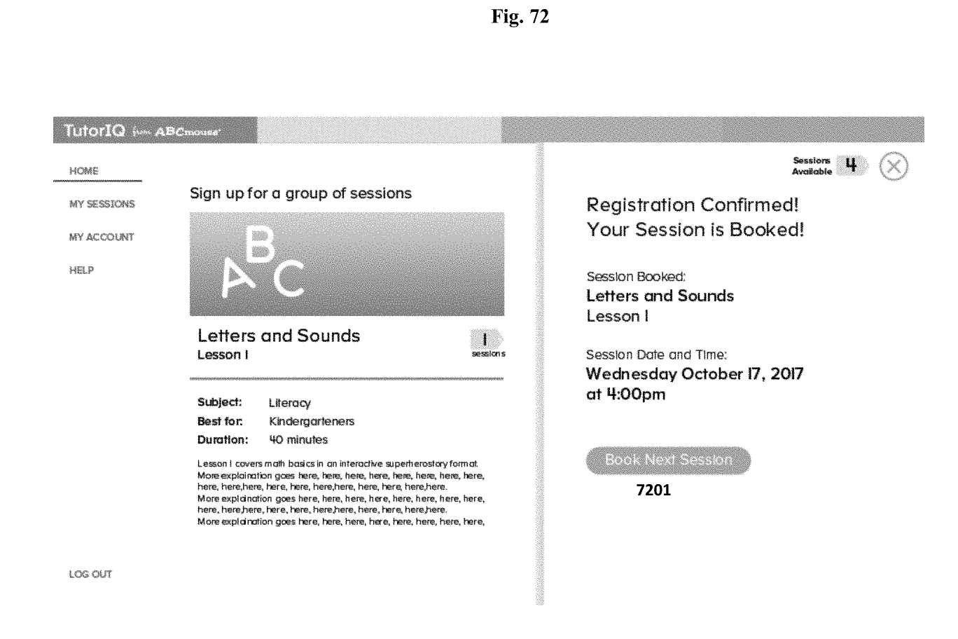

Referring to FIGS. 69-72, in particular embodiments, interfaces for a learner to select and book remote tutoring sessions are provided. Referring to FIG. 69, in a particular embodiment, an interface for a learner to sign up for a remote tutoring session 6901, select a lesson 6902, and select a day and time for the lesson 6903 is provided. Referring to FIG. 70, in a particular embodiment, the interface depicts a learner selecting a lesson 7001 along with a day and time for the lesson 7002. Referring to FIG. 71, in a particular embodiment, the interface provides a learner the option to confirm registration of a selected lesson and its day and time 7101. Referring to FIG. 72, in a particular embodiment, the interface provides a learner the option to book another remote tutoring session 7201.

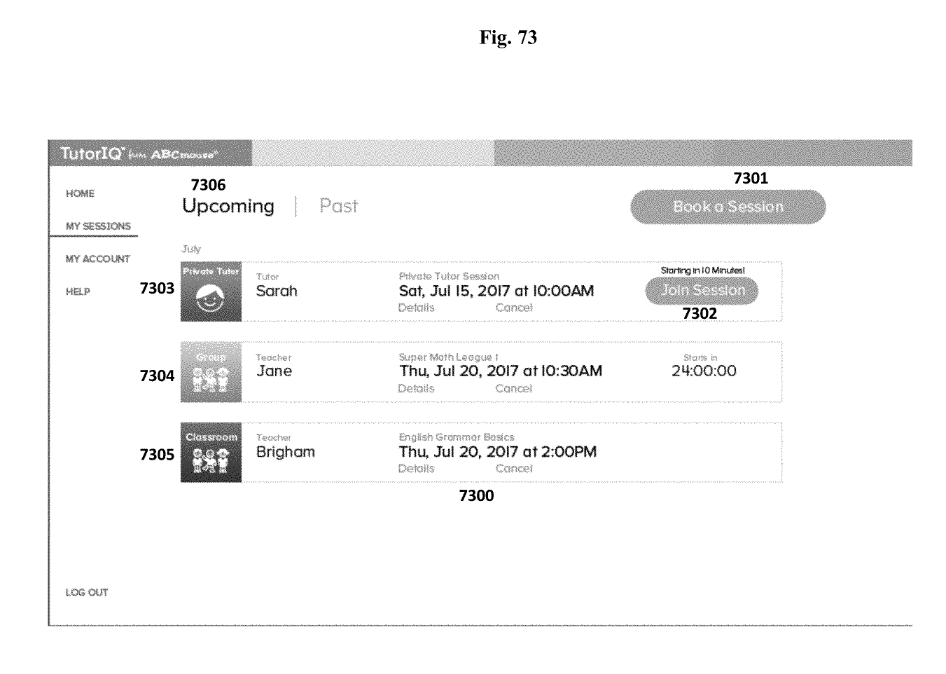

Referring to FIG. 73, in a particular embodiment, an interface for depicting upcoming remote tutoring sessions for the learner 7306 is provided. The interface describes details of the upcoming remote tutoring session. In some embodiments, the details include the name of the tutor, start time, and date of the session, and the name of the session 7300. In further embodiments, the interface describes whether the tutoring session is private 7303, in a small group 7304, or a classroom sized setting 7305. In other embodiments, the interface allows the learner to book another session 7301 or join a session if it has already started 7302.

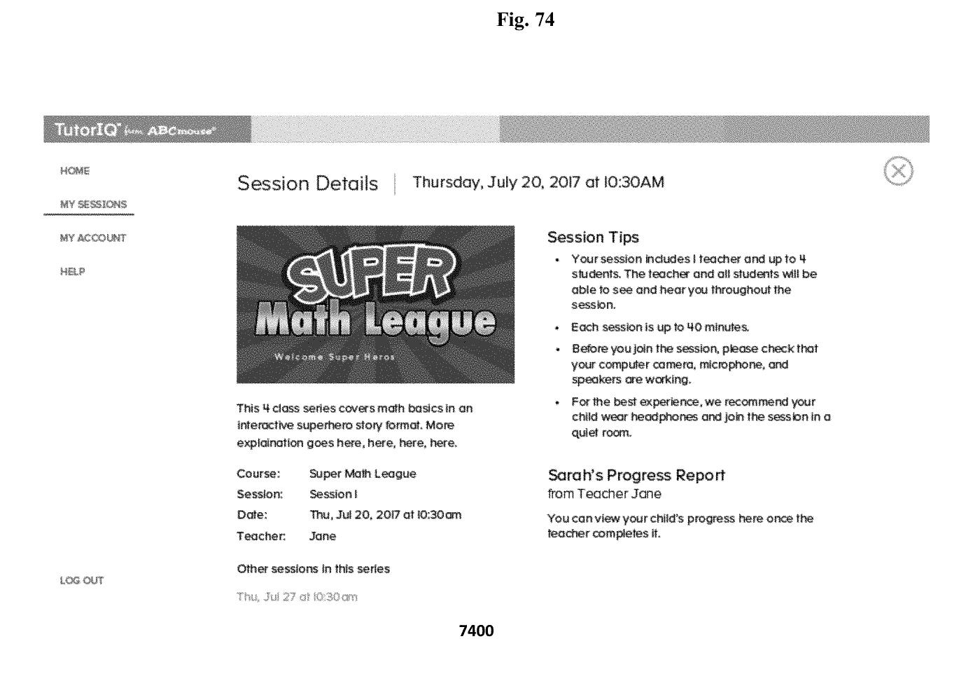

Referring to FIG. 74, in a particular embodiment, an interface for viewing upcoming remote tutoring sessions 7400 is provided.

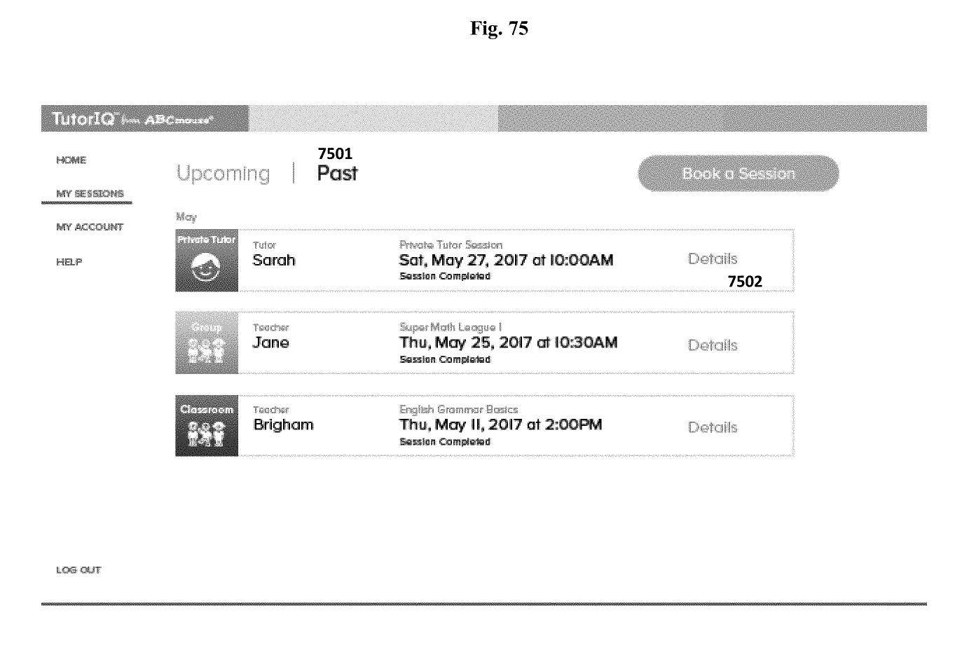

Referring to FIG. 75, in a particular embodiment, an interface for viewing an overview of past remote tutoring sessions 7501 and details of past remote tutoring sessions 7502 is provided.

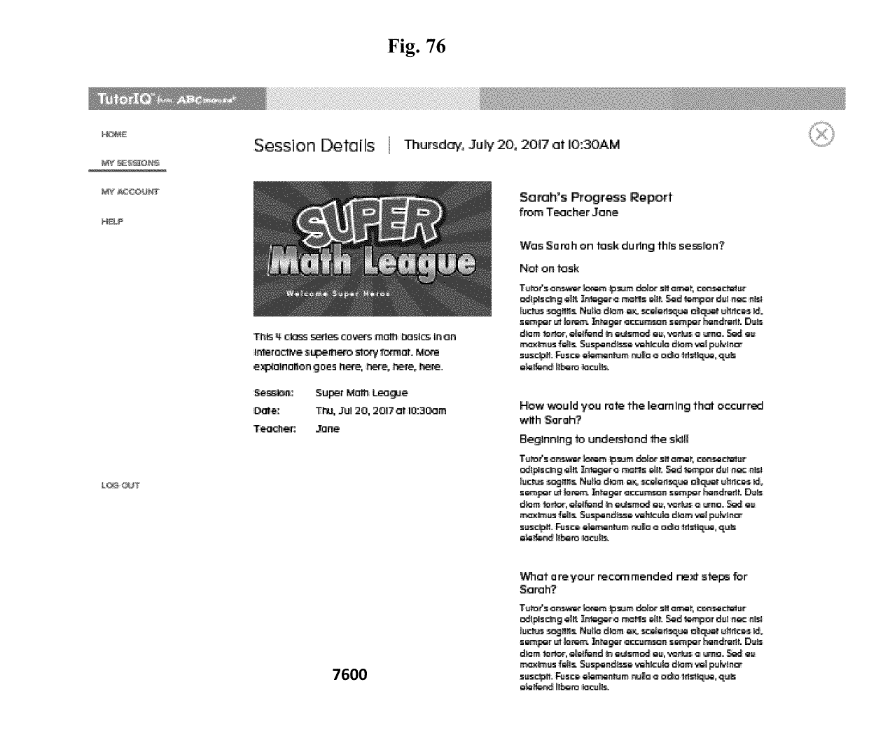

Referring to FIG. 76, in a particular embodiment, an interface for viewing details of past remote tutoring sessions 7600 is provided.

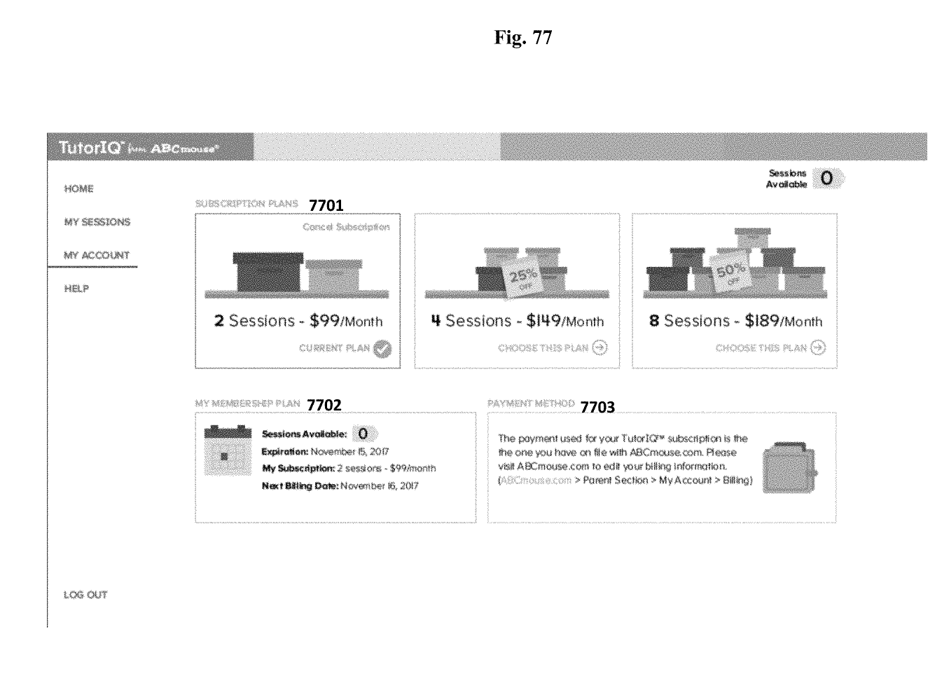

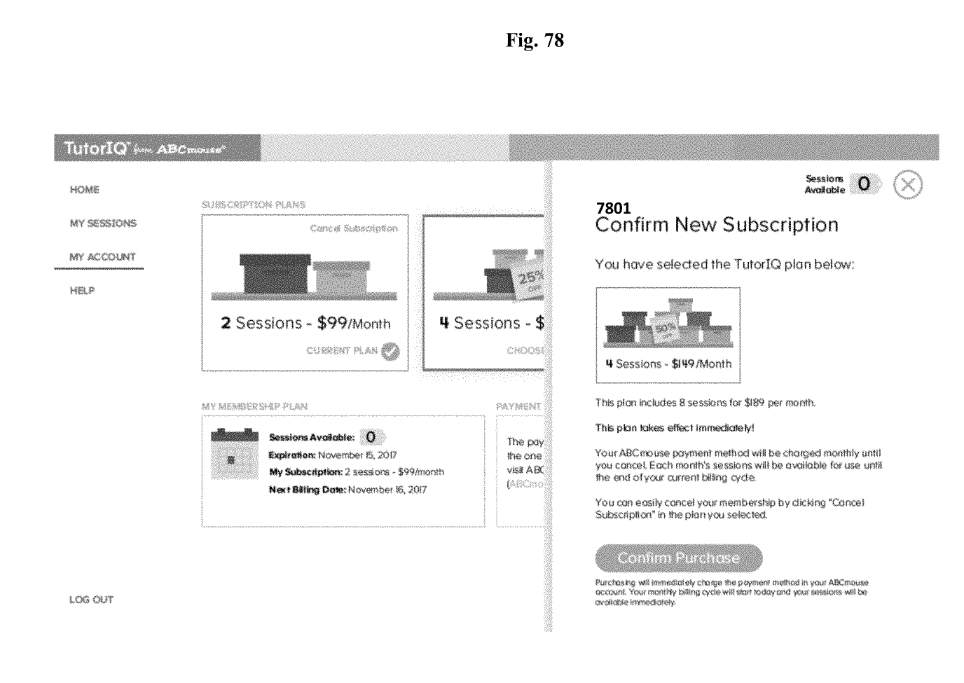

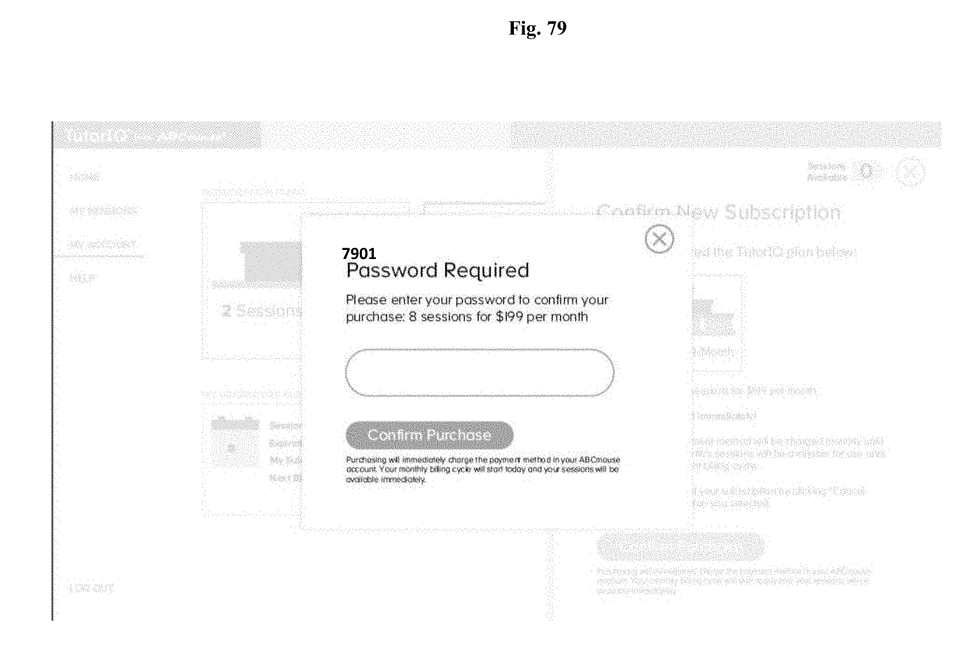

Referring to FIGS. 77-79, in particular embodiments, interfaces for a learner or helper to a learner may purchase one more remote tutoring session plans are provided. Referring to FIG. 77, in a particular embodiment, the interface depicts the various available subscription plans 7701, the membership plan of the learner or user 7702, and methods to remit payment 7703. Referring to FIG. 78, in a particular embodiment, the interface depicts the selected subscription plan and requests confirmation 7801. Referring to FIG. 79, in a particular embodiment, the interface requires a password 7901 from a user before proceeding with purchase of the selected subscription plan. In some embodiments, the password must come from a parent, guardian, mentor, or helper of the learner.

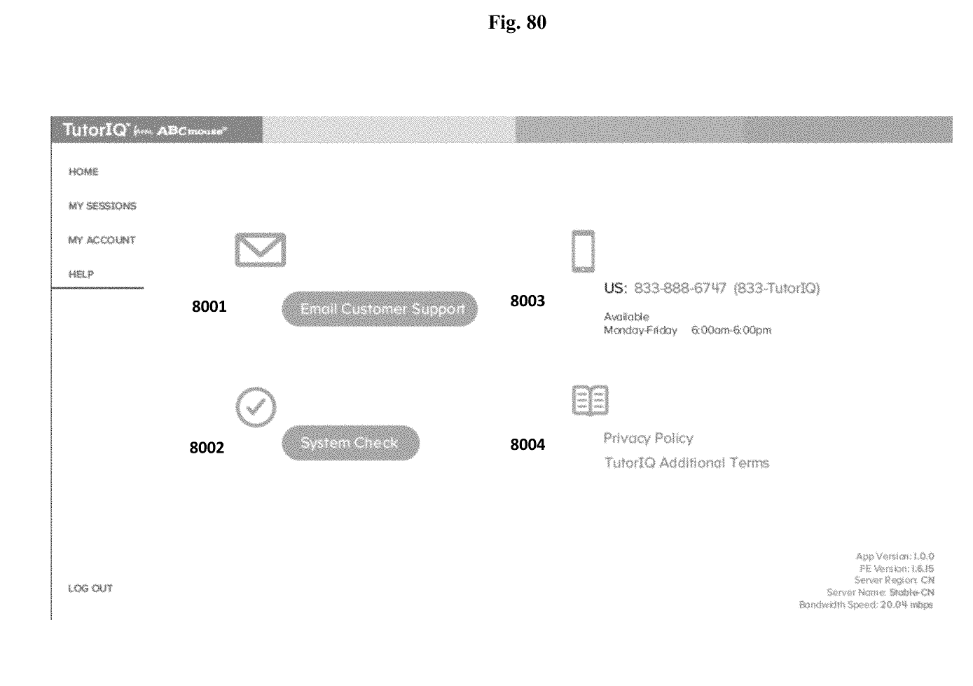

Referring to FIG. 80, in a particular embodiment, the help page is provided. In some embodiments, the help page provides the tutor with access to email customer support 8001, perform a system check 8002, call customer support 8003, or view the privacy policy of the remote tutoring session 8004.

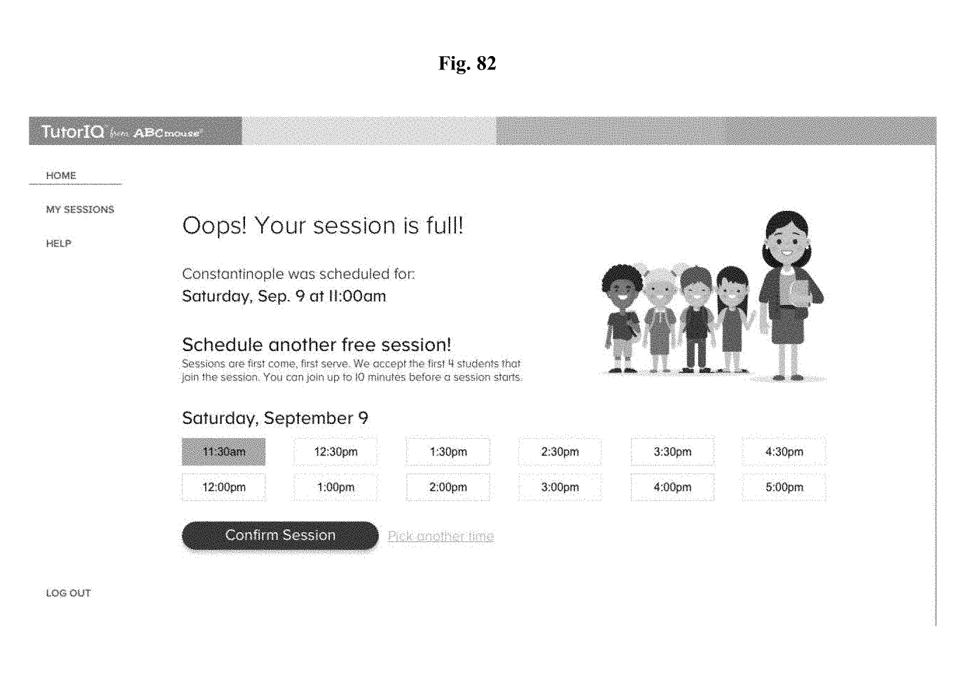

Referring to FIG. 82, in a particular embodiment, an interface for a parent to re-schedule a tutoring session is provided. In some embodiments, if a student has not successfully attended a session, the student or parent can reschedule their session by selecting another time.

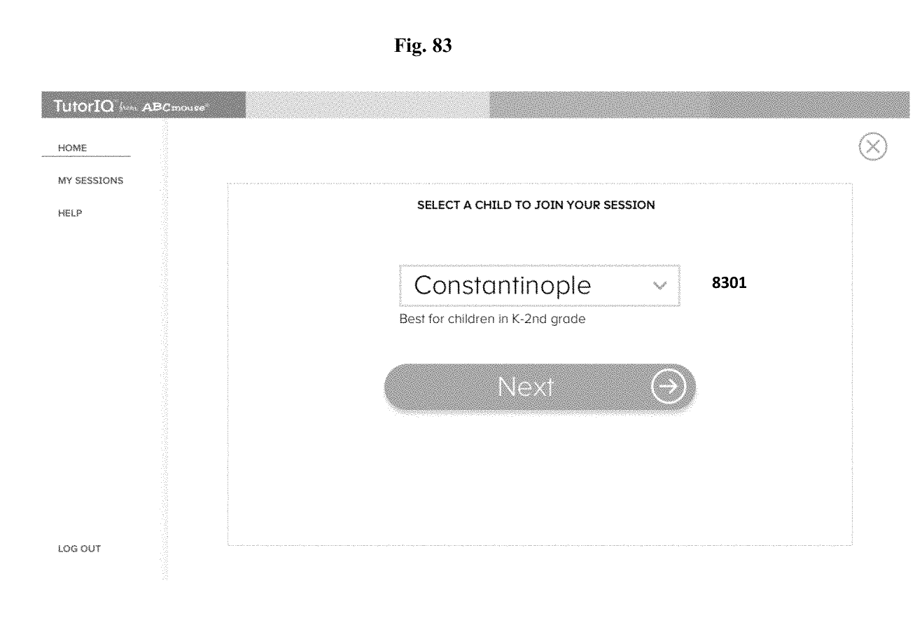

Referring to FIG. 83, in a particular embodiment, an interface for a parent with more than one child learner to select which child is registering for a tutoring session is provided.

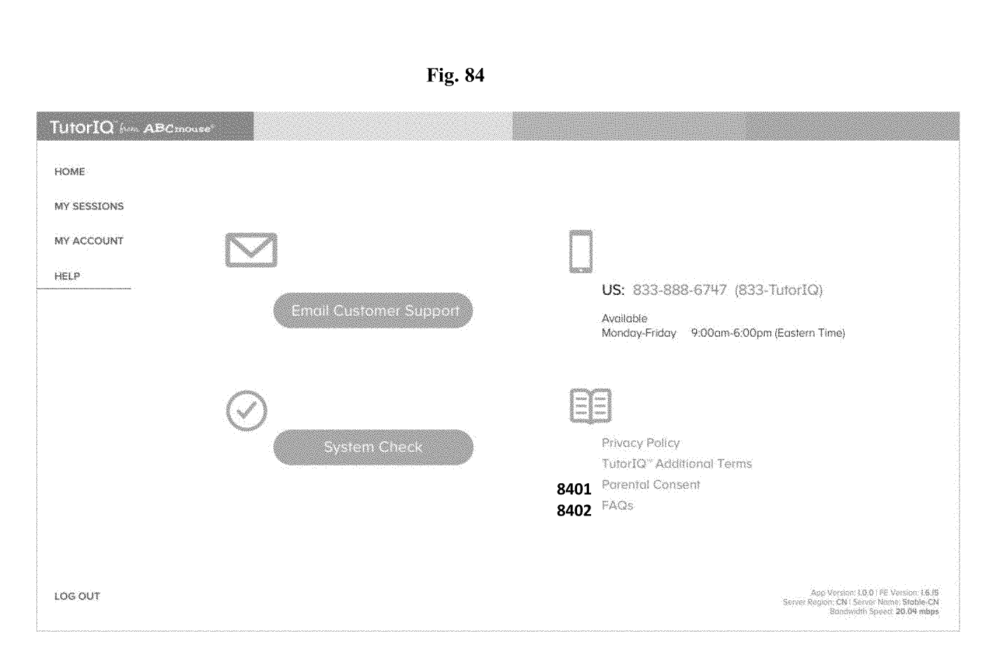

Referring to FIG. 84, in a particular embodiment, a help page is provided. In some embodiments, a parent may be referred to a parental consent link 8401 or to a frequently asked questions link 8402.

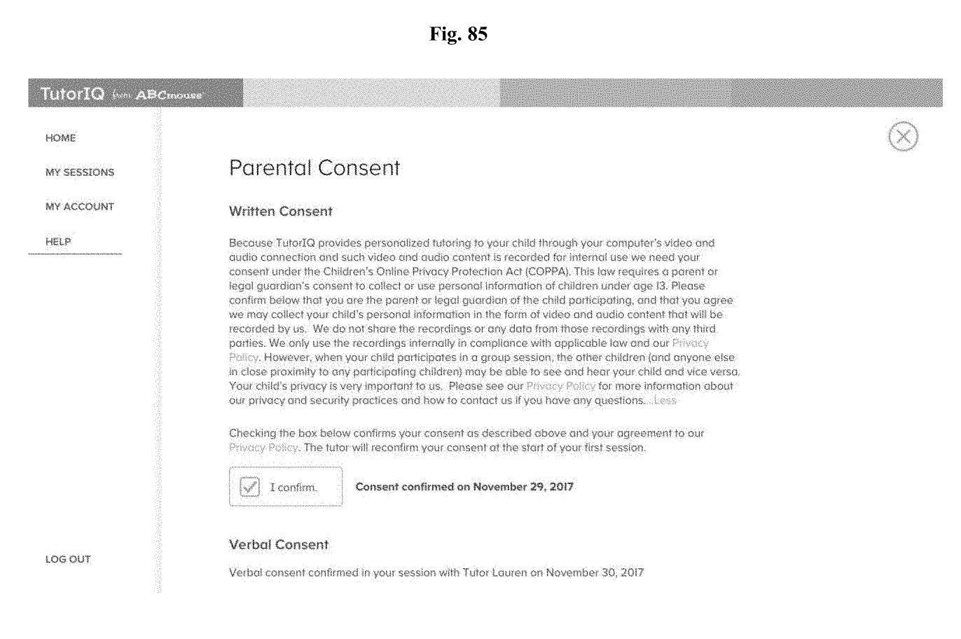

Referring to FIG. 85, in a particular embodiment, an interface for a parent to provide consent is provided. In some embodiments, parents are displayed the date they confirmed their written and/or verbal consent. In other embodiments, the parent can remove their written consent on this page and/or add it back again at any time.

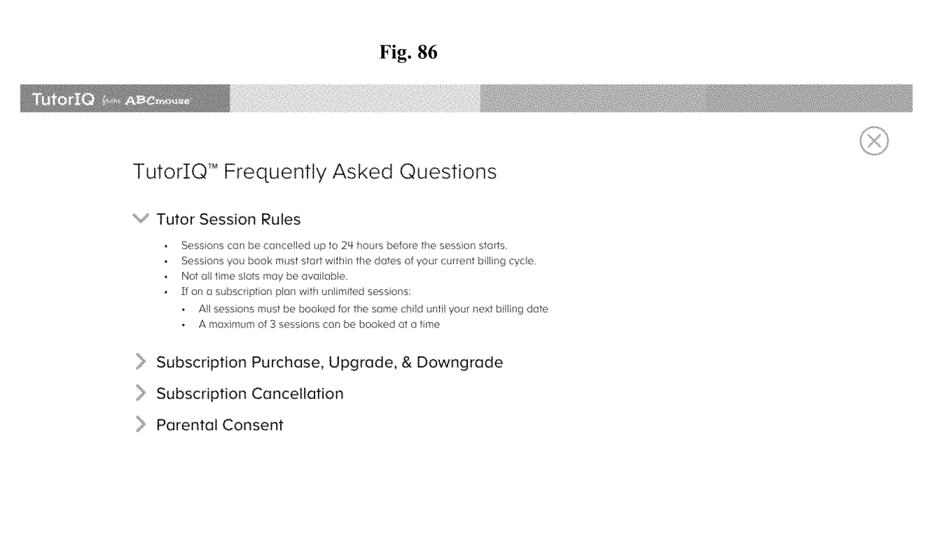

Referring to FIG. 86, in a particular embodiment, an interface for displaying the general rules around tutoring sessions is provided.

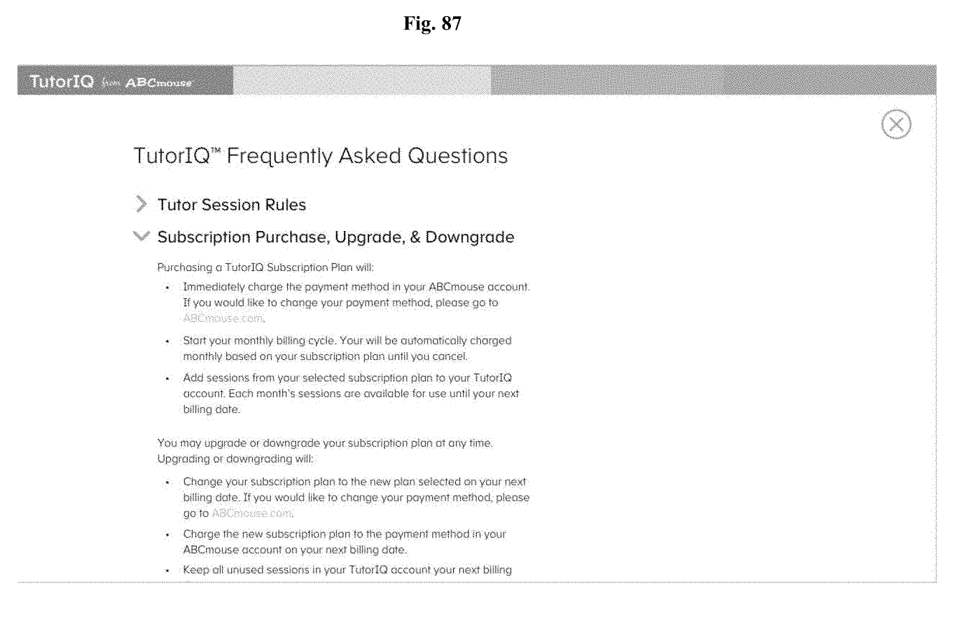

Referring to FIG. 87, in a particular embodiment, an interface for displaying the general rules around subscription purchasing, upgrading, and downgrading is provided.

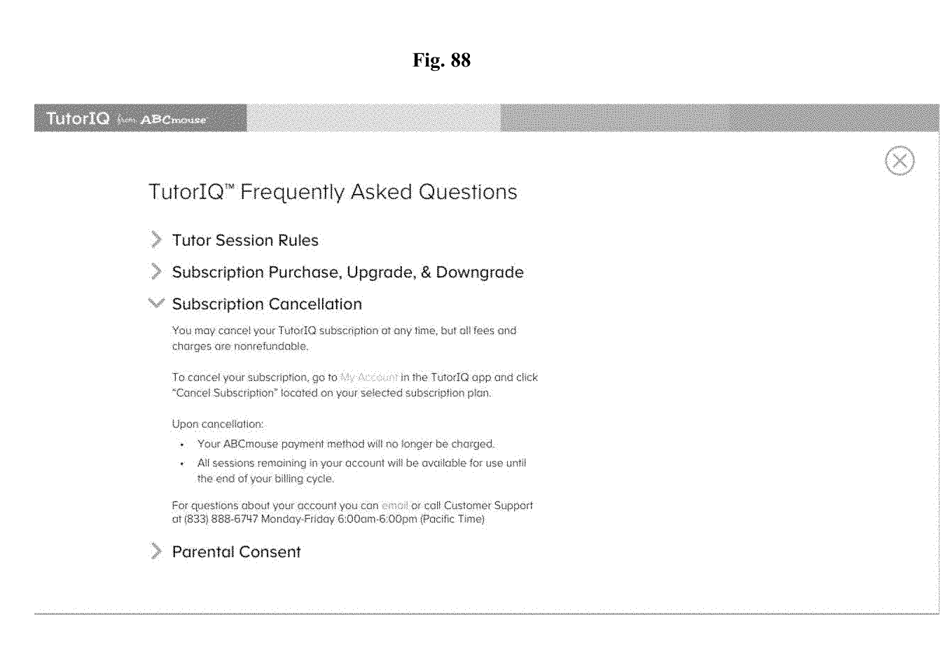

Referring to FIG. 88, in a particular embodiment, an interface for displaying the general rules around subscription cancellation is provided.

### Tutor Mode

In some embodiments, the platforms, systems, media, and methods described herein include a tutor mode, or use of the same. In some embodiments, the tutor mode is determined by log-in credentials. In further embodiments, the log-in credentials comprises an email address and password. In some embodiments, these features and tools include a billing and payment module allowing a tutor to view booked tutoring sessions and payments for completed tutoring sessions. In further embodiments, these features and tools include a tutor feedback module allowing a tutor to, for a completed tutoring session, assign homework, describe learner progress, provide tutor-to-tutor feedback, and rate curriculum. In even further embodiments, these features and tools include an interface wherein the tutor mode provides a tutor the ability to provide onscreen awards to a learner, provide feedback comments to a learner, access curriculum, and view a tutoring script for the curriculum. In further embodiments, these features and tools include a tool for a tutor to disable learner whiteboarding. In some embodiments, these features and tools are unique to a tutor during a co-browsing activity.

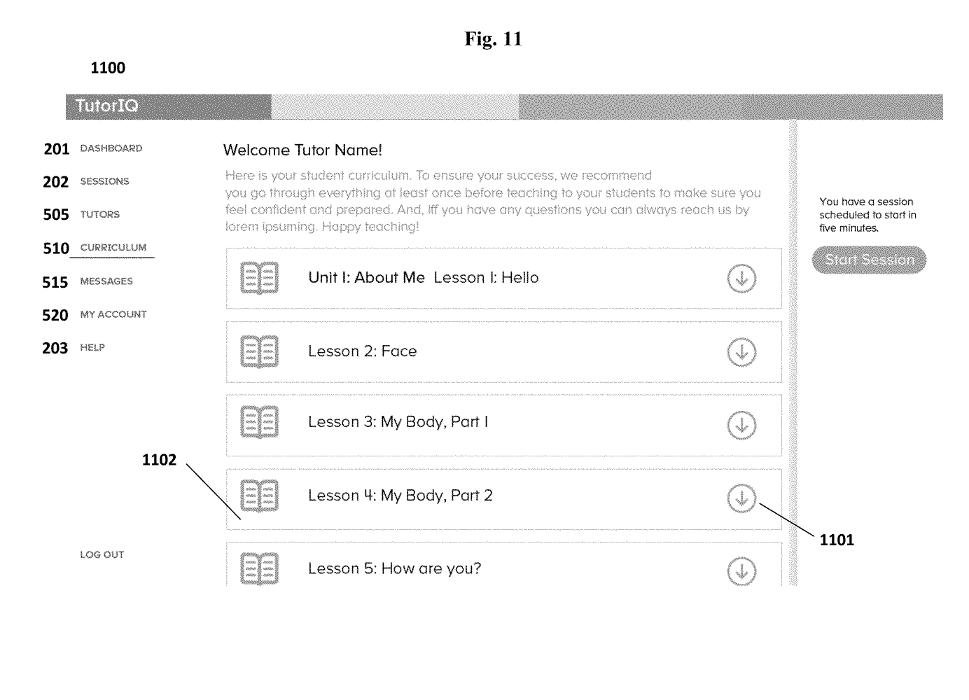

Referring to FIG. 11, in a particular embodiment, an interface 1100 for a tutor to view a curriculum 1102 and its lesson plan 1101 for a remote tutoring session is provided. In this embodiment, the interface displays a menu to access the dashboard 201, view tutoring sessions 202, view profiles of the tutors 505, access the curriculum 510, view messages from other learners or tutors 515, view the subscription details of the tutor 520, or access the help page 203. In other embodiments, the curriculum is organized into a hierarchy comprising one or more units, a unit comprising one or more lessons, a lesson comprising one or more slides, a slide comprising one or more videos.

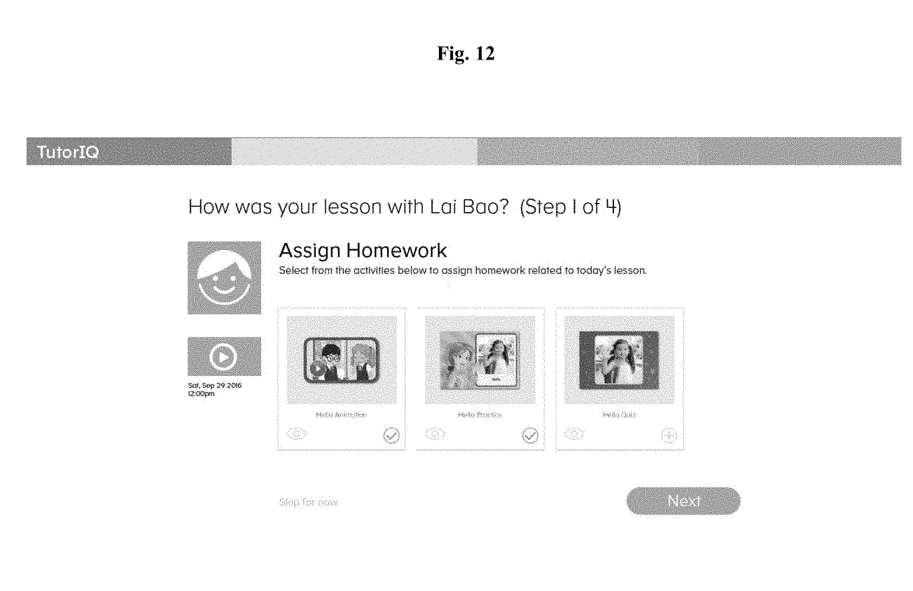

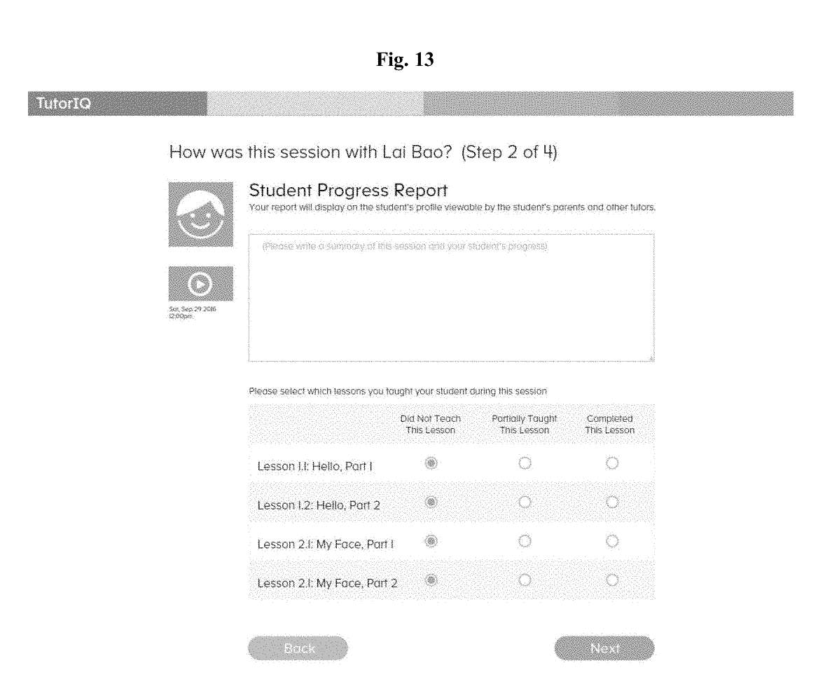

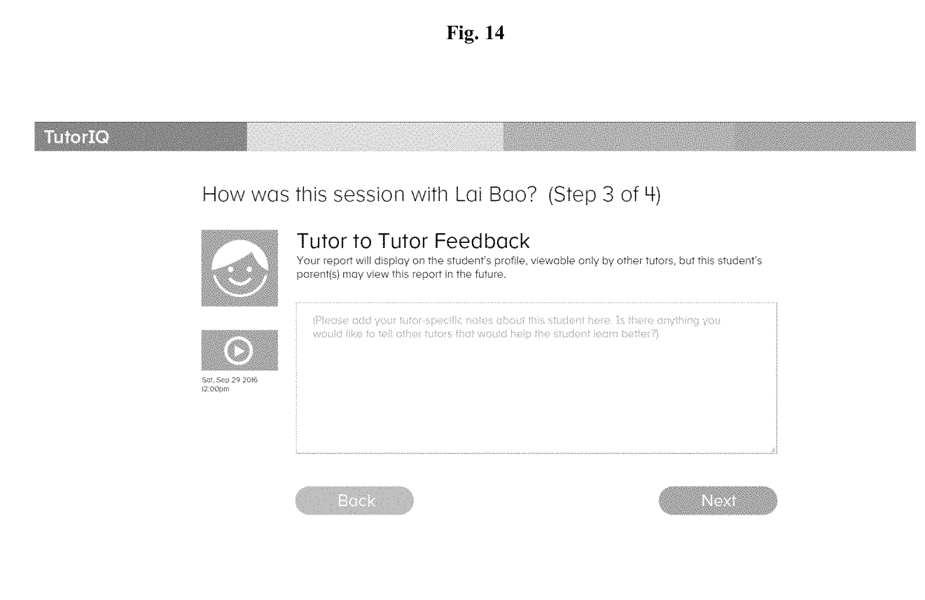

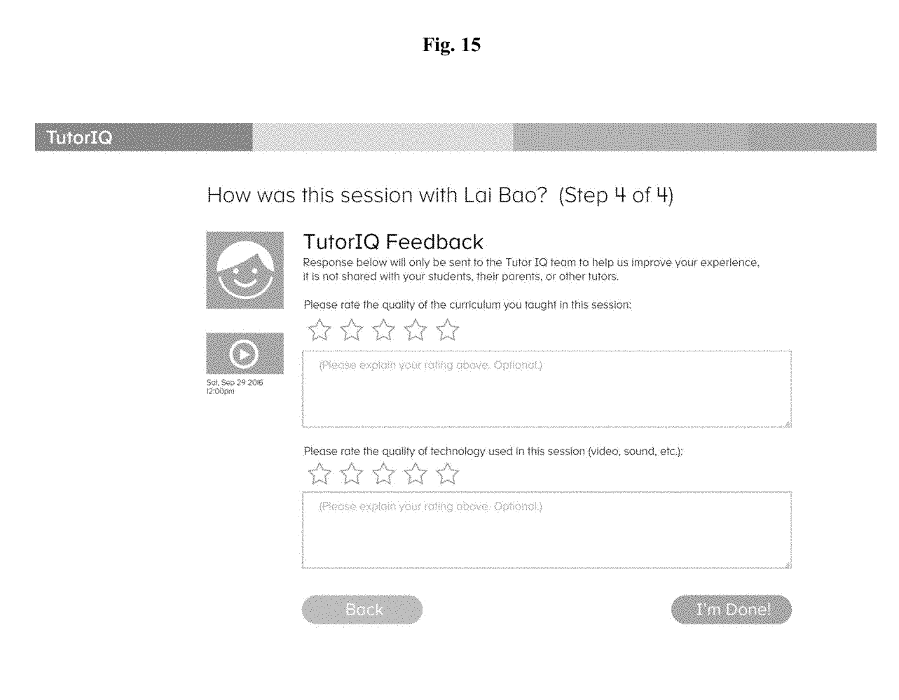

Referring to FIGS. 12-15, in particular embodiments, tutor feedback modules are provided. Referring to FIG. 12, in a particular embodiment, a tutor feedback module allowing a tutor to, for a completed tutoring session, assign homework to the learner is provided. Referring to FIG. 13, in a particular embodiment, a tutor feedback module allowing a tutor to, for a completed tutoring session, describe learner progress is provided. The module may optionally allow the tutor to record whether the lesson was completed, partially taught, or not taught at all. Referring to FIG. 14, in a particular embodiment, a tutor feedback module allowing a tutor to, for a completed tutoring session, provide tutor-to-tutor feedback is provided. In some embodiments, the tutor-to-tutor feedback is viewable to the learner's parents or guardians. Referring to FIG. 15, in a particular embodiment, a tutor feedback module allowing a tutor to, for a completed tutoring session, rate the curriculum is provided.

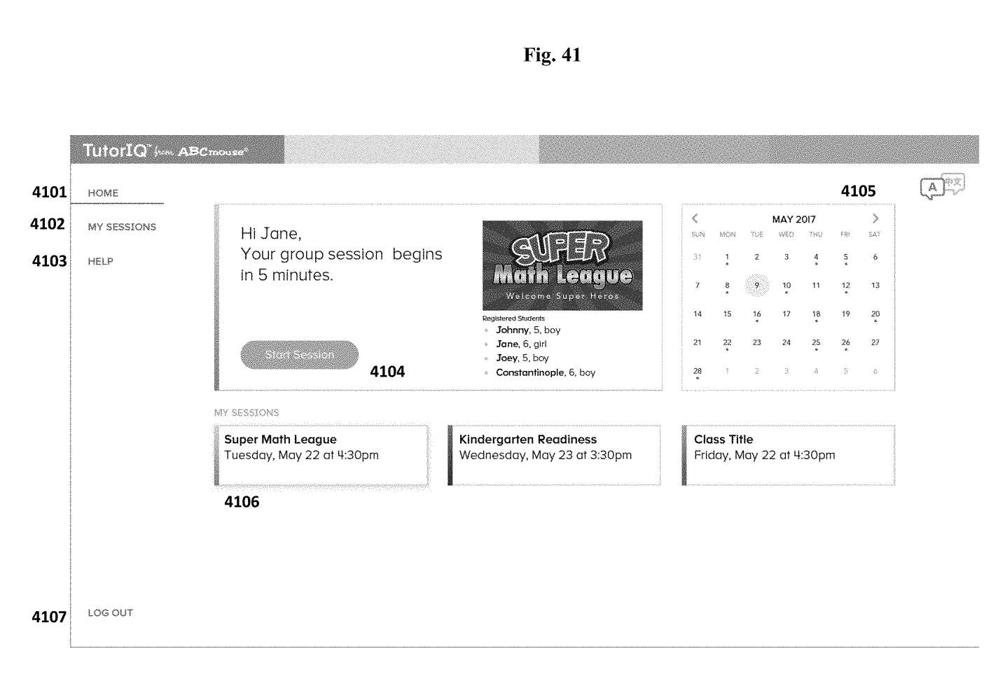

Referring to FIG. 41, in a particular embodiment, an interface for a tutor to view an upcoming remote tutoring session is provided. In this embodiment, the interface displays a menu to access the home page 4101, view tutoring sessions 4102, the help page 4103, and log out of the remote tutoring program 4107. The tutor is able to start an upcoming session with a single click 4101, view upcoming tutoring sessions, 4106, and a calendar 4105 with notations of dates with upcoming remote tutoring sessions.

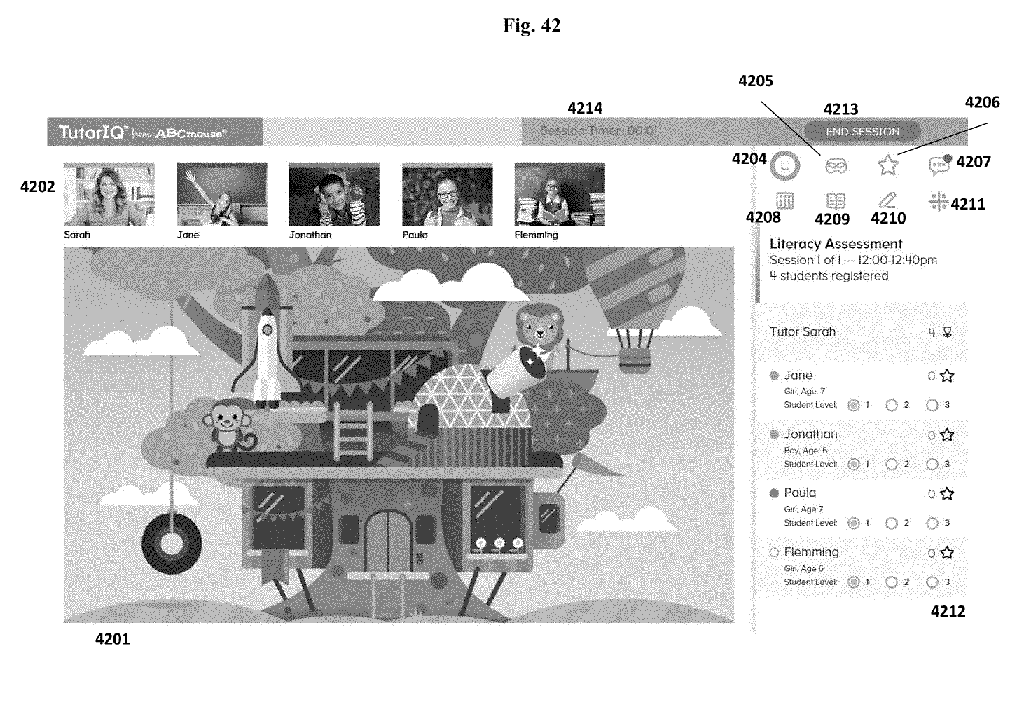

Referring to FIGS. 42-49, in particular embodiments, a graphic user interface for a tutor to conduct a remote tutoring session is provided. Referring to FIG. 42, in a particular embodiment, the interface allows the tutor to view the remaining session length 4214 or end the session 4213. The tutor is further able to view a video screenshot of himself or herself along with video screenshots of four learners 4202 near the top of the interface. In some embodiments, the tutor is able to view still images of one or more learners. In other embodiments, the tutor is able to view video screenshots of one or more learners. In even further embodiments, the tutor is able to scroll through a plurality of video screenshots or still images of one or more learners arranged in a horizontal line. This particular embodiment provides the main content screen 4201 where one or more learning activities may be depicted. FIG. 42 further provides an attendance module, 4204 which provides a tutor with access to view the learners in attendance of the current remote tutoring session 4212. In this particular embodiment, the two learners in attendance are shown with a green circles 4213 and 4214 next to their names. The one learner who was previously in attendance but left the remote tutoring session is indicated with a greyed circle 4215. The one learner who was never in attendance is indicated with a white circle 4216. In further embodiments, a variety of colors, shapes, and sizes may be used to indicate attendance, early departure, and non-attendance of one or more learners.

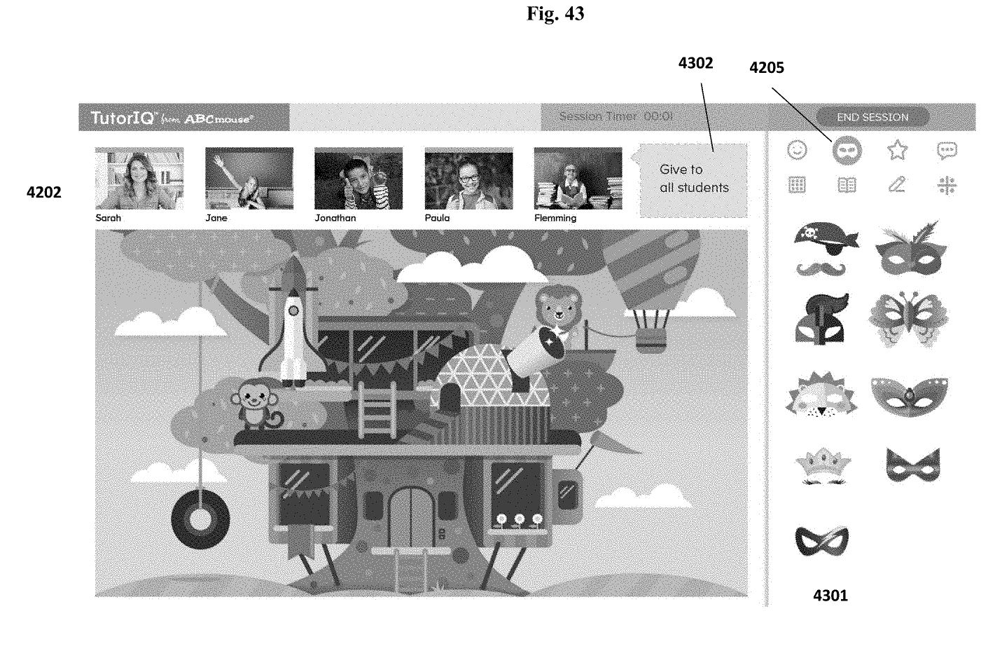

Referring to FIG. 43, in a particular embodiment, the interface provides a mask awarding module 4205, which allows a tutor to award one or more learners with masks 4301 as prizes. In some embodiments, the tutor may select and drag a mask to an area that would provide all learners with a mask. In other embodiments, the tutor may select and drag a mask to individual learners. In further embodiments, the masks integrate with the still images or video images of the one or more learners and tutor in 4202 to look like the learners and tutors are wearing the masks. In even further embodiments, the themes of the animated masks are contextual. In further embodiments, the animated masks correspond with the lesson of the remote tutoring session. By way of example, in some embodiments where the lesson plan is taking place under water, the animated masks may be associated with a pirate theme. In other embodiments where the lesson plan is taking place in a zoo, the animated masks may be associated with an animal, like a lion or a bird.

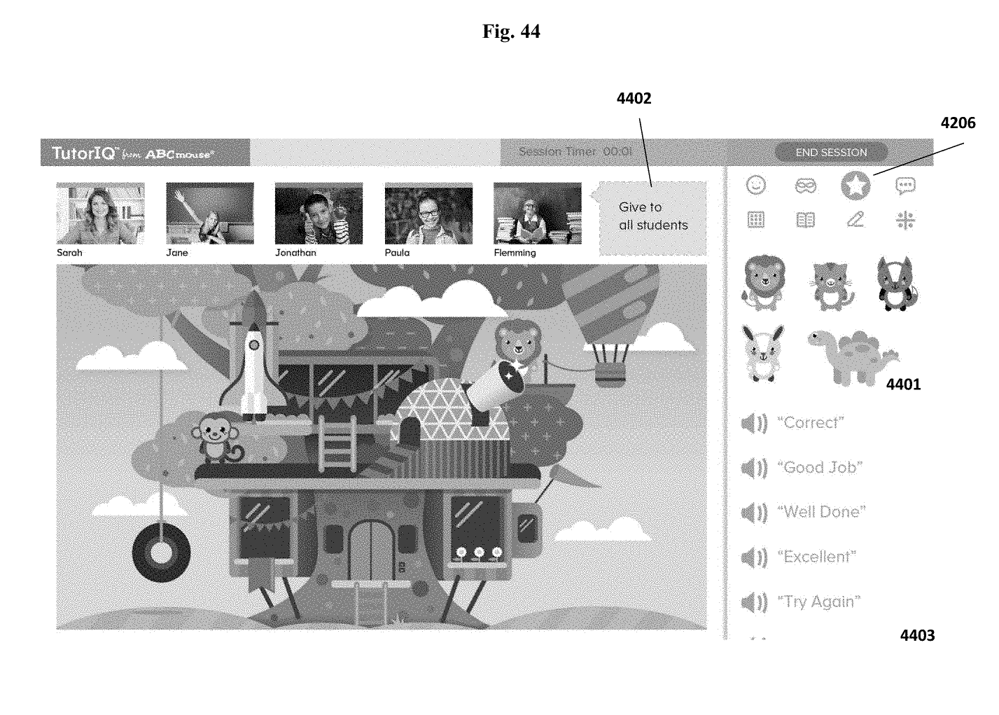

Referring to FIG. 44, in a particular embodiment, the interface provides a sticker awarding module 4206, which allows a tutor to award one or more learners with animated stickers 4401 as prizes. In some embodiments, the tutor may select and drag a sticker to an area that would award all learners with a sticker. In some embodiments, the sticker awarding module further allows the tutor to provide verbal confirmation or instructions 4403, e.g., “Correct,” “Good Job,” “Well Done,” “Excellent,” or “Try Again.”

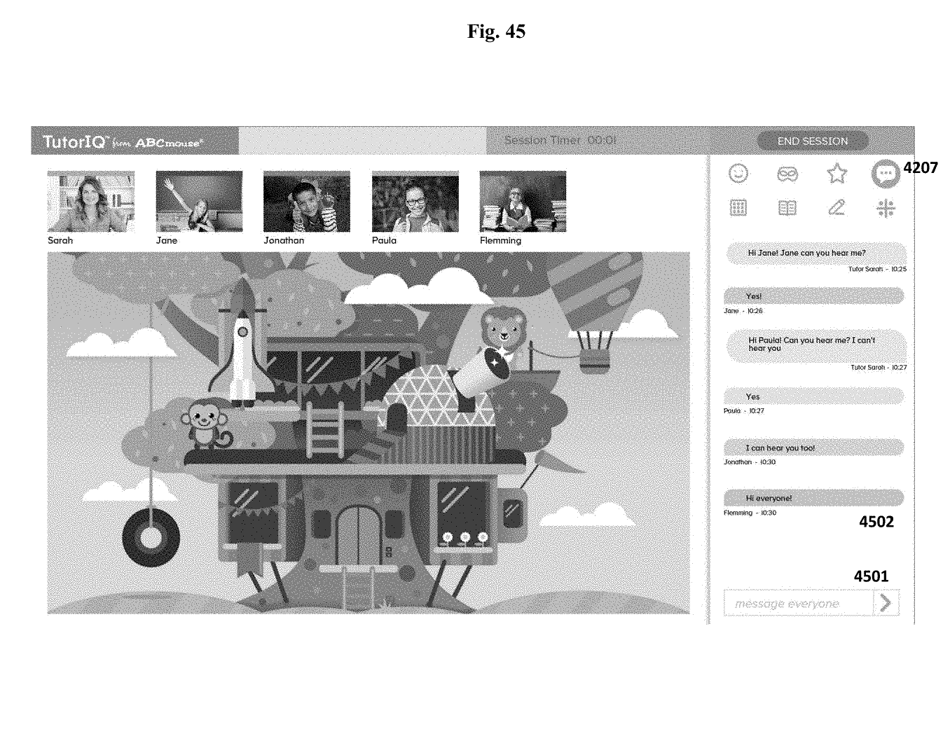

Referring to FIG. 45, in a particular embodiment, the interface provides a chat module 4207, which allows a tutor to type in text in a chat box 4501 and communicate back and forth with one or more learners via chat 4502. In some embodiments, the chats are color coded to allow easy tracking of which learner or tutor provided the chat.

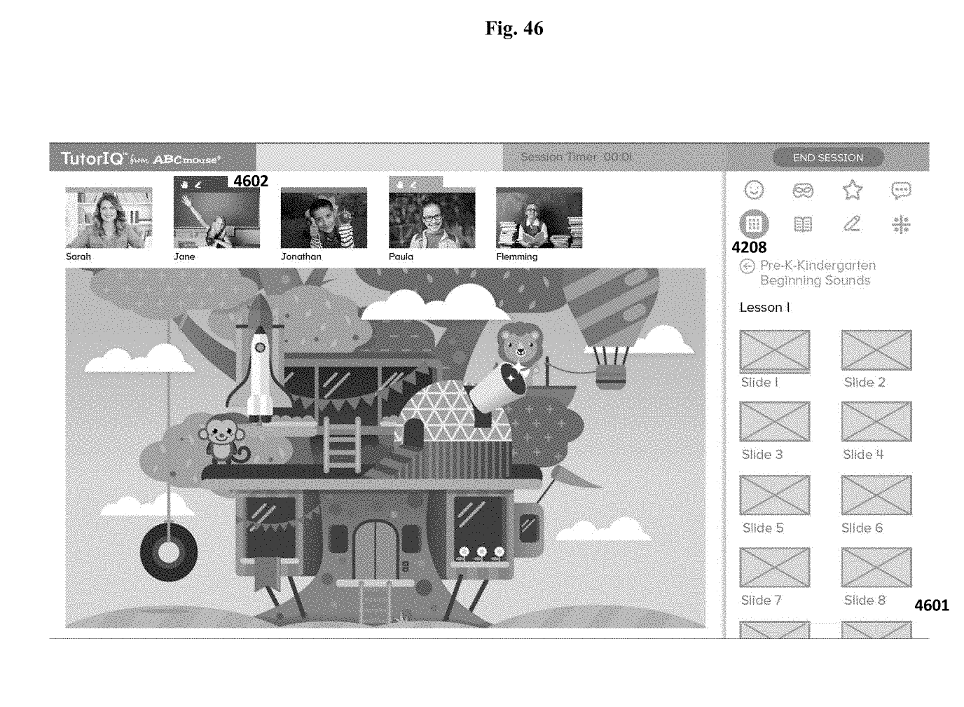

Referring to FIG. 46, in a particular embodiment, the interface provides a lesson slide deck module 4208, which allows a tutor to see an overview of all of the different slides 4601 of the instant remote tutoring session. In some embodiments, the tutor can select the image of video of one or more leaners provides a drop down menu 4602 that provides additional features for the learner to notify. In further embodiments, these features may include the ability to notify the tutor that the learner has a question. In other embodiments, these features may also include the ability to utilize whiteboarding features onto the main screen.

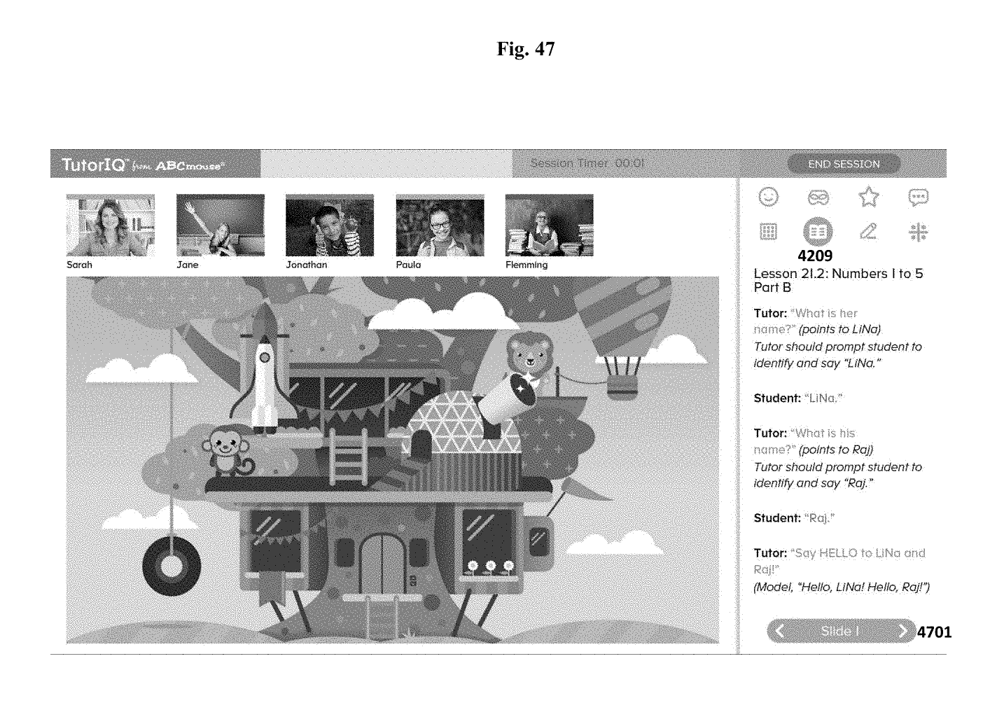

Referring to FIG. 47, in a particular embodiment, the interface provides a lesson plan script module 4209, which allows a tutor to view the lesson script 4701 for a particular remote tutoring session.

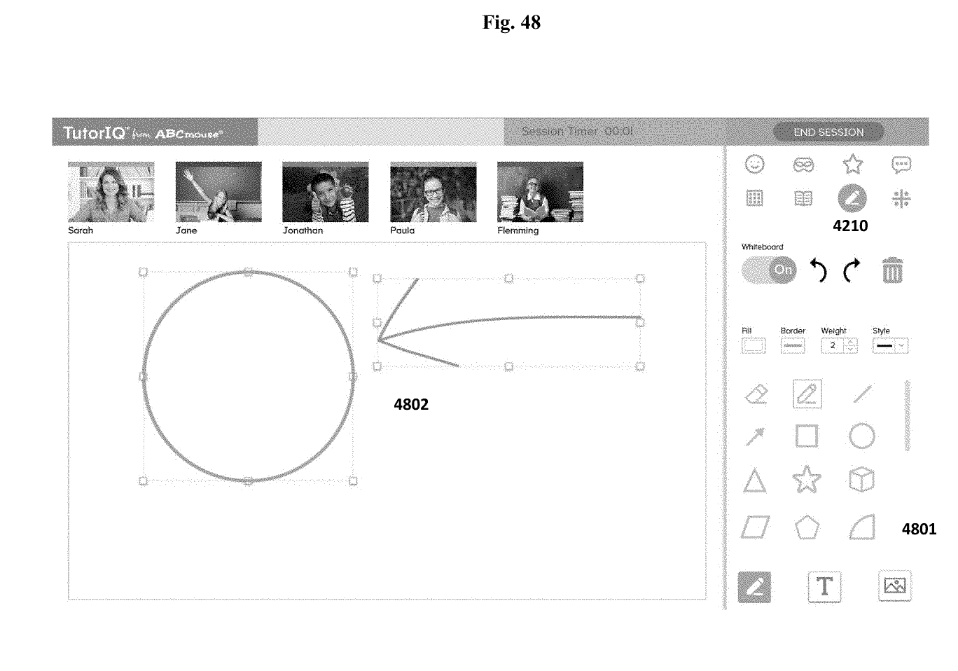

Referring to FIG. 48, in a particular embodiment, the interface provides a white boarding module 4210, which allows a tutor to draw different shapes and figures 4801 onto the main screen 4802. In some embodiments, the white boarding module 4210 allows the tutor select the image or video of one or more learners, where selection gives or takes away permission for a learner to use the white boarding tools. In even further embodiments, the selection of the image of video of one or more leaners provides a drop down menu that provides additional options such as muting or unmuting the learner, starting or stopping the video of the learner, etc.

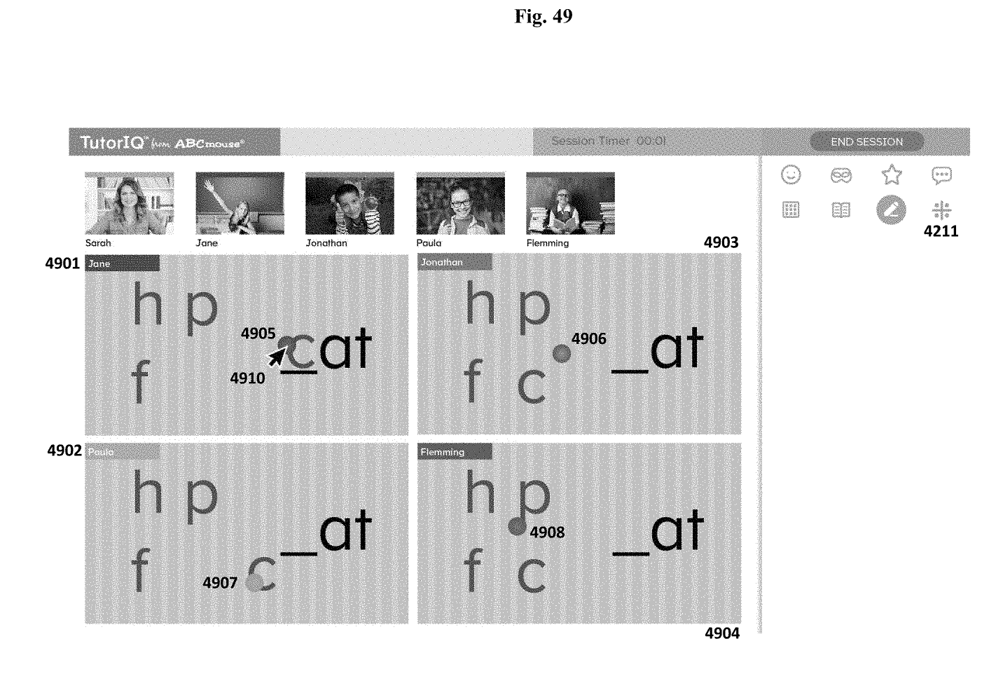

Referring to FIG. 49, in a particular embodiment, the interface provides a quiz mode module 4211, which allows the tutor to simultaneously view the four screens learners 4901, 4902, 4903, and 4904 of all four learners while the four learners participate in the shared experience of the same learning activity. At the same time, each learner is able to view only his or her own screen and is unable to see the screens of the other learners participating in the remote tutoring session. Further, each learner is able to view and interact with the remote tutoring session independently on their computer or device without knowledge of the interactions of the other learners. In the instant embodiment, the tutor is able to see the four different interactions 4905, 4906, 4907, and 4908 of the four learners as the learners are participating in a learning activity. The different interactions of the learners are color coded to make it easy for the tutor to track which interactions are coming from which learner. In other embodiments, the tutor is able to participate or indicate 4910 in each of the screens of the different learners. By using this quiz mode module, a plurality of learners are able to be efficiently quizzed in a remote tutoring session without fear of embarrassment while allowing each learner to interact with the learning activity independently. In further embodiments, the quiz mode allows the tutor to simultaneously view and interact with two, three, four, five, six, seven, eight, nine, ten, eleven, twelve, thirteen, fourteen, fifteen, sixteen, seventeen, eighteen, nineteen, twenty or more learners. In even further embodiments, where more than four learners are participating in a quiz mode, the quiz mode allows the tutor to view the screens of four learners at a time in one set and also allows the tutor to scroll through multiple sets, each set showing the screens of four different learners, quickly.

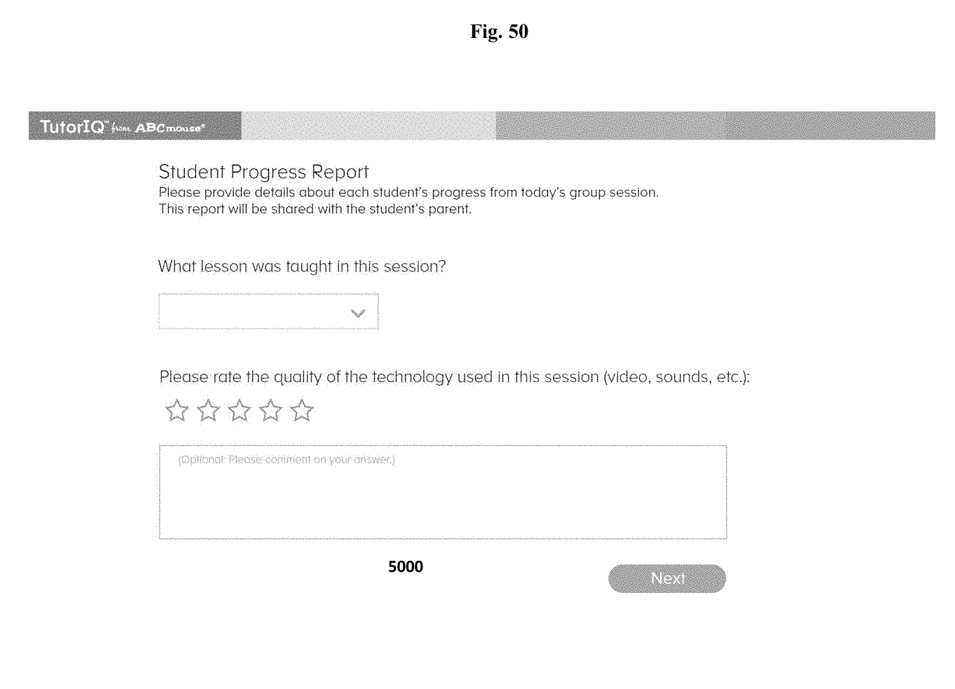

Referring to FIG. 50, in a particular embodiment, the interface provides the tutor with the ability to complete a student progress report 5000 of one or more learners, including explaining what lesson was taught, describing the quality of the technology used, describing the learner progress made during the remote tutoring session.

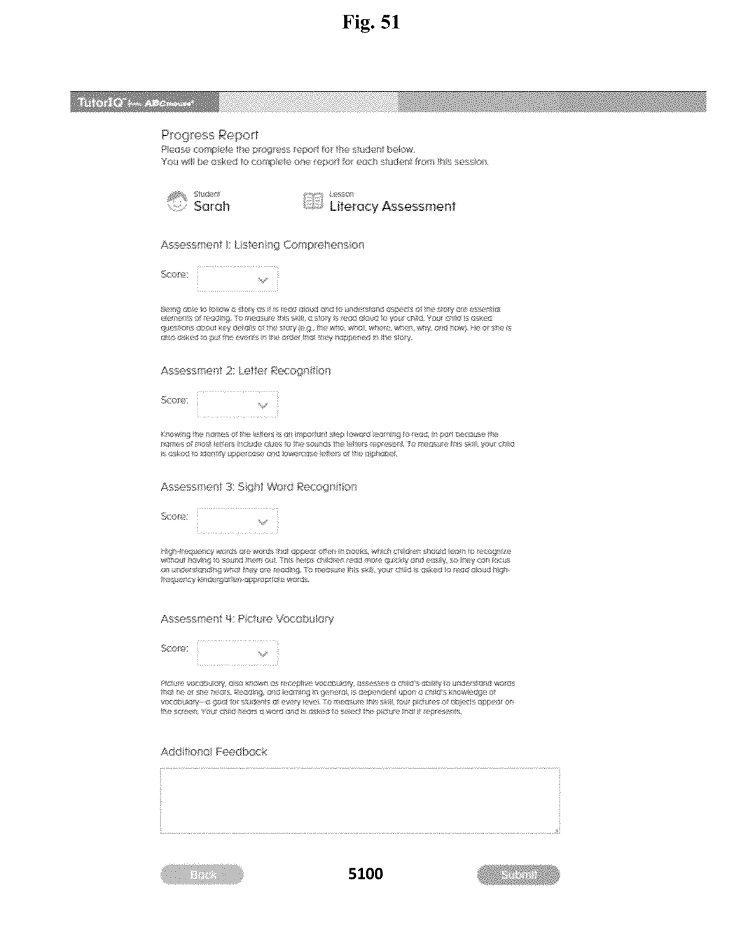

Referring to FIG. 51, in a particular embodiment, the interface provides the tutor with the ability to complete a student progress report 5100 of one or more leaners, including scores of different lesson activities and specific feedback.

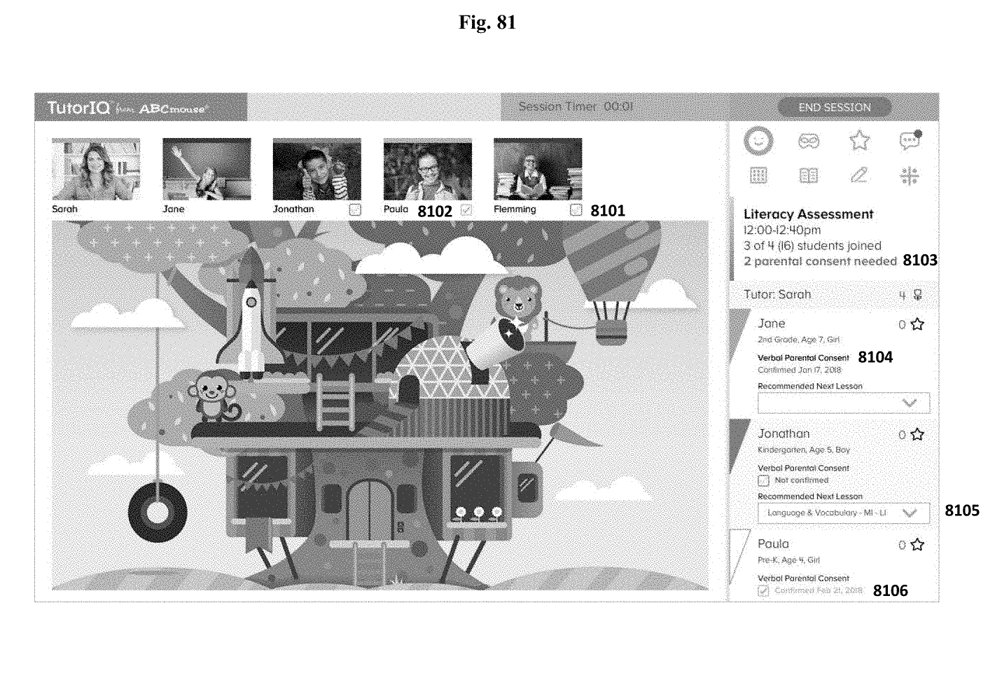

Referring to FIG. 81, in a particular embodiment, the interface provides the tutor to see which parents of learners have or have not provided consent to engage in a remote tutoring session. In some embodiments, the interface provides an indicator underneath a video or still image of a learner, indicating whether parental consent is needed 8101 or whether parental consent is not needed 8102. In further embodiments, the interface may provide a summary of the total amount of parental consent is needed 8103 from the learners in a remote tutoring session. In some embodiments, the parental consent may be verbal, while in other embodiments, the parent consent may be in writing. In even further embodiments, the interface displays the type of parent consent received 8104 and the date 8106. In additional embodiments, the interface is configured to allow a tutor to change the status of a learner with unconfirmed parental consent to confirmed after receiving the parent's verbal consent in a tutoring session. In even further embodiments, the interface is configured to allow a tutor to select the next lesson the student will be allowed to schedule through a drop-down menu 8105. Optionally, in this or other embodiments, this interface is available only in the tutor mode.

In some embodiments, the tutor mode provides additional online tools unavailable to a learner while a remote tutoring session is conducted. These tools may include, in any combination: the ability for a tutor to provide onscreen awards to a learner, provide feedback comments to a learner, access curriculum, or view a tutoring script for the curriculum. In further embodiments, the onscreen awards may comprise an animated graphic or an interactive game. In further embodiments, these tools may additionally include, in further combination, the configuration to begin or end a quiz mode or any other co-browsing activity, to view the interactions of one or more learners participating in quiz mode, to check the status of whether one or more parents have provided consent for a learner to participate in a remote tutoring session, to allow or prohibit one or more learners from utilizing whiteboarding tools or interact in any co-browsing activities. In some embodiments, the one or more combination of these tools and functionalities available only in the tutoring mode and not the learner mode is important to creating a successful e-learning environment. In some embodiments, it is important for learners to have access to some minimum tools to meaningfully interact in a remote tutoring session—an important quality unique to a virtual environment that may lack the physical presence of nearby tutors and students. However, in some embodiments, too many tools available to a learner may also have drawbacks as well, including the possibility of being a distraction for the learner or other learners. Additionally, in further embodiments, having both tutors and learners have equal access to the same features and functionalities may adversely affect the performance and capability of the computer having to accommodate the numerous interactions from both tutors and learners—especially if the number of learners increase. Hence, in some embodiments, having a balanced approach with tutor mode with a greater access to specific tools and features and a learner mode with a more limited access to specific tools and features may provide a technical advantage and improvement in computer functionality while maintaining enough opportunities for the one or more learner to interact in order to create a meaningful remote tutoring session.

### Co-Browsing Module

In online learning, or e-learning, a learner participates in learning activities via a computer or mobile device that accesses learning content via a computer network, such as the internet. Because using a computer or mobile device lacks the real-time physical interaction that concurrently comes with attending a physical classroom, online learning applications should be able to accommodate as much real-time interaction as possible. The need for real-time interaction is especially important if the learner is a young child who may have challenges focusing on a lesson without someone physically present.

As such, in some embodiments, the platforms, systems, media, and methods described herein includes a co-browsing module presenting an interface for conducting a tutoring session between one or more tutors and one or more learners. In some embodiments, the session has a predetermined duration. In other embodiments, the interface comprises a live audio and video presence. In further embodiments, the co-browsing module allows live presentation of media simultaneously to the one or more tutors and the one or more learners. In even further embodiments, the co-browsing module shows a pointer position with whiteboarding.

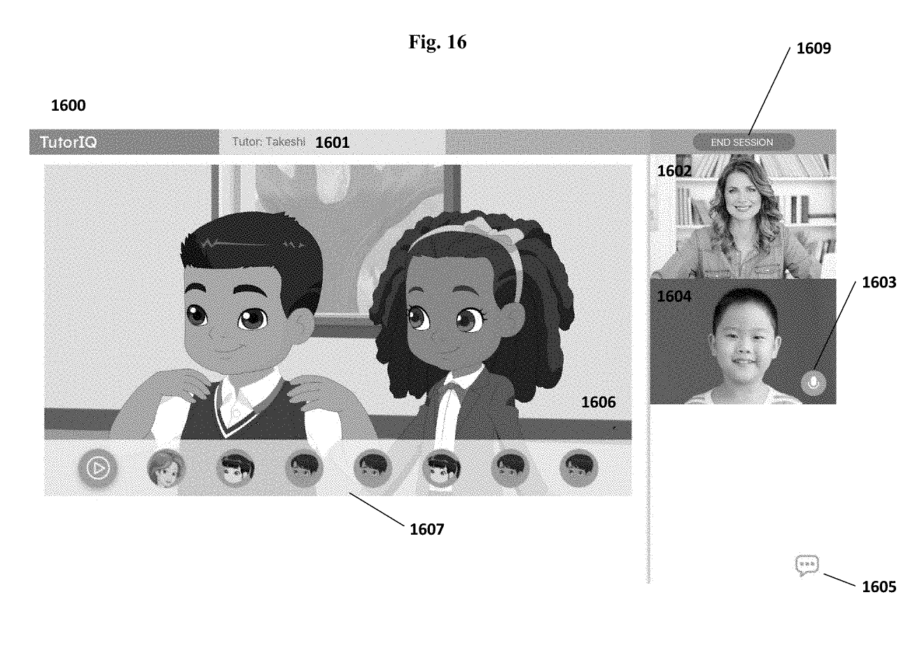

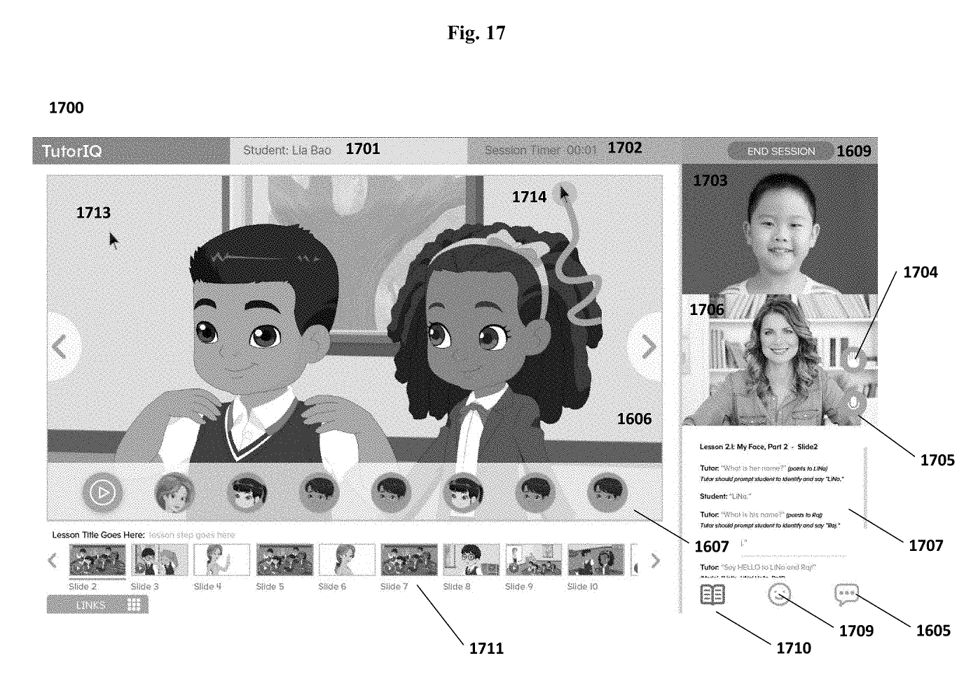

Referring to FIGS. 16 and 17, in particular embodiments, interfaces for conducting a tutoring session between one or more tutors and one or more learners through a shared co-browsing module are provided. Referring to FIG. 16, in a particular embodiment, a co-browsing module 1600 as seen from a learner's perspective is provided. The learner mode co-browsing module depicts the name of the tutor 1601 leading the remote tutoring session. In this embodiment, the learner mode co-browsing module further depicts a live video image of the tutor 1602 and the learner 1604. These live video images may optionally accommodate more than one tutor or learner when they are present during a remote tutoring session. Further in this embodiment, the co-browsing module depicts different buttons for the learner to end the session 1609, mute the audio 1603, or initiate a chat 1605 with the one or more tutors or learners. In some embodiments, the interface comprises a text chat with automatic translation. Finally, the learner mode co-browsing module depicts a graphic interface of the lesson 1606 and other icons associated with the instant lesson 1607. Referring to FIG. 17, in a particular embodiment, a co-browsing module 1700 shared with the learner in FIG. 16 as seen from a tutor's perspective is provided. Similar to the embodiment portrayed in FIG. 16, the tutor mode co-browsing module depicts a graphic interface of the lesson 1606, icons associated with the lesson 1607, live video image of the tutor 1706 and learner 1703, the learner's name 1701 participating in the remote tutoring session, and different buttons to end the session 1709, mute the audio 1703, or initiate a chat 1605 with the one or more learners and tutors. Further, in this embodiment, the tutor mode co-browsing module further allows the tutor to view a script of the curriculum 1707 by pressing the curriculum icon 1710, use a pointer capable of whiteboarding 1714, view the learner's pointer 1713, access other lessons 1711, issue a warning 1704 to the learner, or award onscreen awards to a learner by pressing the onscreen awards icon 1709. In some embodiments, the onscreen awards may comprise an animated graphic or an interactive game.

### Co-Browsing Activities

In some embodiments, the platforms, systems, media, and methods described herein include a plurality of co-browsing activities, or use of the same. In some embodiments, the plurality of co-browsing activities is a data store or database of co-browsing activities. In some embodiments, the plurality of co-browsing activities comprises about 2, 5, 10, 20, 30, 40, 50, 60, 70, 80, 90, 100, or more activities, including increments therein. In further embodiments, the plurality of co-browsing activities comprises about 50, 100, 150, 200, 250, 300, 350, 400, 450, 500, 550, 600, 650, 700, 750, 800, 850, 900, 950, 1000, 2000, 3000, 4000, 5000, or more activities, including increments therein. A preferred embodiment for co-browsing activities involves utilizing them in a shared co-browsing module between one or more learners and one or more tutors. In some of these embodiments a learner performs a number of different tasks or participates in various online exercises under the supervision of one or tutor. In additional embodiments, the tutor can participate in these tasks and online exercises along with the learner. However, in other embodiments, the co-browsing activities may be utilized outside a co-browsing module or without one or more learners and one or more tutors present.

Many types of co-browsing activities are suitable. In some embodiments, one or more activities are selected from informal activities including, by way of non-limiting examples, demonstrations, how-to-articles, how-to-videos, and simulations. In some embodiments, one or more activities are selected from preschool activities including, by way of non-limiting examples, books, games, puzzles, art, songs, chants, and music. In some embodiments, one or more activities are selected from K-12 activities including, by way of non-limiting examples, books, games, puzzles, art, music, reading assignments, articles, videos, demonstrations, simulations, quizzes, examinations, worksheets, problem sets, brainstorms, and journals. In some embodiments, one or more activities are selected from higher education activities including, by way of non-limiting examples, books, reading assignments, lectures, articles, videos, demonstrations, simulations, mock examinations, quizzes, examinations, essays, laboratory experiments, problem sets, brainstorms, and journals. In some embodiments, one or more activities are selected from professional activities including, by way of non-limiting examples, books, articles, brainstorms, collaborations, group activities, multi-player games, videos, lectures, role-plays, simulations, demonstrations, quizzes, and exams.

In some embodiments, the co-browsing activities are directed to a topic. In other embodiments, the co-browsing activities are directed to a subject. In further embodiments, a co-browsing activity is directed to a particular level of learning for a subject. Many subjects are suitable and include, by way of non-limiting examples, math, reading, science, social studies, art, music, language arts, foreign language, and combinations thereof. Similarly, many levels of learning are suitable and include, by way of non-limiting examples, a pre-K, level, a Kindergarten level, a first grade level, a second grade level, a third grade level, a fourth grade level, a fifth grade level, a sixth grade level, a seventh grade level, an eighth grade level, a ninth grade level, a tenth grade level, an eleventh grade level, a twelfth grade level, and the like, including intermediate levels between. In other embodiments, a co-browsing activity is not linked to a school grade level, but instead is a proficiency level, a fluency level, a competency level, a mastery level, or a combination thereof.

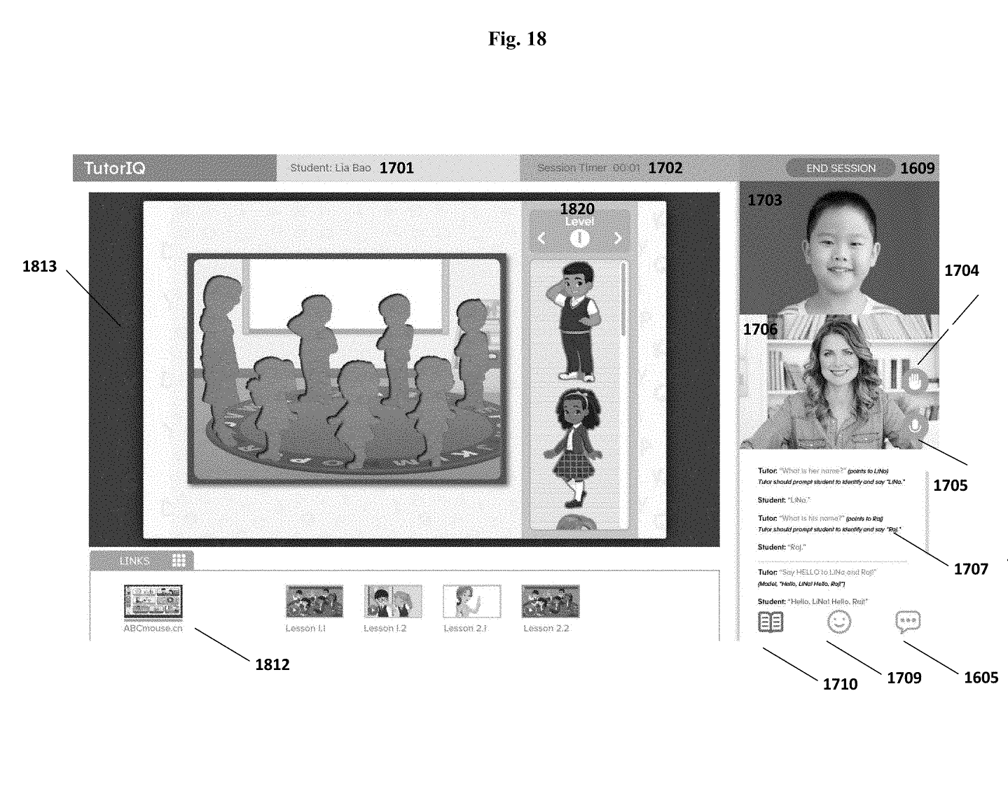

Referring to FIGS. 18-26, a variety of embodiments depicting co-browsing activities are provided.

Referring to FIG. 18, in a particular embodiment, a co-browsing activity relating to matching different FIG. 1813 is provided. In some embodiments, the learning activity optionally provides the option for the learner or tutor to instantly adjust the level of difficulty of the learning activity 1820.

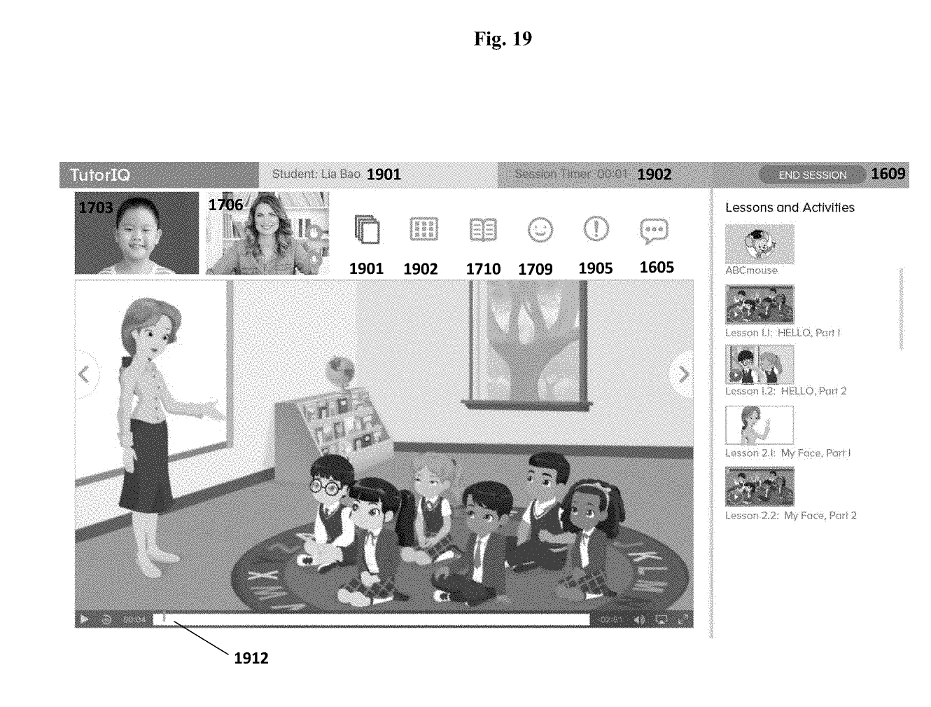

Referring to FIG. 19, in a particular embodiment, a short animation as part of a co-browsing activity shared through a co-browsing module is provided. This embodiment provides further options for the tutor to access different support tools for a co-browsing activity, including accessing the lesson plan 1902, view the lesson script 1901, start or stop the animation 1912, or provide a pre-scripted comment to the learner 1905.

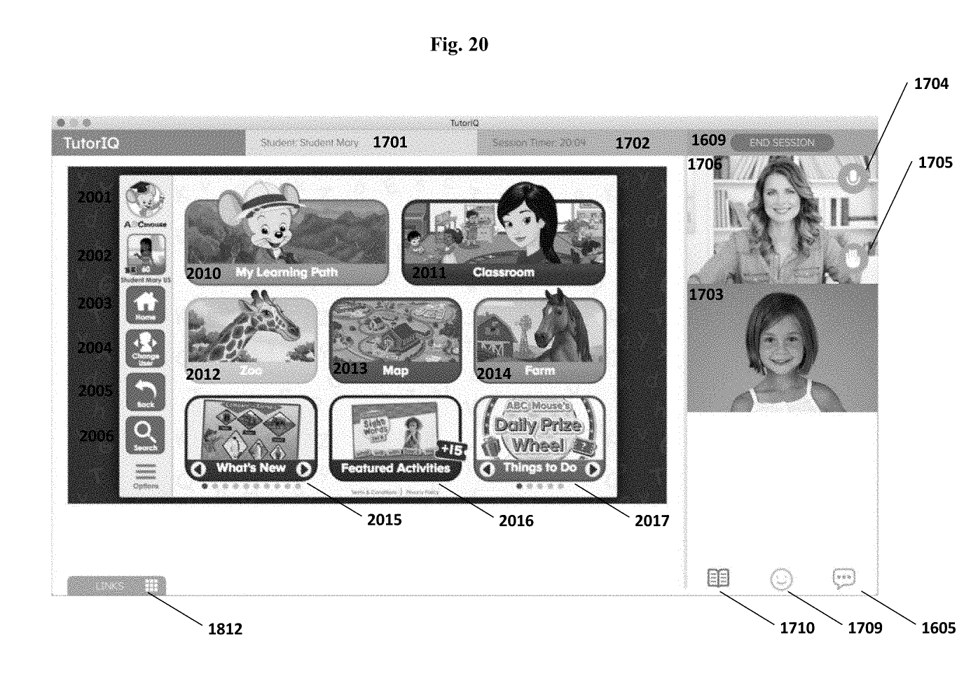

Referring to FIG. 20, in a particular embodiment, an interface for introducing children to a plurality of academic subjects in a variety of themes is provided. In some embodiments, the interface portrays activities directed to subjects for children aged three to seven. The themes may optionally include, but are not limited to, a set path 2010, a classroom 2011, a zoo 2012, a map 2013, or a farm 2015, or any other theme friendly to young children. Further, in this embodiment, the interface offers featured activities 2016 that can only be unlocked after winning tickets from completing co-browsing activities. In some embodiments, the tickets to unlock and play featured activities 2016 may be won by completely daily online tasks 2017.

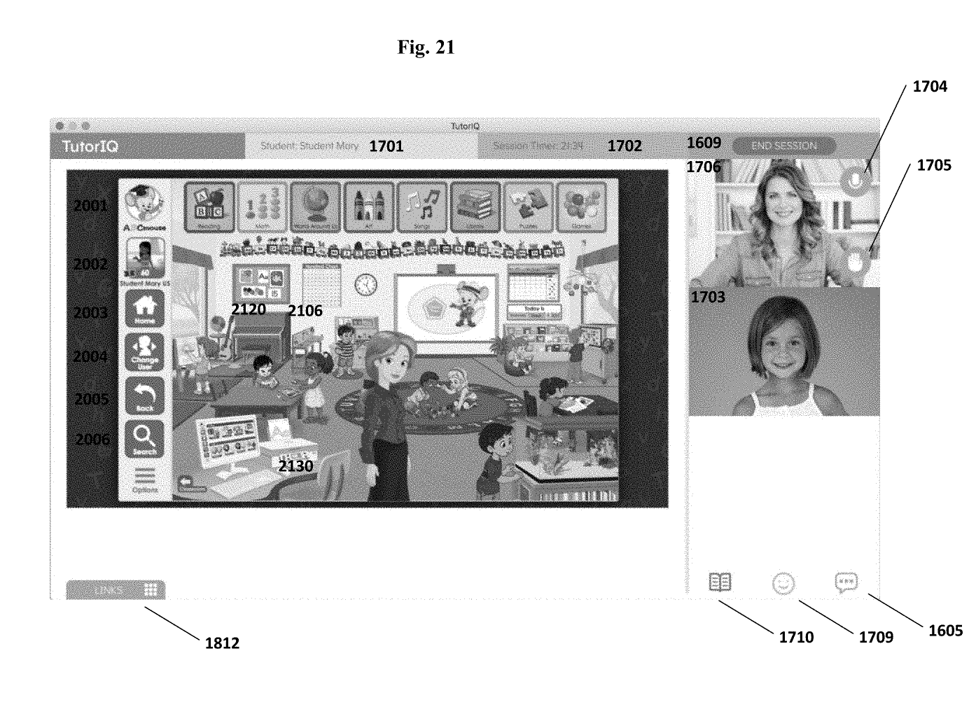

Referring to FIG. 21, in a particular embodiment, of an interface introducing children to a plurality of academic subjects through a classroom theme is provided. In some embodiments, the learner or tutor can click on various icons throughout the interface, which may be called hotspots and which light up when a mouse hovers over the icon, to start a co-browsing activity. By way of example, a learner can click on a number chart hotspot 2106 that, when selected, takes the learner to co-browsing activities concerning numbers. In further embodiments, these number co-browsing activities can include videos, games, puzzles, and art activities. In other embodiments, the learner can earn or win online tickets, vouchers, or prizes for completing a co-browsing activity.

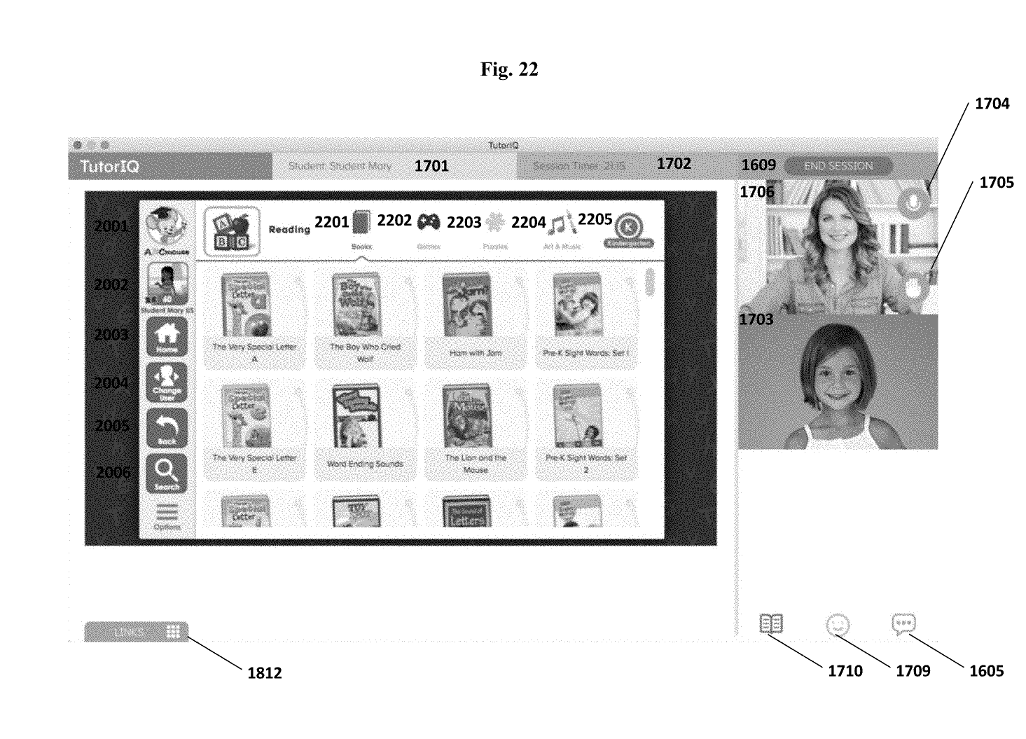

Referring to FIG. 22, in a particular embodiment, an interface for introducing children to a variety of reading activities is provided. In some embodiments, a learner can press buttons at the top of the interface to access different books 2201, games 2202, puzzles 2203, or arts and music 2204 associated with reading. In other embodiments, a learner can select books to read and press buttons to slow down, speed up, pause at the turn of each page, or turn the highlight option on and off of a selected book.

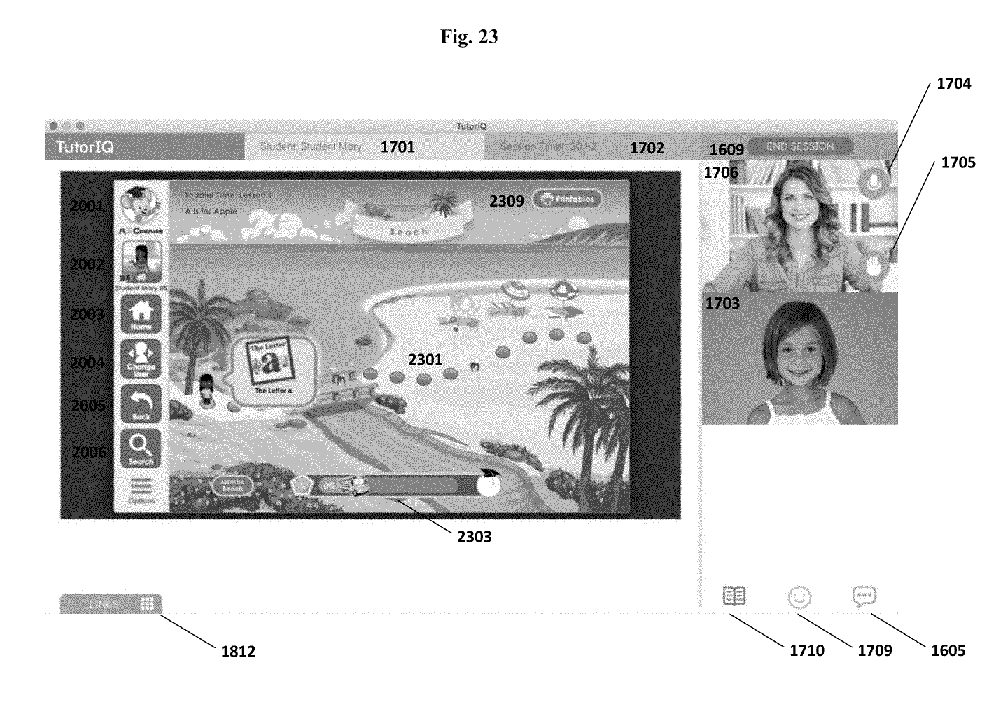

Referring to FIG. 23, in a particular embodiment, depicts an illustration of a path on a beach 2301, which is part of a carefully designed lesson wherein each lesson on the step-by-step path is designed to match the child's academic level. In further embodiments, there are hot spots specific to each environment on the bottom of each lesson. In even further embodiments, a learner can click on this area to learn more about the environment they are currently in. In some embodiments, there is a progress bar 2303 at the bottom of the interface showing the learner or tutor the learner's progress of the lesson. In further embodiments, the interface provides the co-browsing activity in a printable 2309 format. In some embodiments, the end of the step-by-step path depicts a prize box. In some embodiments, the activities between the prize boxes are named at the top of the screen. In some embodiments, the learner gets an online award when completing all of the co-browsing activities of a lesson. In further embodiments, the online award comprises an animated graphic or an interactive game. In even further embodiments, these prizes may be put in areas designated to store such prizes. By way of examples, these areas may be depicted with different kid-friendly themes, including “My Aquarium,” “My Hamster,” or “My Room.” In some embodiments, each lesson is designed to take from 10 to 20 minutes depending on the child's age. In further embodiments, the length of a lesson is determined by a goal set by the learner, the learner's parents, learner's guardian, or tutor each time the learner uses the remote tutoring platform.

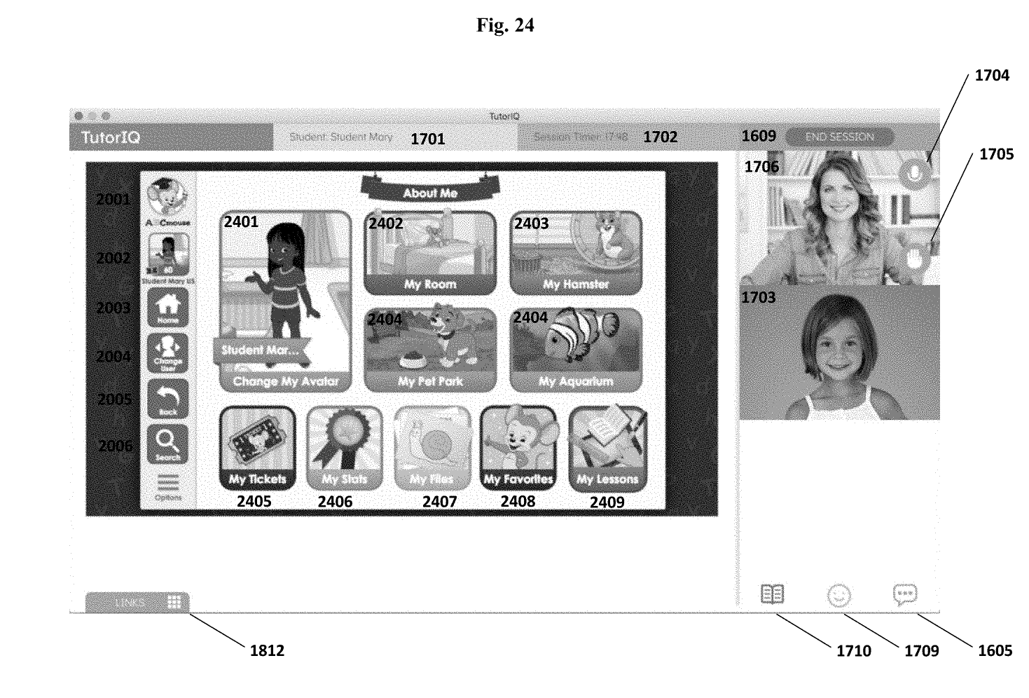

Referring to FIG. 24, in a particular embodiment, an interface for customizing the co-browsing activities and organizing earned tickets, coupons, prizes, tokens, or awards is provided. The interface provides a means of helping earlier learners develop numbers sense and gain experience with quantities and values, the concepts of more and less, as well as to become familiar with addition and subtraction. The interface further provides a means to help learners practice important critical thinking skills of comparing and deciding, as well as learning how to set and achieve long term goals. In this embodiment, the interface depicts an option for an individual to select “My Room” 2402. In some embodiments, the “My Room” is customizable. In further embodiments, a learner may add prizes won to “My Room” by completing lessons or purchase items using tickets that are earned by completing activities. In some embodiments, the prizes won may be in the form of virtual pets and animals. In some embodiments, a learner can organize all the items in an inventory within “My Room” or other similar areas in the remote learning platform. In further embodiments, there is a “Go Shopping” button where additional items can be purchased for “My Room.” In further embodiments, a learner can also drag and drop items from the inventory into the room so the learner can get creative with how the room will ultimately look. In further embodiments, the interface allows the user's avatar, which may appear in the co-browsing activities, to be customized by selecting “Change My Avatar” 2401. In further embodiments, a learner can customize his or her avatar by using tickets, coupons, prizes, tokens, or awards that were earned by completing co-browsing activities or separately purchased. In other embodiments, an individual can manage their tickets 2405, status 2406, files 2407, favorite lessons 2408, and lessons 2409. In further embodiments, the total amount of tickets earned is tracked.

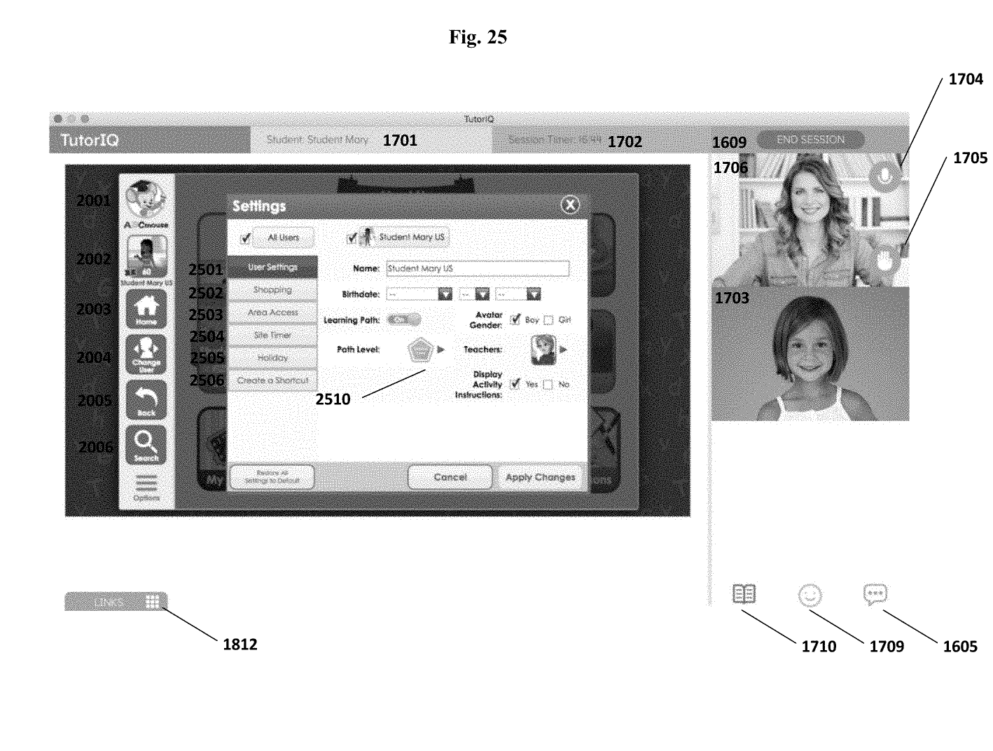

Referring to FIG. 25, in a particular embodiment, an interface for customizing the co-browsing activities is provided. In this embodiment, the interface depicts an interface to change the learner's Learning Path level 2510, ticket spending limits 2502, gender of the avatar, and time limits a learner may use the program 2504. In some embodiments, the time limit can be limited based on a specific time range per day or a specific amount of time. In some embodiments, the interface is depicted as a “Settings” page. In further embodiments, the “Settings” page is found by selecting a hamburger menu. In even further embodiments, accessing the Settings page or similar pages to manage the subscription account is password protected. In some embodiments, there is an option for a learner's parent or learner's guardian to select, which optionally provides tools and options unique to a parent or guardian to better understand what the learner is learning and manage the account. In some embodiments, a subscription comes with 1 Parent profile and room for up to 3 learner profiles. In further embodiments, a learner profile may comprise of a child profile. In some embodiments, a parent profile cannot be deleted. In further embodiments, a learner profile may be deleted and new ones can be added. In other embodiments, existing profiles can be edited through a Settings page. In some embodiments, a guardian (who is not the learner's legal guardian) may have access to edit the learner's settings.

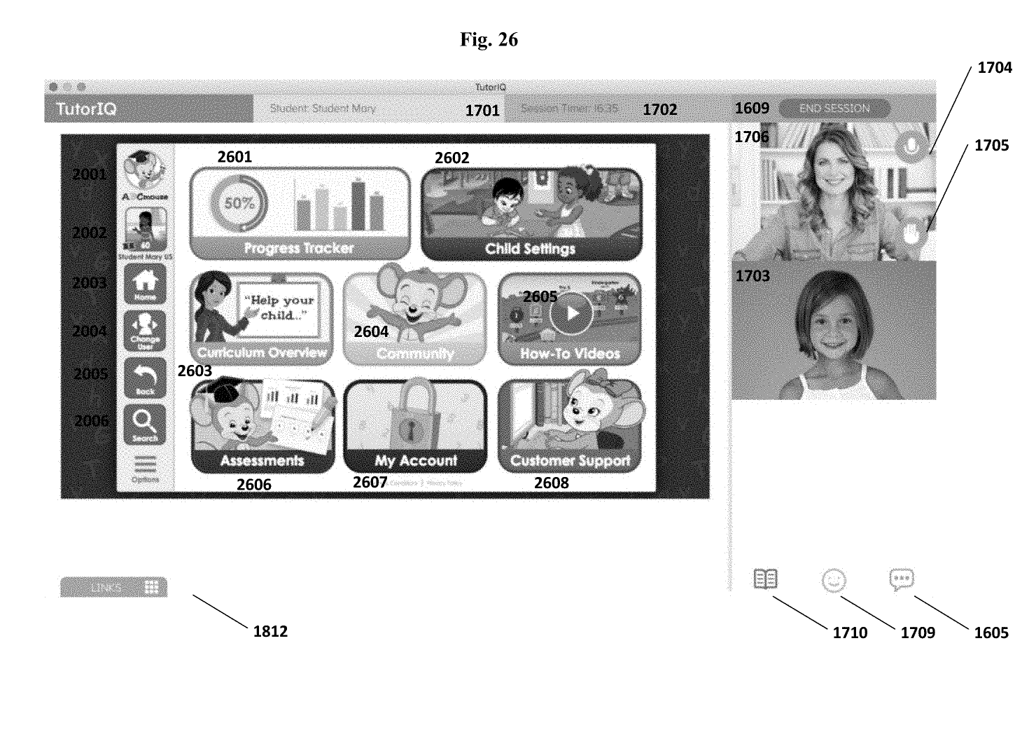

Referring to FIG. 26, in a particular embodiment, an interface for managing the learner's account is provided. In this embodiment, the interface depicts an interface to view the learner's progress 2601, provide an overview of the curriculum 2603, reach out to other users in the community 2604, provide how-to videos explaining how to use the application 2605, evaluate the learner's assessments 2606, access the user's account 2607, and reach out for customer support 2608. In further embodiments, the “Curriculum Overview” option 2603 gives background information about the curriculum available on the remote tutoring platform. In even further embodiments, this information may include information about how children learn to read, learn math, and other important academic skills. In some embodiments, the ability to access the “Curriculum Overview” 2603 is always available. In some embodiments, a user can change the subscription, payment information, email address, or password by accessing the “My Account” option 2607.

In some embodiments, customer support may comprise providing a live guided tour of the remote tutoring platform from one or more support staff members to a learner, a learner's parent, a learner's guardian, or some combination thereof. In some embodiments, the guided tour may last no more than 25 minutes. In other embodiments, the tour will end automatically after 30 minutes for all participants. In other embodiments, the learner's parent cannot enter the live guided tour until the support staff has started the session and the start time of the scheduled session. In further embodiments, the learner's parent will remain in a wait screen until the support staff has started the session. In even further embodiments, the learner's parents will automatically join the session at the start time of the session and if the support staff is in the session. In other embodiments, the support staff can enter the session up to 10 minutes before the session start time.

In some embodiments, the support staff may be provided a script of the live guided tour to help educate the learner, learner's parents, or learner's guardian about the remote tutoring platform, including how to familiarize them with the different learning areas on the platform and how to customize the experience to fit the specific needs of the learner or the learner's parents and/or guardian. In further embodiments, the support staff may inquire the learner's parents as to why they subscribed to access the remote tutoring platform. In even further embodiments, the support staff may be instructed to use the learner's name to help personalize the live guided tour experience. As part of the live guided tour, the support staff may optionally explain that the remote tutoring session covers all academic subjects for children ages 3 to 7. The support staff may also optionally explain how independent research has proven that children experience significant gains in reading and math skills even if they spend just 45 minutes a week on the remote tutoring platform. The support staff may further optionally explain that the amount of time a learner spends each day on the remote tutoring platform from about 30 minutes to about 60 minutes a day.

Optionally, the support staff may provide a different live guided tour experience depending on the age of the learner or the subject matter the learner is interested in learning. In one scenario, where the learner is in kindergarten or younger, the support staff may refer the learner's parents or learner's guardian who is participating in the live guided tour to go to an interface like the one portrayed in FIG. 21. In this scenario, the support staff may further instruct the learner's parents or guardian to click on the “Hundred” chart 2106, which is located on the left of the clock and above the virtual instructor's head. In some embodiments, the chart 2106 takes the user to learning activities about numbers. Optionally, the chart may take the user to co-browsing activities where one or more learners and one or more tutors can participate together. In further embodiments, there are videos, games, puzzles, and art activities, which can be seen if the user scrolls down and back up against using a scroll bar on the right. In another scenario, where the learner is a first or second grader, the support staff may refer the learner's parents or learner's guardian who is participating in the live guided tour to click on the Word Wall 2120, which is located on the left side of FIG. 21, next to a big window. In some embodiments, the support staff may instruct the user on the guided tour to click on any word they see, which may optionally take the user to a plurality of learning activities for every sight word that a child needs to learn within the academic range of pre-kindergarten to second grade. In further embodiments, the Word Wall 2120 may take the user to co-browsing activities where one or more learners and one or more tutors can participate together. In some embodiments, the Word Wall 2120 may be considered as hotspot, which lights up when selected. In another scenario where the learner is a second grader or younger, the support staff may refer the learner's parents or learner's guardian who is participating in the live guided tour to click on a hamster cage or a “Go Shopping” tab to purchase items for a fish tank like the one depicted in the bottom right hand corner in FIG. 21. In other embodiments, the support staff may explain to the learner's parents or learner's guardians how a learner can win items as prizes for completing learning or co-browsing activities. In further embodiments, the learner may also use the tickets to purchase items for other areas available in the remote tutoring platform. In some embodiments, the support staff may also explain to the learner's parents about the hotspots that are printable—i.e., an option that allows a learner to print out printable activities that may be done off the computer. In further embodiments, this printable hotspot is depicted in the form of a virtual printer 2130 like the one depicted in the bottom left hand corner in FIG. 21. In even further embodiments, the remote tutoring platform may offer hundreds of printable activities that match with what a learner is learning in school.

In some embodiments, the support staff may direct the learner's parents or learner's guardian to a page specific to a subject area or by activity type. By way of example, these subject areas include, but are not limited to math, reading, science, social studies, art, music, language arts, foreign language, and combinations thereof. Similarly, many levels of learning are suitable and include, by way of non-limiting examples, a pre-K, level, a Kindergarten level, a first grade level, a second grade level, a third grade level, a fourth grade level, a fifth grade level, a sixth grade level, a seventh grade level, an eighth grade level, a ninth grade level, a tenth grade level, an eleventh grade level, a twelfth grade level, and the like, including intermediate levels between. In some embodiments, the user can select the grade level and the associated available activities associated with the level. In other embodiments, a co-browsing activity or learning activity associated with the subject area is not linked to a school grade level, but instead is a proficiency level, a fluency level, a competency level, a mastery level, or a combination thereof. In some embodiments, the support staff may guide the learner's parents or learner's guardians to an interface that depicts a variety of activities and subject matters on a single webpage.

### Broadcast Modes

In some embodiments, the platforms, systems, media, and methods described herein include a plurality of broadcast mode for live, remote tutoring sessions. In further embodiments, a learner is able to select a broadcast mode for a live, remote tutoring session.

In some embodiments, a live, remote tutoring session is delivered via a one-to-one broadcast mode, wherein one tutor conducts a tutoring session with one learner. In other embodiments, a live, remote tutoring session is delivered via a many-to-one broadcast mode, wherein a plurality of tutors conduct a tutoring session with one learner. In such embodiments, the multiple tutors optionally use co-teaching methodologies to conduct the tutoring session.

In other embodiments, a live, remote tutoring session is delivered via a one-to-many broadcast mode, wherein one tutor conducts a tutoring session with a plurality of learners. In various embodiments, in a one-to-many broadcast mode, the tutor conducts a tutoring session with 2, 3, 4, 5, 6, 7, 8, 9, 10, 20, 30, 40, 50, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500 or more learners, including increments therein. In other embodiments, a live, remote tutoring session is delivered via a many-to-many broadcast mode, wherein a plurality of tutors conduct a tutoring session with the plurality of learners. In such embodiments, the multiple tutors optionally use co-teaching methodologies to conduct the tutoring session.

In yet other embodiments, a live, remote tutoring session is delivered via a large group broadcast mode, wherein one tutor conducts a tutoring session with a large number of learners. In further embodiments, in a large group broadcast mode, the tutor conducts a tutoring session with more than 2500 or more learners. In various embodiments, in a large group broadcast mode, the tutor conducts a tutoring session with 2500, 3000, 3500, 4000, 4500, 5000, 5500, 6000, 6500, 7000, 7500, 8000, 8500, 9000, 9500, 10,000, 20,000, 30,000, 40,000, 50,000 or more learners, including increments therein. In a large group broadcast mode, in some cases, an alternative software architecture, described herein, is employed to handle the large amounts of data involved with live streaming video, live streaming audio, and learning content with real-time interactivity (including onscreen polling and rewards) provided to, for example, more than 2500 learner simultaneously. In some embodiments, a live, remote tutoring session is delivered via a large group broadcast mode, wherein a plurality of tutors conducts a tutoring session with the large group of learners. In such embodiments, the multiple tutors optionally use co-teaching methodologies to conduct the tutoring session.

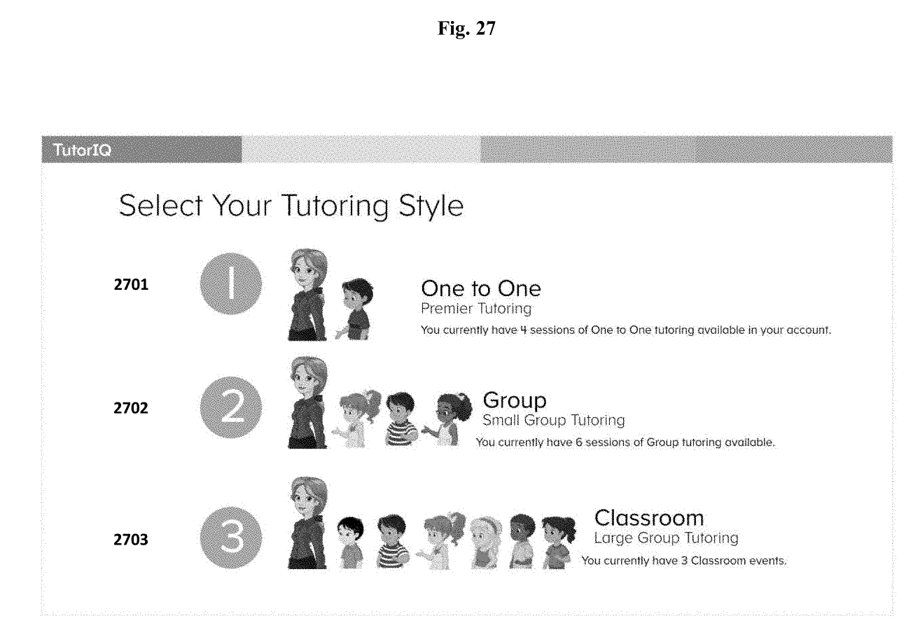

Referring to FIG. 27, in a particular embodiment, an interface for a learner to select a tutoring style for a live, remote tutoring session is provided. In some embodiments, the learner may select from three options: one to one tutoring 2701, small group tutoring 2702, or a classroom (large group) tutoring 2703. In some embodiments, one or more tutor may participate in the remote tutoring session. In further embodiments, the interface can depict how many sessions a learner has to sign up for each option. In some embodiments, the small group tutoring session can comprise of learner group sizes ranging anywhere from 2, 3, 4, 5, 6, 7, 8, 9, or 10 learners. In other embodiments, the classroom (large group) tutoring session can comprise of learner group sizes ranging anywhere from 10, 20, 30, 40, 50, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500 or more learners, including increments therein.

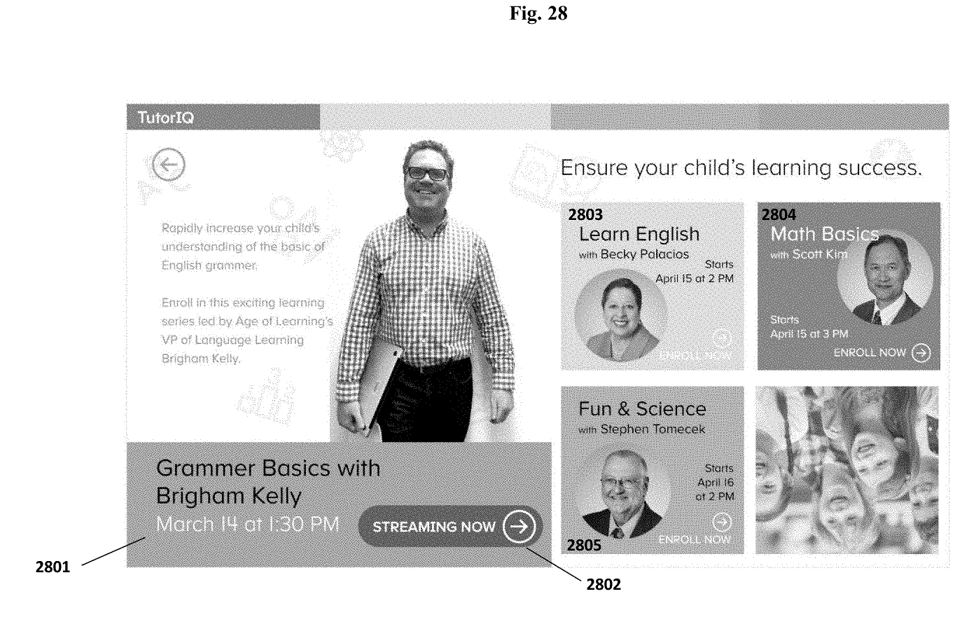

Referring to FIG. 28, in a particular embodiment, a home screen for a classroom (large group) tutoring session including a catalog of broadcast events and access to interface elements allowing a learner to enroll in future sessions and join currently streaming sessions is provided. In some embodiments, the interface depicts a variety of different subject matters, including but not limited to, English 2803, basic math 2804, science 2805, or grammar 2802. Many subjects are suitable and include, by way of non-limiting examples, math, reading, science, social studies, art, music, language arts, foreign language, and combinations thereof. Similarly, many levels of learning are suitable and include, by way of non-limiting examples, a pre-K, level, a Kindergarten level, a first grade level, a second grade level, a third grade level, a fourth grade level, a fifth grade level, a sixth grade level, a seventh grade level, an eighth grade level, a ninth grade level, a tenth grade level, an eleventh grade level, a twelfth grade level, and the like, including intermediate levels between. In other embodiments, subject matters are not linked to a school grade level, but instead is a proficiency level, a fluency level, a competency level, a mastery level, or a combination thereof. In some embodiments, the interface depicts an image of the tutor teaching the various subject matters. In other embodiments, the interface further depicts the time and date of the remote tutoring session 2801 and optionally provides the learner the ability to enroll. In further embodiments, the interface also informs the learner if a particular remote tutoring session is currently active and provides the option for the learner to access the lesson instantly 2802.

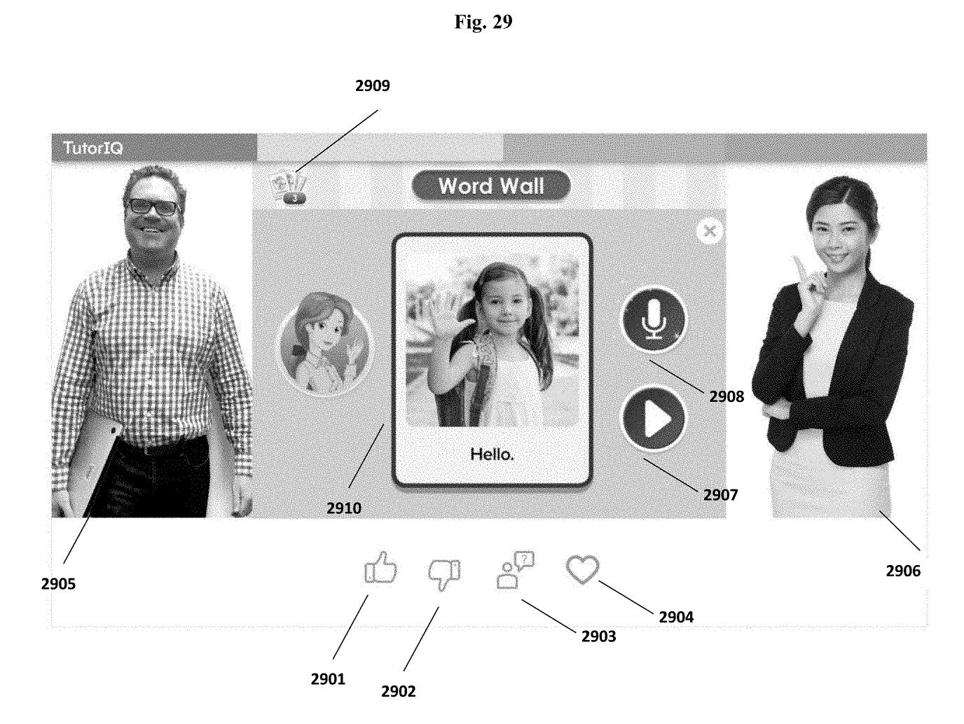

Referring to FIG. 29, in a particular embodiment, an interface for providing a classroom (large group) tutoring session including two tutor video presences is provided. In some embodiments, a live stream of one tutor is depicted on the left side of the interface 2905 while the live stream of the second tutor is depicted on the right side of the interface 2906. In other embodiments, more than two tutors may be present. By way of example, the number of tutors may include but are not limited to 3, 4, 5, 6, 7, 8, 9, or 10. In some embodiments, the one or more tutors may be stationary while teaching a particular subject matter. In other embodiments, the one or more tutors may be moving to different locations in real life while teaching a particular subject matter. These locations may include, but are not limited to, supermarkets, libraries, malls, parks, museums, airports, and other public places. In further embodiments when there are two or more tutors, the tutors may be interacting with each other while teaching a subject matter. In some embodiments, the learning lesson or activity may be depicted in the center of the interface 2910. In other embodiments, the learner may optionally press an icon to mute the lesson 2908 or play a lesson 2907. In some embodiments, the learner may be asked to participate in a learning activity that requires the learner's vote. In some embodiments, the learner may be asked to vote by pressing a thumbs up 2901 or thumbs down 2902 icon. In further embodiments, the learner may press another icon 2903 to indicate to the one or more tutors about a question the learner may have. In some embodiments, the learner may press an icon 2904 to indicate his or her approval of the one or more tutors. In some embodiments, the learner is given awards in the forms of tickets when adequately completing a learning activity. In further embodiments, an icon 2909 keeps track of the number of awards the learner has won.

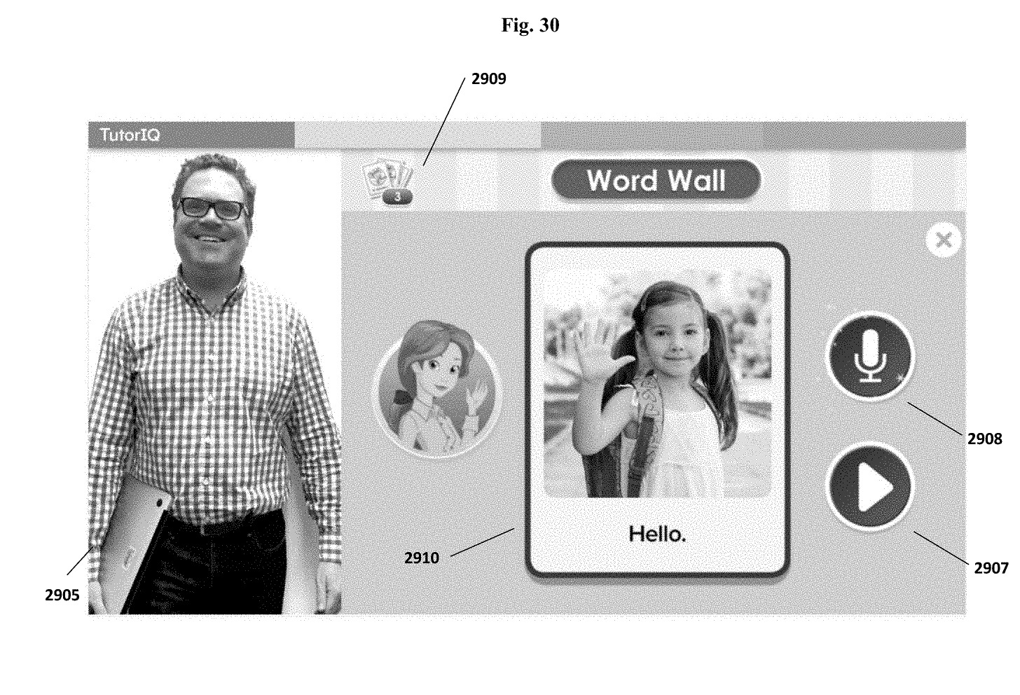

Referring to FIG. 30, in a particular embodiment, an interface for providing a classroom (large group) tutoring session including a single tutor video presence is provided. In some embodiments, the single tutor is depicted on the left side of the interface 2905. In some embodiments, the learning lesson or activity may be depicted in the center of the interface 2910. In other embodiments, the learner may optionally press an icon to mute the lesson 2908 or play a lesson 2907. In some embodiments, the learner is given awards in the forms of tickets when adequately completing a learning activity. In further embodiments, an icon 2909 keeps track of the number of awards the learner has won.

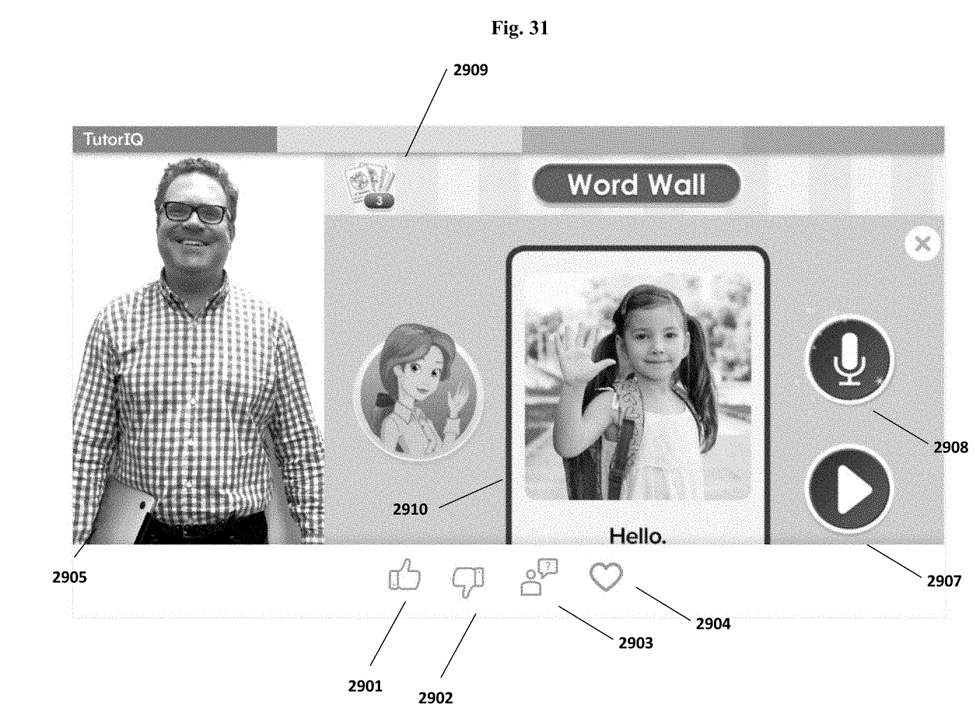

Referring to FIG. 31, in a particular embodiment, a different interface for providing a classroom (large group) tutoring session including a single tutor video presence is provided. In some embodiments, the learner may be asked to participate in a learning activity that requires the learner's vote. In some embodiments, the learner may be asked to vote by pressing a thumbs up 2901 or thumbs down 2902 icon. In further embodiments, the learner may press another icon 2903 to indicate to tutor about a question the learner may have. In some embodiments, the learner may press an icon 2904 to indicate his or her approval of tutor.

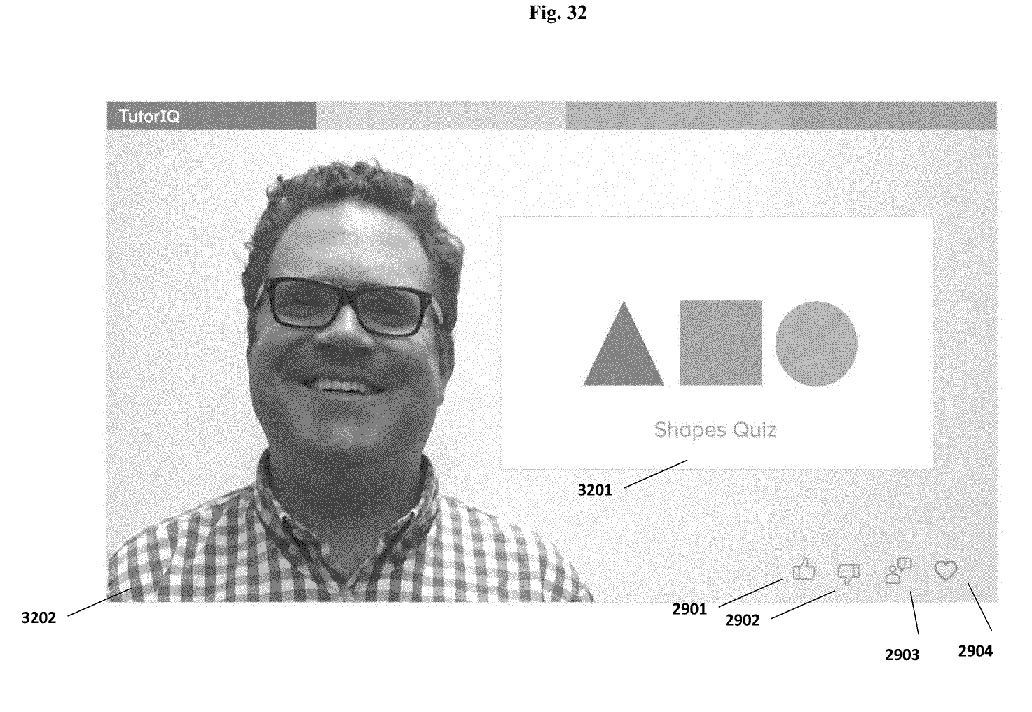

Referring to FIG. 32, in a particular embodiment, an interface for providing a classroom (large group) tutoring session including a live quiz feature is provided. In some embodiments, a single tutor video presence is provided in the background 3202. In some embodiments, the live quiz feature 3201 is a shapes quiz. In further embodiments, the quiz can cover a variety of subject matters which can include, by way of non-limiting examples, math, reading, science, social studies, art, music, language arts, foreign language, and combinations thereof. In further embodiments, the results of the learner's responses to the quizzes are recorded and shared with all the learners.

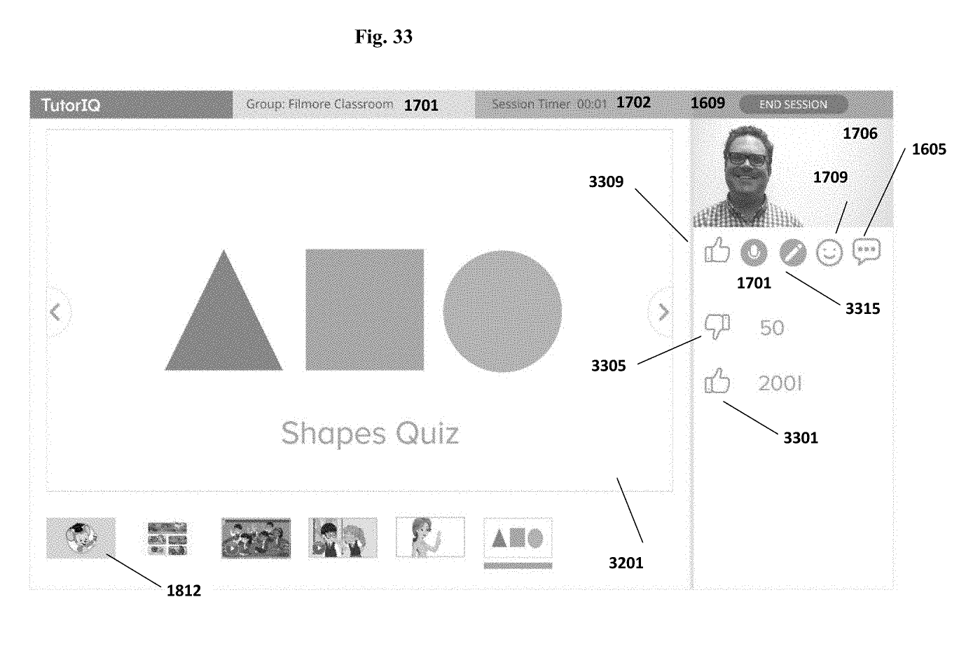

Referring to FIG. 33, in a particular embodiment, a different interface for providing a classroom (large group) tutoring session including a live quiz feature is provided. In some embodiments, the interface takes a similar form to the co-browsing interface as depicted in FIG. 17. In some embodiments, the live quiz takes up a larger portion of the interface than as depicted in FIG. 32. In some embodiments, the live video stream of the tutor 1706 is found on the top right hand side of the interface. In further embodiments, the learner has the option to press an icon to mute the lesson 1701, start an interactive chat 1605 with the tutor, or indicate his or her satisfaction with the lesson 1709 to the tutor. In even further embodiments, the learner has access to a menu that depicts different lessons or learning activities 1812. In some embodiments, the learner has a whiteboarding tool 3315. In further embodiments, the learner can vote 1701. In even further embodiments, the learner can view a tally that indicates how other learners voted. In some embodiments, this tally depicts how many learners gave a thumbs up 3305 or a thumbs down 3301 to a vote.

### Application Software Architecture

In some embodiments, the applications described herein have an architecture designed to improve performance of the processors, memory, and storage devices used to host and implement the applications. The performance improvements affect, in various embodiments, processor utilization and/or speed, memory utilization, storage device utilization, responsiveness, bandwidth utilization, and the like.

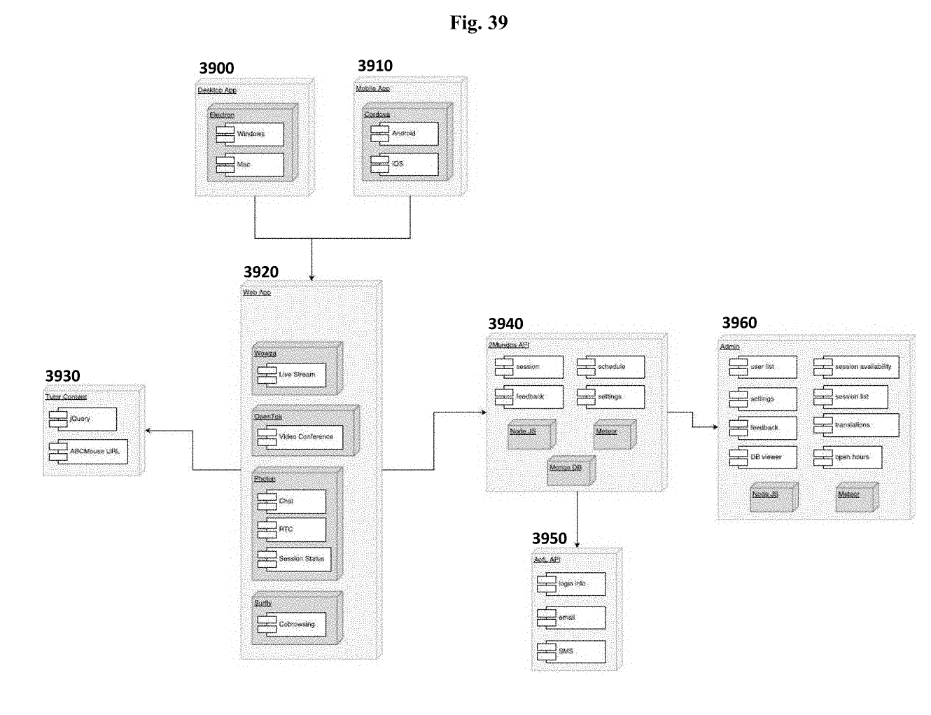

Referring to FIG. 39, in a particular embodiment, data is sent to and from a user's desktop application 3900 running on a Windows or Mac desktop or laptop computer, or from a user's mobile application 3910 running on an Android or iOS mobile device, via an Electron framework or via a Cordova framework, respectively, to the web application 3920. In this embodiment, the mobile application 3910 running on an Android or iOS mobile device, and the desktop application 3900 running on a Windows or Mac desktop or laptop computer are designed to provide a consistent, e.g., substantially similar, user experience and GUIs within the limits of the respective devices. In other embodiments, the mobile application 3910 and the desktop application 3900 are unique. In this embodiment, the web application 3920 comprises a Wowza live streaming engine, an OpenTok video conferencing platform, a Photon chat module, a real time clock (RTC) session status modules, and a Surfly co-browsing module. In some embodiments, the Wowza live streaming engine within the web application 3920 is capable of, and specifically implemented for, high-bandwidth broadcasting, and is therefore capable of supporting the transfer of larger data streams to a large number of students simultaneously. In this embodiment, with regard to co-browsing, each user (and each tutor for that matter) downloads the learning content independently using their own internet bandwidth and the Surfly co-browsing module within the web application 3920 communicates event data, such as the current page or slide, and the voice of, and any markings, notations or mouse movements made by, a tutor to each users' device. In this embodiment, the Surfly co-browsing module within the web application 3920 significantly reduces the amount of bandwidth required for streaming a presentation or lesson, because the original presentation content is downloaded by the user, and thus does not have to be included with the remainder of the time-sensitive and high-bandwidth live streamed data. In this embodiment, data from the web application 3920 is transmitted to the tutor GUI 3930, so that the tutor can access and submit content via jQuery or the ABCMouse URL. Further, in this embodiment, the data from the web application 3920 is transmitted to a 2Mundos API 3940, which coordinates and stores the session, schedule, feedback, and settings, through NodeJS, Meteor, and Mongo DB software. The 2Mundos API 3940 communicates with an API to store and receive login information, SMS and email data. Moreover, in this embodiment the 2Mundos API 3940, communicates with an Admin platform 3960, which stores and coordinates, and wherein the administrators can modify, the user list, session availability, configuration settings, session list, feedback data, translation data, a database (DB) viewer, and the open hours, through NodeJS and Meteor software.

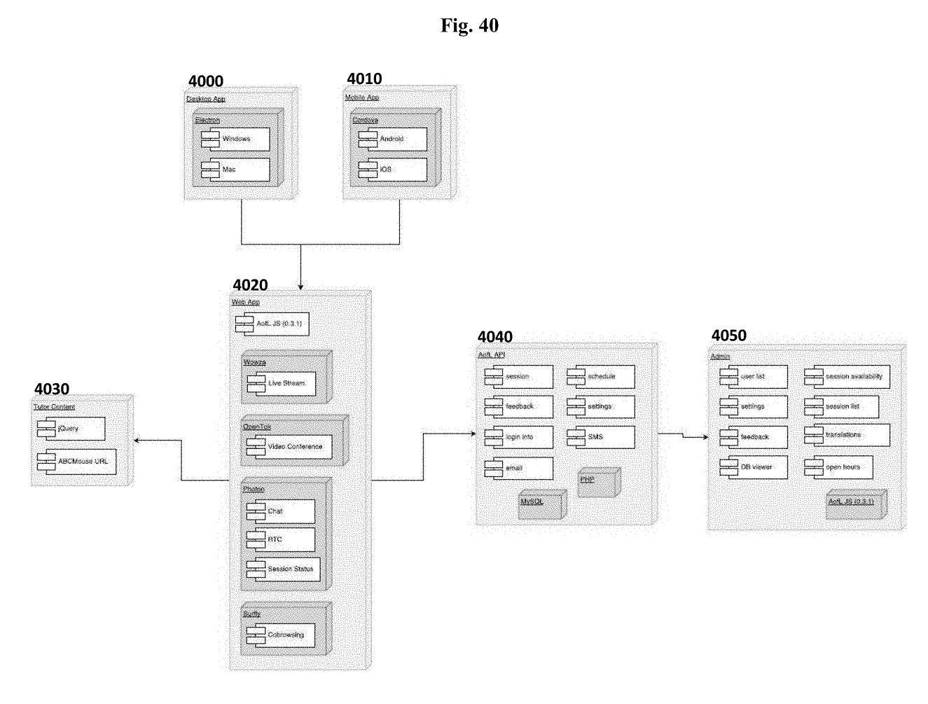

Referring to FIG. 40, in an alternative embodiment, the data from the web application 4020 is transmitted to the API 4040, which coordinates and stores the session, schedule, feedback, settings, login information, SMS and email data through a MySQL and PHP stack. In this embodiment API 4040, communicates with an Admin platform 4050, which stores and coordinates, and wherein the administrators can modify, the user list, session availability, settings, session list, feedback, translations, database (DB) viewer and the open hours, through an JS software.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, WindowsServer®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, AmazonFire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

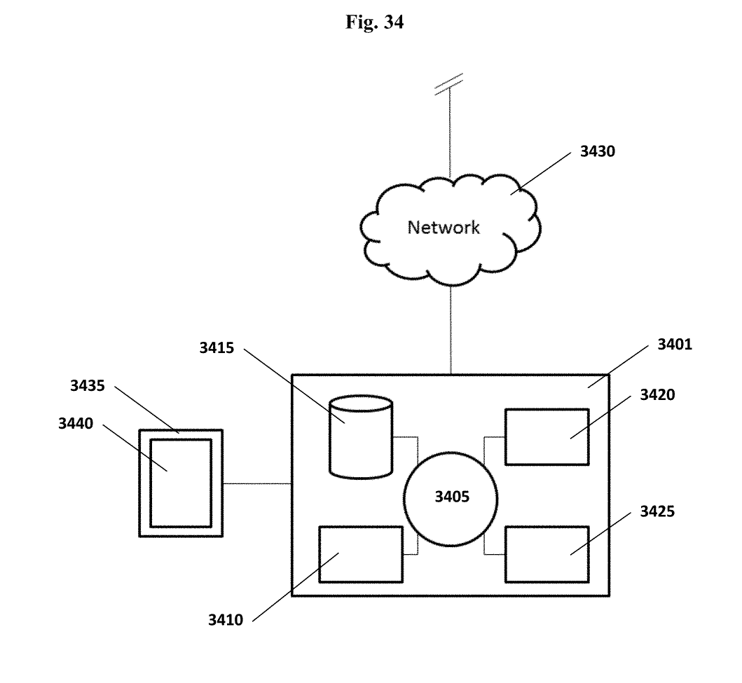

Referring to FIG. 34, in a particular embodiment, an exemplary digital processing device 3401 is programmed or otherwise configured to present tutor and learner interfaces for scheduling and conducting a tutoring session. In this embodiment, the digital processing device 3401 includes a central processing unit (CPU, also “processor” and “computer processor” herein), which can be a single core or multi core processor, or a plurality of processors for parallel processing. The digital processing device 3401 also includes memory or memory location 3410 (e.g., random-access memory, read-only memory, flash memory), electronic storage unit 3415 (e.g., hard disk), communication interface 3420 (e.g., network adapter) for communicating with one or more other systems, and peripheral devices 3425, such as cache, other memory, data storage and/or electronic display adapters. The memory 3410, storage unit 3415, interface 3420 and peripheral devices 3425 are in communication with the CPU 3405 through a communication bus (solid lines), such as a motherboard. The storage unit 3415 can be a data storage unit (or data repository) for storing data. The digital processing device 3401 can be operatively coupled to a computer network (“network”) 3430 with the aid of the communication interface 3420. The network 3430 can be the Internet, an internet and/or extranet, or an intranet and/or extranet that is in communication with the Internet. The network 3430 in some cases is a telecommunication and/or data network. The network 3430 can include one or more computer servers, which can enable distributed computing, such as cloud computing. The network 3430, in some cases with the aid of the device 3401, can implement a peer-to-peer network, which may enable devices coupled to the device 3401 to behave as a client or a server.

Continuing to refer to FIG. 34, the CPU 3405 can execute a sequence of machine-readable instructions, which can be embodied in a program or software. The instructions may be stored in a memory location, such as the memory 3410. The instructions can be directed to the CPU 3405, which can subsequently program or otherwise configure the CPU 3405 to implement methods of the present disclosure. Examples of operations performed by the CPU 3405 can include fetch, decode, execute, and write back. The CPU 3405 can be part of a circuit, such as an integrated circuit. One or more other components of the device 3401 can be included in the circuit. In some cases, the circuit is an application specific integrated circuit (ASIC) or a field programmable gate array (FPGA).

Continuing to refer to FIG. 34, the storage unit 3415 can store files, such as drivers, libraries and saved programs. The storage unit 3415 can store user data, e.g., user preferences and user programs. The digital processing device 3401 in some cases can include one or more additional data storage units that are external, such as located on a remote server that is in communication through an intranet or the Internet.

Continuing to refer to FIG. 34, the digital processing device 3401 can communicate with one or more remote computer systems through the network 3430. For instance, the device 3401 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein can be implemented by way of machine (e.g., computer processor) executable code stored on an electronic storage location of the digital processing device 3401, such as, for example, on the memory 3410 or electronic storage unit 3415. The machine executable or machine readable code can be provided in the form of software. During use, the code can be executed by the processor. In some cases, the code can be retrieved from the storage unit 3415 and stored on the memory 3410 for ready access by the processor 3405. In some situations, the electronic storage unit 3415 can be precluded, and machine-executable instructions are stored on memory 3410.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

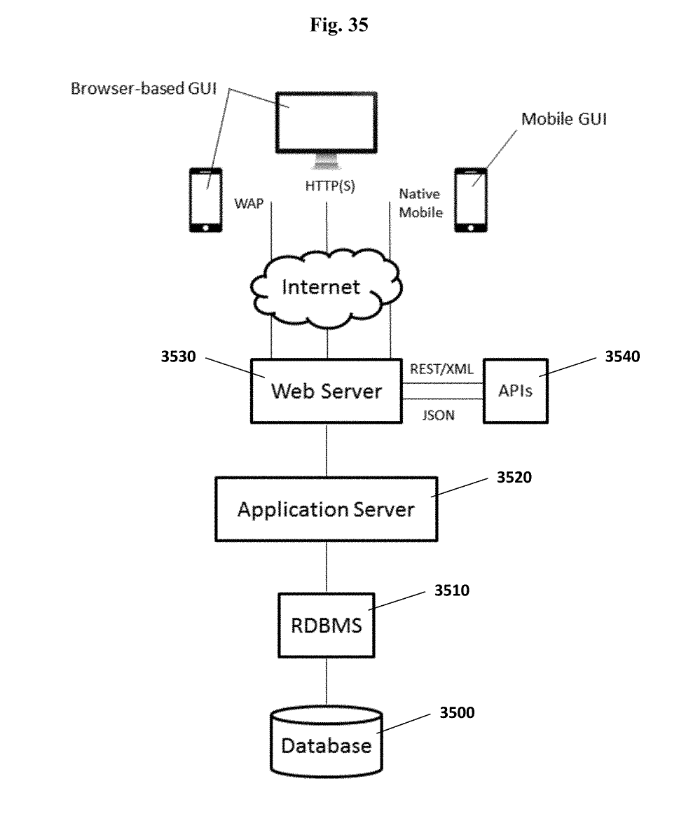

Referring to FIG. 35, in a particular embodiment, an application provision system comprises one or more databases 3500 accessed by a relational database management system (RDBMS) 3510. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 3520 (such as Java servers, .NET servers, PHP servers, and the like) and one or more web servers 3530 (such as Apache, IIS, GWS and the like). The web server(s) optionally expose one or more web services via app application programming interfaces (APIs) 3540. Via a network, such as the Internet, the system provides browser-based and/or mobile native user interfaces.

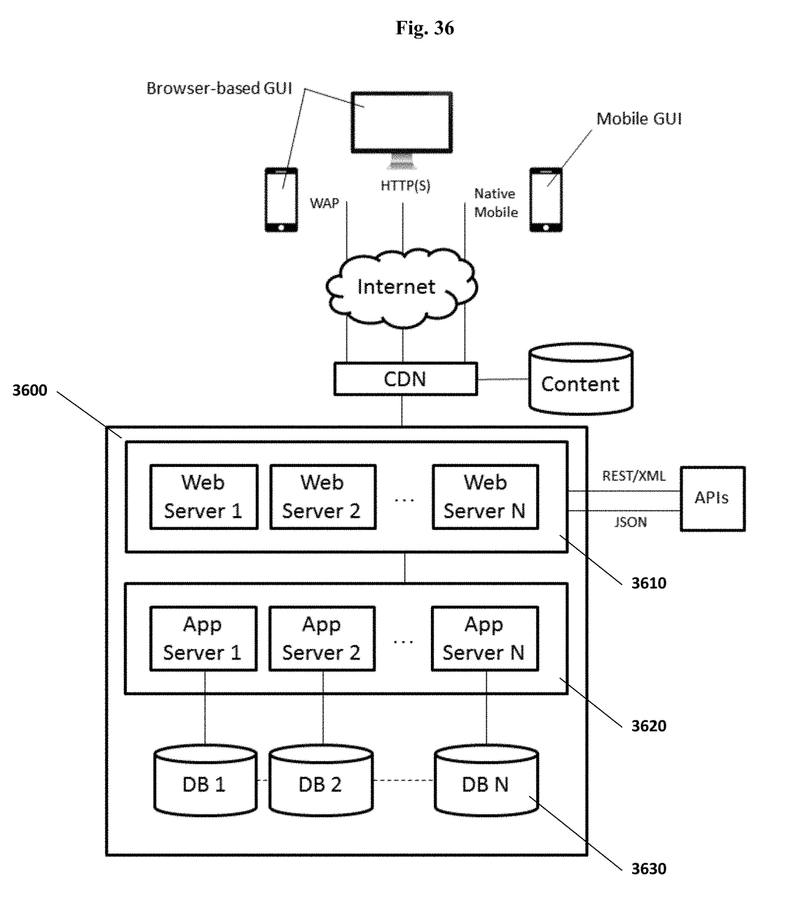

Referring to FIG. 36, in a particular embodiment, an application provision system alternatively has a distributed, cloud-based architecture 3600 and comprises elastically load balanced, auto-scaling web server resources 3610 and application server resources 3620 as well synchronously replicated databases 3630.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

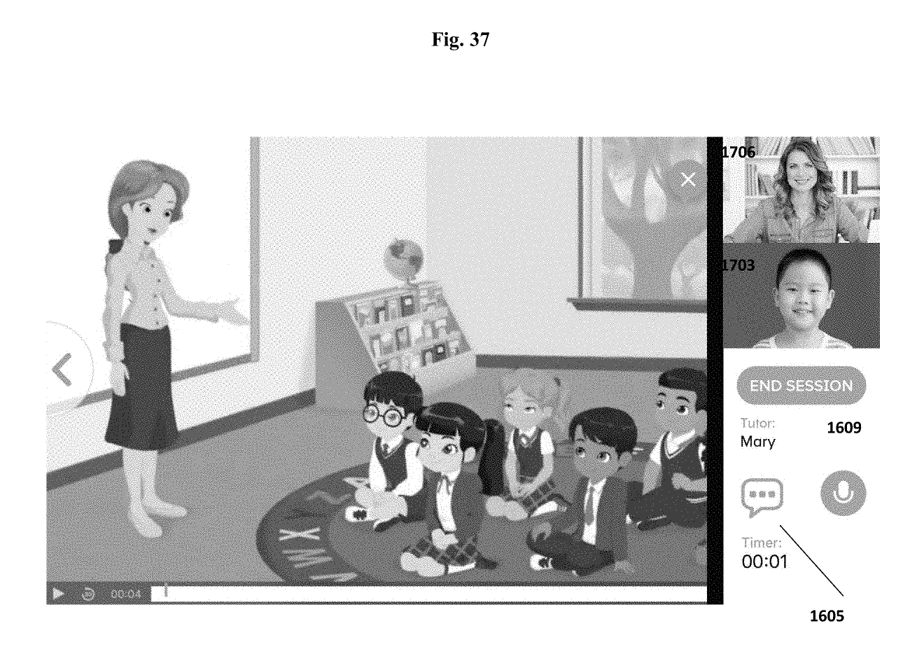

Referring to FIG. 37, in a particular embodiment, a co-browsing module for a remote tutoring session interface configured for a mobile phone is provided. In some embodiments, the remote tutoring session interface configured for a mobile phone has the same features as the one depicted in FIG. 16 or 17, but in different locations. In other embodiments, the mobile phone interface has fewer features as the one depicted in FIG. 16 or 17, but in different locations.

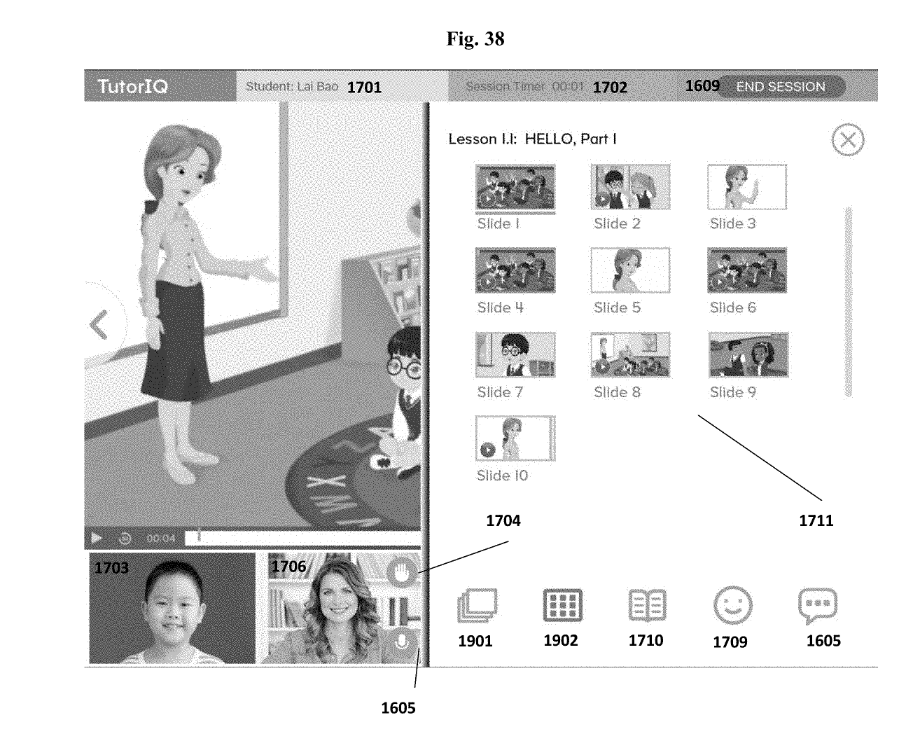

Referring to FIG. 38, in a particular embodiment, a co-browsing module for a remote tutoring session interface configured for a tablet is provided. In some embodiments, the remote tutoring session interface configured for a tablet has the same features as the one depicted in FIG. 16, 17, or 19 but in different locations. In other embodiments, the mobile phone interface has fewer features as the one depicted in FIG. 16, 17, or 19 but in different locations.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of learner, tutor, curriculum, progress, and performance information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1—Remotely Teaching an English Lesson in Tutor Mode Through a Co-Browsing Module

Jane Takeshi, a 27-year old English tutor, lives in Washington D.C. She is preparing to tutor Lai Bao, a six-year old boy living in China, in English one Saturday morning.

As shown in FIG. 1, Jane logs into the remote tutoring platform on her tablet using her email and address. The platform recognizes Jane's credentials as a tutor so the platform automatically directs Jane to the tutor mode where Jane has access to a number of features specific for a tutor. Jane checks the dashboard module to see that she has just the session with Lai Bao for that day. As shown in FIG. 11, Jane begins reviewing the curriculum and the lesson script for Lai Bao's lesson. Lai Bao's lesson for that day covers learning about different parts of the body in English.

Five minutes before the lesson with Lai Bao is about to begin, the dashboard module alerts Jane about the upcoming lesson. Jane exits the dashboard module, accesses the shared co-browsing module, turns on her live video camera from her tablet, presses the mute button, and waits for Lai Bao to appear from his end of the co-browsing module. Lai Bao appears for his lesson.

As shown in FIG. 17, a live video of Jane 1706 and Lai Bao 1703 is shown as the remote tutoring session is about to begin. Jane quickly glances at the top of the co-browsing module and confirms Lai Bao is checked in for the lesson. Jane unmutes the audio from her side, greets Lai Bao, and begins the lesson. Jane is not worried about forgetting what the lesson plan provides because the curriculum and a script that tracks the curriculum are conveniently located on the bottom right hand corner of the co-browsing module. Jane begins reading off the script, explaining the different parts of the body. Jane shows through the live video the different parts of her face like her own eyes, ears, nose, and mouth. She uses her white boarding tools on her pointer 1714 to annotate the different parts of the cartoon kids on the interface. When it looks like Lai Bao is distracted because he is not maintaining eye contact with Jane or Lai Bao's pointer 1713, which Jane can see on her end, is moving around without any prompt, Jane issues a gentle verbal reminder for Lai Bao to pay attention. Lai Bao. Jane asks Lai Bao to identify different parts of his face and to state them in English. Jane hears Lai Bao pronounce these different parts of his face correctly through the live chat feature so she gives Lai Bao a ticket. Lai Bao is very excited upon receiving the ticket because he knows if he saves enough tickets, he can use them to purchase different online prizes on a different menu. Jane glances at the session timer 1702 to check to see if there is enough time to start a new lesson 1711, but decides against it because the session is almost over. Jane says good-bye to Lai Bao and ends the session 1609.

As shown in FIGS. 12-14, Jane accesses the tutor feedback module to summarize Lai Bao's progress and to assign him homework. As shown in FIG. 12, Jane assigns Lai Bao some exercises to reinforce his understanding of the different parts of the body. As shown in FIG. 13, Jane further fills out a student progress report. Jane is mindful that this section of the feedback module is publicly available to Lai Bao and his parents, so Jane fills the section out with Lai Bao's strengths, constructive criticism, and more specific status of Lai Bao's learning. Jane also notes that Lai Bao satisfactorily finished all the English lessons related to the body so Lai Bao does not have to do this lesson again. As shown in FIG. 14, Jane further fills out a report available only to other tutors. Here, Jane makes a note to Lai Bao's others tutors to be mindful of Lai Bao's tendency to be distracted if a tutor uses white boarding tools and for them to adjust their tutoring sessions accordingly.

Jane goes back to the dashboard module to check on her upcoming tutoring sessions. She notices that she has a remote tutoring session with Paul and Peter, two four-year old boys living in Japan, in three days. Jane is planning to conduct that session with Bob, a tutor who lives in Japan. Jane directly messages Bob to coordinate a meeting in advance of the session to discuss division of labor. Jane signs off the platform and enjoys the rest of her Saturday.

### Example 2—Reading Co-Browsing Activity

Mary Silva, a 7 year-old girl from Brazil, is logging into a remote tutoring session to do a co-browsing activity focused on reading in English. With the help of her dad, Mary logs into the remote tutoring platform on her dad's desktop using her email and address. The platform recognizes Mary's credentials as a learner so the platform automatically directs Mary to the learner mode with features specific for a learner. Mary checks the dashboard module to see that her remote tutoring session with her tutor, Jessica, has already started a few minutes ago. Mary quickly accesses the co-browsing module, which takes her to an interface like the one depicted in FIG. 20. Mary's father continues to oversee the remote tutoring session to the side.

Jessica greets Mary through a live video stream and Mary responds with pleasantries. Jessica asks Mary whether she would like to have her reading activity at the beach, classroom, zoo, map or farm. Jessica responds that she would like to go to the classroom today. Jessica directs Mary to select the classroom option 2011 on the top right hand corner, which takes Jessica and Mary to a virtual classroom environment like the one depicted in FIG. 21. Jessica further directs Mary to select the “Reading” hotspot on the top left corner of the page, which takes Jessica and Mary to more options like the one depicted in FIG. 22. Jessica asks Mary to read all of the words on the screen, which Mary does. Jessica then asks Mary which book Mary would like to read today. Mary responds that she wants to read “The Boy Who Cried Wolf.” Jessica instructs Mary to select the icon for that book, which takes both of them to a picture book. Mary begins to read all the words and Jessica corrects Mary when Mary struggles with the pronunciation of a word. After the reading activity is done, Jessica tells Mary what a great job she has done and awards her several tickets. Mary is excited and asks whether she can use the tickets to purchase prizes, which Jessica says is okay. Both of them access the page like the one depicted in FIG. 24. With Jessica's guidance, Mary exchanges her newfound won tickets for a virtual hamster she can play with. After the lesson is over, Mary (with the help of her father) fills out an evaluation form like the one shown in FIG. 10 about Jessica's performance.

### Example 3—Signing Up for a Session and Managing Session Settings

Jill Lee, a 32-year old Korean mother, wants to sign up her five-year old son Jim Lee for an English lesson through a remote tutoring session. Jill starts by accessing the remote tutoring session platform. As shown in FIG. 1, the platform is originally depicted in English, which Jill is not as comfortable using. Jill presses the toggle button 110 to convert the platform into Korean, a language she is more comfortable using. Jill logs into the remote tutoring platform on her mobile device using an email and address she previously set up for her son's account. The platform recognizes Jill's credentials as Jim's guardian so the platform automatically directs Jill to a mode dedicated to guardians or parents of learners.

The first page Jill sees is the dashboard module, which shows Jim has not booked any session. As shown in FIG. 6, Jill quickly checks her account and confirms that Jim's tutoring package has not expired. Then, Jill browses a catalogue of possible tutors and their tutor profiles to find the one who would be a good fit for her son. As shown in FIG. 5, the tutor profiles show a picture of the tutor along with the tutor's educational background, experience in various subject matters, and awards and accolades. Jill is excited when she finds a tutor, Charlotte, who has extensive experience with teaching English to Korean children (including teaching at academies in Korea for many years) who is bilingual in English and Korean, and who received numerous awards from various teaching organizations to be Jim's student—a perfect fit for Jim.

Jill proceeds to book a remote tutoring session with Charlotte. As shown in FIG. 3, Jill first finds a convenient day that works for Jim and when Charlotte is available. She chooses the last Tuesday of the month—one week away. Then, as shown in FIG. 4, Jill selects a convenient time that works for Jim and when Charlotte is available. Jill ends up choosing 5 pm slot.

Then, Jill proceeds to further set up the account for her son for other co-browsing activities. Jill selects Jim's avatar to be a boy. She selects the path level to be at a low level to allow her son to ease into his reading lessons. She also disables any features that would allow Jim to exchange items for tickets on his own. When Jill has questions about the different co-browsing activities Jim would be exposed to, Jill is able to easily call customer support for help and clarification. Once Jill finishes configuring her son's account, Jill logs off and continues on with the rest of her day.

### Example 4—Participating in Quiz Mode

Sarah Johnson, a 28-year old English tutor, is teaching English to four learners—Jane, Jonathan, Paula, and Flemming—in a remote tutoring session. The four learners are 5, 5, 6, and 6 years old, respectively. On a shared screen, Sarah shows Jane, Jonathan, Paula, and Flemming a learning activity on spelling. Here, the learning activity is how to spell “CAT.” Sarah and all the learners can see the same screen that shows the letters “AT” on the right side and the letter “H,” “P,” “F,” and “C” on the left. Only Sarah, however, is able to interact with the screen. Sarah begins to explain the sounds of all the different individual letters and indicating the location of each individual letter. Sarah's interactions with the shared screen are simultaneously broadcasted to all the learners.

Sarah decides that it is time to give a quiz on how to spell “CAT.” She announces to all four learners that it's quiz time. Sarah selects the “Quiz Mode” module in the toolbox on the upper right hand of her remote tutoring session interface. When Sarah selects “Quiz Mode,” the view of her screen changes. As shown in FIG. 49, Sarah is able to simultaneously see the separate content screens of Jane, Jonathan, Paula, and Flemming and their interactions. Sarah is also able to interact with all the screens of Jane, Jonathan, Paula, and Flemming and provide instructions to the entire group of learners at once. The learners' screen, however, have a different screen viewing experience than Sarah. In “Quiz Mode” for the learners, Jane, Jonathan, Paul, and Flemming are shown the same “AT” on their screens along with the letters “H,” “P,” “F,” and “C”—the same content before the Quiz Mode was entered. However, this time each learner is able to interact with each of the “H,” “P,” “F,” and “C” letters. Notably in Quiz Mode, each learner is not able to see the screen of the other learners. Additionally, each learner's individual interactions with his or her content screen does not impact what goes on in other learner's content screens. Each learner believes that he or she is viewing a single learning activity unique to that learner. Each learner is able to hear Sarah's instructions.

Sarah instructs the learners to please spell “CAT” by selecting and dragging the appropriate letter to the appropriate space. In Quiz Mode, Sarah is able to see how Jane, Jonathan, Paula, and Flemming are separately performing in real time. Jane's screen has her name on the top left hand corner in red. This red color matches the surrounding red color around Jane's image at the top of Sarah's tutor mode interface and the red cursor in Jane's screen depicting Jane's last interaction. A similar corresponding color scheme appears for Jonathan (in blue), Paula (in green), and Flemming (in purple). This makes it easier for Sarah to keep quickly track of the different learners and their current interactions.

Each learner goes to complete the task. Jane is first to select the “C” letter and has already dragged the “C” letter to spell CAT. “Good job, Jane!” says Sarah. However, in Quiz Mode, none of the other learners knew what Jane did because their respective screens do not show what actions Jane took. In that split second, Sarah notices that Paula has selected the “C” and was well on her way to move the C to the correct space. “Keep it up, Paula!” says Sarah encouragingly. In the corner of her eye, Sarah notices that Flemming and Jonathan have not selected the correct letter and that Flemming was going to select the incorrect “P” letter. Sarah tells the group of learners, “Remember, the word is ‘CAT.’ Let's think about how the word would sound if we put the letters like “H” or “P” in front of it. Does that spell or sound like CAT?” Sarah is careful to not call out Flemming's or

Jonathan's name to avoid drawing unnecessary attention to them. Eventually, Jonathan and Flemming reach the correct answer. “Great job, everyone!” Sarah declares. “Let's go over each letter.” Sarah remembers that Flemming initially reached out to the “P” letter before Sarah's instructions. To confirm that Flemming solidified his understanding of spelling “CAT” and why “P” was the incorrect spelling, Sarah asks Flemming, “What happens if we put ‘P’ there?” Flemming confidently responds that this would spell “PAT,” which is not “CAT.” “Excellent work, Flemming!” Sarah proclaims.

After the end of the learning activity, Sarah exits Quiz Mode and back to the shared mode with the shared content screen. In doing so, the content screen reverts back to the non-manipulated content screen prior to the learner's interactions in Quiz Mode, i.e., showing “AT” on the screen along with the letters “H,” “P,” “F,” and “C.” Back in the shared mode, only Sarah is able to interact with the content screen. Sarah drags the “H” letter in front of the learners and tells them how that would spell “HAT.” Satisfied that all the learners achieved the learning objective, Sarah moves on to the next slide of her lesson plan. By utilizing the Quiz Mode, Sarah is able to efficiently and accurately keep track of multiple learners' interactions and thought process of the instant learning lesson. However, because this mode is configured to prevent the learners from viewing each other's screen, each learner can learn independently, e.g., without relying on copying the process of other learners, and can be given instructions or guidance from the tutor without embarrassment.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system comprising: a digital processing device comprising: at least one processor, an operating system configured to perform executable instructions, a memory, and a computer program including instructions executable by the digital processing device to create a bi-modal, online tutoring application for providing live, remote tutoring sessions, the application comprising:
a) a database of tutor profiles, each profile comprising an average rating and availability of a tutor;
b) an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding;
c) a learner mode comprising:
i) a booking module allowing a learner to purchase tutoring session credits, browse the tutor profiles, and book new tutoring sessions;
ii) a dashboard module providing access to booked sessions and learner progress; and
iii) a learner feedback module allowing a learner to rate tutors and completed tutoring sessions;
d) a tutor mode comprising:
i) a billing and payment module allowing a tutor to view booked tutoring sessions and payments for completed tutoring sessions; and
ii) a tutor feedback module allowing a tutor to, for a completed tutoring session, perform one or more of: assign homework, describe learner progress, provide tutor-to-tutor feedback, and rate curriculum;
wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum.

2.-6. (canceled)

7. The system of claim 1, wherein the co-browsing module shows the pointer position of the one or more tutors, the one or more learners or both the one or more tutors and the one or more learners.

8. (canceled)

9. The system of claim 1, wherein the onscreen awards comprise an animated graphic, an interactive game, or an animated mask, wherein the animated mask is contextual to the tutoring session.

10.-12. (canceled)

13. The system of claim 1, wherein the co-browsing module independently accesses the media for each tutor and learner and exchanges event data to sync the presentation among all tutors and learners.

14. The system of claim 1, wherein, in the tutor mode, the interface for conducting a tutoring session further comprises tools for a tutor to disable learner whiteboarding.

15. The system of claim 1, wherein the tutoring script for the curriculum comprises educational rationales and teaching prompts.

16. The system of claim 15, wherein the teaching prompts comprise a prompt to transfer navigational control to one or more of the learners or a prompt to transfer navigational control back from a learner.

17. The system of claim 15, wherein the tutoring script for the curriculum comprises one or more images, one or more videos, one or more audio elements, or one or more interactive elements.

18. The system of claim 1, wherein the application is implemented as a mobile app, web app, or a standalone app.

19. (canceled)

20. (canceled)

21. The system of claim 1, wherein the tutoring session is conducted between one tutor and one learner or between one tutor and a plurality of learners.

22. (canceled)

23. The system of claim 1, wherein the co-browsing module comprises:
a) a shared mode wherein the application simultaneously presents to the one or more tutors and the one or more learners a content screen with the co-browsing activity; and
b) a quiz mode wherein the application presents:
i) to the one or more learners a content screen comprising at least one learning activity, wherein each learner is given permission to interact with the at least one learning activity on the content screen, wherein each learner's interaction is not broadcast to any other learner in the tutoring session; and
ii) to the one or more tutors one or more content screens that simultaneously broadcasts in real time the content screen and interactions of the one or more learners;
wherein the application provides the one or more tutors with an interface element to switch between the shared mode and the quiz mode.

24. The system of claim 23, wherein the quiz mode presents to the one or more tutors all of the one or more learners' content screens and interactions in a single tutor content screen.

25. Non-transitory computer-readable storage media encoded with a computer program including instructions executable by a processor to create a bi-modal, online tutoring application for providing live, remote tutoring sessions, the application comprising:
a) a database of tutor profiles, each profile comprising an average rating and availability of a tutor;
b) an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding;
c) a learner mode comprising:
i) a booking module allowing a learner to purchase tutoring session credits, browse the tutor profiles, and book new tutoring sessions;
ii) a dashboard module providing access to booked sessions and learner progress; and
iii) a learner feedback module allowing a learner to rate tutors and completed tutoring sessions;
d) a tutor mode comprising:
i) a billing and payment module allowing a tutor to view booked tutoring sessions and payments for completed tutoring sessions; and
ii) a tutor feedback module allowing a tutor to, for a completed tutoring session, perform one or more of: assign homework, describe learner progress, provide tutor-to-tutor feedback, and rate curriculum;
wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum.

26.-36. (canceled)

37. The media of claim 25, wherein the co-browsing module independently accesses the media for each tutor and learner and exchanges event data to sync the presentation among all tutors and learners.

38.-46. (canceled)

47. The media of claim 25, wherein the co-browsing module comprises:
a) a shared mode wherein the application simultaneously presents to the one or more tutors and the one or more learners a content screen with the co-browsing activity; and
b) a quiz mode wherein the application presents:
i) to the one or more learners a content screen comprising at least one learning activity, wherein each learner is given permission to interact with the at least one learning activity on the content screen, wherein each learner's interaction is not broadcast to any other learner in the tutoring session; and
ii) to the one or more tutors one or more content screens that simultaneously broadcasts in real time the content screen and interactions of the one or more learners;
wherein the application provides the one or more tutors with an interface element to switch between the shared mode and the quiz mode.

48. The media of claim 47, wherein the quiz mode presents to the one or more tutors all of the one or more learners' content screens and interactions in a single tutor content screen.

49. A computer-implemented method of providing a live, remote, online tutoring session comprising:
a) maintaining a database of tutor profiles, each profile comprising an average rating and availability of a tutor;
b) presenting an interface for conducting a tutoring session between one or more tutors and one or more learners, the interface comprising: a live audio/video presence; text chat; and a co-browsing module allowing live presentation of a co-browsing activity simultaneously to the one or more tutors and the one or more learners, the co-browsing module showing a pointer position with whiteboarding;
c) providing a learner mode comprising:
i) a booking module allowing a learner to purchase tutoring session credits, browse the tutor profiles, and book new tutoring sessions;
ii) a dashboard module providing access to booked sessions and learner progress; and
iii) a learner feedback module allowing a learner to rate tutors and completed tutoring sessions;
d) providing a tutor mode comprising:
i) a billing and payment module allowing a tutor to view booked tutoring sessions and payments for completed tutoring sessions; and
ii) a tutor feedback module allowing a tutor to, for a completed tutoring session, perform one or more of: assign homework, describe learner progress, provide tutor-to-tutor feedback, and rate curriculum;
wherein, in the tutor mode, the interface for conducting a tutoring session further comprises tools for a tutor to configure navigational control of the co-browsing activity, provide onscreen awards to a learner, provide feedback comments to a learner, access curriculum, and view a tutoring script for the curriculum.

50.-60. (canceled)

61. The method of claim 49, wherein the co-browsing module independently accesses the media for each tutor and learner and exchanges event data to sync the presentation among all tutors and learners.

62.-70. (canceled)

71. The method of claim 49, wherein the method further comprises:
a) providing a shared mode comprising the application simultaneously presenting to the one more tutors and the one or more learners a content screen with the co-browsing activity;
b) providing a quiz mode comprising:
i) the application that presents to one or more learners a content screen comprising the at least one learning activity, giving each learner permission to interact with the at least one learning activity on the content screen, and limiting the broadcast of each learner's interaction so the learners' interaction is not broadcast to any other learning in the remote tutoring session; and
ii) the application that presents to the one or more tutors one or more content screens that simultaneously broadcasts in real time the content screen and interactions of the one or more learners; and
c) providing the one or more tutors with an interface element to switch between the shared mode and the quiz mode.

72. The method of claim 71, wherein the quiz mode presents to the one or more tutors all of the one or more learners' content screens and interactions in a single tutor content screen.

73.-90. (canceled)
